(19) United States
(12) Patent Application Publication
(10) Pub. No.: US 2006/0226726 A1
(43) Pub. Date: Oct. 12, 2006

(54) Planar electromagnetic induction generators and methods

(76) Inventor: Youngtack Shim, Port Moody (CA)

Correspondence Address: Youngtack Shim, 155 Aspenwood Drive, Port Moody, BC, V3H 5A5, CA

(21) Appl. No.: 11/062,127

(22) Filed: Feb. 22, 2005

(51) Int. Cl. H02K 17/00; H02K 41/00

(52) U.S. Cl. 310/166; 310/12

(57) ABSTRACT

The present invention generally relates to electromagnetic induction generators for generating AC or DC electric currents (or voltages) through electromagnetic induction in response to user inputs manually applied thereto. More particularly, the present invention relates to planar induction members and/or planar magnetic members for compact electromagnetic induction generators portably applied to various electronic and/or electronic devices. The present invention further relates to various methods of generating AC or DC currents (or voltages) using the foregoing electromagnetic induction generators and various methods of providing the electromagnetic induction generators, planar induction members thereof, and planar and/or non-planar magnetic members thereof. The planar induction members may be provided in various configurations of this invention through conventional semiconductor fabrication technologies, while the magnetic members may be provided in various configurations of this invention to induce electric currents (or voltages) through such induction members Therefore, electromagnetic induction generators of this invention may be provided as relatively thin, compact, lightweight portable generators which have enough efficiency to provide sufficient electrical power for various electronic and/or electrical devices.

The present application claims a benefit of an earlier invention date pertinent to the Disclosure Document entitled as “Planar Electromagnetic Induction Generators and Methods Therefor,” deposited in the U.S. Patent and Trademark Office by the same Applicant on Mar. 3, 2003 under the Disclosure Document Deposit Program of the Office, and bearing a Ser. No. 527,283, an entire portion of which is to be incorporated by reference herein.

### FIELD OF THE INVENTION

The present invention generally relates to electromagnetic induction generators for generating AC or DC electric currents (or voltages) through electromagnetic induction in response to user inputs manually applied thereto. More particularly, the present invention relates to planar induction members and/or planar magnetic members for compact electromagnetic induction generators portably applied to various electronic and/or electric devices. The present invention further relates to various methods of generating AC or DC currents (or voltages) using the foregoing electromagnetic induction generators and various methods of providing the electromagnetic induction generators, planar induction members thereof, and planar and/or non-planar magnetic members thereof.

### BACKGROUND OF THE INVENTION

Batteries always run out!

With the advent of semiconductor technologies, various portable electric equipment has been in use. From boom boxes of the 80's, walkmans of the 90's, and to laptop computers and cell phones of the 21st Century, batteries constitute the essential source of power. When such batteries run out, all equipment becomes useless unless the discharged batteries are replaced by new batteries or they are plugged to an AC power outlet. Conventional portable electrical generators are typically bulky and inefficient. Accordingly, there are needs for portable generators which are not only efficient but also compact enough to be carried by the users or to be incorporated into various electronic and electric portable equipment.

### SUMMARY OF THE INVENTION

The present invention relates to electromagnetic induction generators and methods therefor to generate AC or DC currents by electromagnetic induction in response to user inputs manually applied thereto. The present invention particularly relates to planar induction members and/or planar magnetic members for compact portable electromagnetic induction generators and various methods of providing such.

In one aspect of the invention, an electromagnetic induction generator is provided to generate AC or DC electric current. Such an electromagnetic induction generator includes a magnetic member and an induction member, where the magnetic member forms at least one planar (or flat) surface and includes at least one (permanent) magnet arranged to emit magnetic fluxes and where the induction member includes at least one (planar or flat) induction layer arranged to define at least one planar (or flat) conductive loop therein. The induction layer is disposed adjacent to the planar (or flat) surface of the magnet such that the conductive loop receives at least a portion of the magnetic fluxes. In a first embodiment, the magnet and/or the induction layer may be arranged to move with respect to the other in response to a user input in order to induce electric current through the conductive loop. In another embodiment, the conductive loop may form a region at least partially surrounded thereby, and an area of the region normally projected onto the magnetic fluxes may be arranged to change over time. In yet another embodiment, the conductive loop may form a region at least partially surrounded thereby, and an amount of the magnetic fluxes intersecting such a region may be arranged to change over time.

An AC or DC electromagnetic induction generator may also include a magnetic member and an induction member, where the magnetic member has at least one planar (or flat) surface and includes at least one (permanent) magnet arranged to emit magnetic fluxes, where the induction member may include at least one (planar or flat) induction layer which is arranged to define at least one planar (or flat) conductive loop therein and to have a thickness less than about, e.g., 5 mm, 3 mm, 2 mm, 1 mm, 100 microns, 10 microns, 1 micron, etc. The induction layer is disposed adjacent to the planar (or flat) surface of the magnet so that the conductive loop receives at least a portion of the magnetic fluxes. In one embodiment, the magnet and/or induction layer may be arranged to move relative to the other in response to a user input in order to induce electric current through the conductive loop. In another embodiment, the conductive loop may form a region at least partially surrounded thereby and an area of the region normally projected onto the magnetic fluxes may be arranged to change over time. In yet another embodiment, the conductive loop may form a region at least partially surrounded thereby and an amount of the magnetic fluxes intersecting the region may be arranged to change over time.

An AC or DC electromagnetic induction generator may also include a magnetic member and an induction member, where the magnetic member has at least one planar (or flat) surface and includes at least one (permanent) magnet arranged to emit magnetic fluxes therefrom and where the induction member may include at least one (planar or flat) induction layer arranged to define at least one planar (or flat) conductive loop therein and to be placed adjacent to the planar (or flat) surface of the magnet within a distance of about, e.g., 5 mm, 3 mm, 2 mm, 1 mm, 100 microns, 10 microns, 1 micron, etc., so that the conductive loop may receive at least a portion of the magnetic fluxes. In one embodiment, the magnet and/or induction layer may be arranged to with respect relative to the other in response to a user input in order to induce electric current through the conductive loop. In another embodiment, the conductive loop may form a region at least partially surrounded thereby, and an area of such a region normally projected onto the magnetic fluxes may then be arranged to change over time. In yet another embodiment, the conductive loop may also form a region at least partially surrounded thereby, and an amount of the magnetic fluxes intersecting the region may then be arranged to change over time.

An AC or DC electromagnetic induction generator may also include a magnetic member and an induction member, where the magnetic member has at least one planar (or flat) surface and includes at least one (permanent) magnet arranged to emit magnetic fluxes therefrom and where the induction member may include at least one (planar or flat) induction layer arranged to define therein at least one planar (or flat) conductive loop made up of molecules deposited from their vapor phase. The induction layer is disposed adjacent to the planar (or flat) surface of the magnet such that the conductive loop receives at least a portion of the magnetic fluxes. In one embodiment, the magnet and/or induction layer may be arranged to move with respect to the other in response to a user input in order to induce electric current through the conductive loop. In another embodiment, the conductive loop may form a region at least partially surrounded thereby, and an area of such a region normally projected onto the magnetic fluxes may be arranged to change over time. In a further embodiment, the conductive loop may form a region at least partially surrounded thereby, and an amount of the magnetic fluxes which intersect the region may then be arranged to change over time.

Any of the foregoing electromagnetic induction generators may also include multiple magnetic members and/or multiple induction members. Alternatively, the magnetic member may include multiple (permanent) magnets, the induction member may include multiple induction layers, and/or the induction layer may include multiple planar (or flat) conductive loops. In any of the foregoing generators, either or both of the magnet (or magnetic member) and the induction layer (or induction member) may move in response to the user input. In addition, the foregoing induction member may be arranged to include on its top and on its bottom at least one conductive loop respectively. To generate electric current by electromagnetic induction, such a generator may include at least one actuator arranged to move one of the magnetic and induction members with respect to the other thereof. In the alternative, when the conductive loop defines a region at least partially surrounded thereby, an actuator may be arranged to change over time an area of said region normally projected onto the magnetic fluxes and/or to change over time an amount of magnetic fluxes intersecting such a region.

In another aspect of the present invention, an AC or DC electromagnetic induction generator may be provided by various methods. One method may include the steps of emitting magnetic fluxes from at least one (permanent) magnet, disposing at least one planar (or flat) conductive loop adjacent to the magnet, applying a user input to the magnet and/or the conductive loop, and displacing one of the magnet and the conductive loop with respect to the other in response to the user input, thereby inducing electric current through the conductive loop. An alternative method may include the steps of emitting magnetic fluxes from at least one (permanent) magnet, disposing at least one planar (or flat) conductive loop adjacent to the magnet so as to receive the magnetic fluxes through a region at least partially surrounded by the conductive loop, and changing over time an area of the region of the conductive loop normally projected onto the magnetic fluxes, thereby inducing electric current through the conductive loop. Another method may include the steps of emitting magnetic fluxes from at least one (permanent) magnet, disposing at least one planar (or flat) conductive loop adjacent to the magnet in order to receive the magnetic fluxes through a region at least partially surrounded by the conductive loop, and changing an amount of the magnetic fluxes intersecting such a region of the conductive loop over time, thereby inducing electric current through the conductive loop.

An AC or DC electromagnetic induction generator may be provided by a method including the steps of emitting magnetic fluxes from at least one (permanent) magnet, disposing an induction layer adjacent to the magnet, and providing at least one planar (or flat) conductive loop in the induction layer while maintaining a total thickness of the induction layer and the conductive loop less than about, e.g., 3 mm, 2 mm, 1 mm, 100 microns, 10 microns, 1 micron, etc., such that at least a portion of the magnetic fluxes may intersect a region at least partially surrounded by the conductive loop. Such a method may include the steps of applying a user input to the magnet and/or induction layer and displacing such a magnet and/or induction layer with respect to the other in response to the user input, thereby inducing electric current through the conductive loop. The method may include one of the steps of changing an area of the region of the conductive loop normally projected onto the magnetic fluxes over time so as to induce electric current through the conductive loop and changing an amount of the magnetic fluxes intersecting the region of the conductive loop so as to induce electric current through the conductive loop over time.

An AC or DC electromagnetic induction generator may also be provided by a method including the steps of emitting magnetic fluxes from at least one (permanent) magnet and disposing at least one planar (or flat) conductive loop adjacent to the magnet within a distance of about, e.g., 5 mm, 3 mm, 2 mm, 1 mm, 100 microns, 10 microns, 1 micron, etc., to receive at least a portion of the magnetic fluxes through a region at least partially surrounded by the conductive loop. Such a method may include the steps of applying a user input to the magnet and/or the induction layer and then displacing the magnet and/or the conductive loop with respect to the other in response to the user input, thereby inducing electric current through the conductive loop. The method may include one of the steps of changing an area of the region of the conductive loop normally projected onto the magnetic fluxes over time while maintaining the distance therebetween in order to induce electric current through the conductive loop and changing over time an amount of the magnetic fluxes intersecting such a region of the conductive loop while maintaining such a distance therebetween to induce electric current through the conductive loop.

Such an AC or DC electromagnetic induction generator may be provided by a method including the steps of disposing at least one (permanent) magnet emitting magnetic fluxes, disposing at least one (non-conductive) substrate layer adjacent to the magnet, depositing at least one planar (or flat) conductive loop on the substrate layer (by at least one of chemical vapor deposition, physical vapor deposition, ion bombardment, etc.) to receive at least a portion of the magnetic fluxes, applying a user input to the magnet and/or the substrate layer, and displacing the magnet and/or substrate layer with respect to the other in response to the user input to induce electric current through the conductive loop. An AC or DC electromagnetic induction generator may be provided by an alternative method also including the steps of disposing at least one (permanent) magnet emitting magnetic fluxes, disposing a (non-conductive) substrate layer adjacent to the magnet, depositing on such a substrate layer at least one planar (or flat) conductive layer by, e.g., chemical vapor deposition, physical vapor deposition, ion bombardment, etc., to receive at least a portion of the magnetic fluxes, etching at least a portion of the conductive layer based on a preset pattern to define at least one planar (or flat) conductive loop on at least a substantial portion of the conductive layer, applying a user input to the substrate layer and/or magnet, and displacing the magnet and/or the substrate layer relative to the other in response to the user input to induce electric current through the conductive loop. In another alternative, an AC or DC electromagnetic induction generator may be provided by a method including the steps of disposing at least one (permanent) magnet emitting magnetic fluxes, disposing a (non-conductive) substrate layer adjacent to the magnet, etching at least a substantial portion of the substrate layer based on a preset pattern, filling the etched portion with a conductive substance to define at least one planar (or flat) conductive loop therein, applying a user input to the magnet and/or substrate layer, and displacing the magnet and/or substrate layer with respect to the other in response to the user input to induce electric current through such a conductive loop. In another alternative, an AC or DC electromagnetic induction generator may also be provided by a method including the steps of disposing at least one (permanent) magnet emitting magnetic fluxes, disposing a (non-conductive) substrate layer adjacent to the magnet, doping at least a substantial portion of the substrate layer based on a preset pattern, curing the doped portion to form at least one planar (or flat) conductive loop, applying a user input to the substrate layer and/or magnet, and displacing the magnet and/or the substrate layer relative to the other in response to the user input to induce electric current through the conductive loop. An AC or DC electromagnetic induction generator may also be provided by another method including the steps of disposing at least one (permanent) magnet emitting magnetic fluxes, disposing a (non-conductive) substrate layer in a chamber, providing a conductive substance on at least a substantial portion of the substrate layer, fabricating the substrate layer into a single inductor including (or up to nine inductors each including) at least one conductive loop thereon, placing the inductor adjacent to the magnet, applying a user input to the magnet and/or inductor, and then displacing the magnet and/or inductor relative to the other in response to the user input to induce electric current through the conductive loop of the inductor.

Such an AC or DC electromagnetic induction generator may further be provided by a process including the steps of disposing at least one (permanent) magnet emitting magnetic fluxes, disposing a (non-conductive) substrate layer adjacent to the magnet, doping at least a substantial portion of the substrate layer based on a preset pattern, curing the doped portion into at least one planar (or flat) conductive loop, and configuring one of the magnet and the substrate layer to move with respect to the other. In the alternative, an AC or DC electromagnetic induction generator may also be provided by a process including the steps of disposing at least one (permanent) magnet emitting magnetic fluxes, disposing a (non-conductive) substrate layer adjacent to the magnet, depositing at least one planar (or flat) conductive layer on the substrate layer utilizing, e.g., chemical vapor deposition, physical vapor deposition, ion bombardment, etc., to receive at least a portion of the magnetic fluxes, etching at least a portion of the conductive layer according to a preset pattern in order to define at least one planar (or flat) conductive loop on at least a substantial portion of the conductive layer, and then configuring the magnet and/or substrate layer to move with respect to the other. In another alternative, an AC or DC electromagnetic induction generator may be provided by a process including the steps of disposing at least one (permanent) magnet emitting magnetic fluxes, disposing a (non-conductive) substrate layer adjacent to the magnet, etching at least a substantial portion of the substrate layer based on a preset pattern, filling the etched portion with at least one conductive substance to define at least one planar (or flat) conductive loop therein, and configuring the magnet and/or substrate layer to move relative to the other. In another alternative, an AC or DC electromagnetic induction generator may be provided by a process including the steps of disposing at least one (permanent) magnet emitting magnetic fluxes, placing a (non-conductive) substrate layer in a chamber, providing at least one conductive substance on at least a substantial portion of the substrate layer, preparing from such a substrate layer at least one to at most nine inductors each including at least one conductive loop thereon, placing the inductor adjacent to the magnet, and then configuring one of the magnet and the inductor to move with respect to the other.

Any of the foregoing methods may also include one or more of the steps of disposing multiple (permanent) magnets (in the magnetic member), disposing multiple conductive loops (in the induction layer, induction member), disposing multiple magnetic members, induction members, induction layers or substrate layers, etc., disposing multiple conductive loops in the induction layer or the substrate layer, moving the magnet (or the magnetic member), moving the conductive loop, induction member, induction layer, substrate layer, and so on. In addition, the methods involving the foregoing induction layers may include the step of providing at least one conductive loop on a top and a bottom of the induction layer. The methods involving the foregoing conductive layers may include the step of providing at least one conductive layer on a top and a bottom of the substrate layer and then etching all conductive layers to define at least one conductive loop on the top and bottom of the substrate layer. The method involving the above substrate layers may include the step of etching both of a top and a bottom of the substrate layer and then filling etched portions to define at least one conductive loop on the top and the bottom of the substrate layer or the step of doping a top and a bottom of the substrate layer and then curing the doped portions to define at least one conductive loop on the top and bottom of the substrate layer. In addition, the above method may include the steps of defining a region at least partially surrounded by the conductive loop and then changing over time an area of the region normally projected onto the magnetic fluxes or, alternatively, may include the steps of defining a region which is at least partially surrounded by the conductive loop and changing over time an amount of magnetic fluxes intersecting such a region.

In another aspect of this invention, a planar inductor is provided to generate electric current by electromagnetic induction. Such an inductor may include at least one (planar or flat) non-conductive substrate layer and at least one planar (or flat) conductive loop deposited over at least a substantial portion of the substrate layer and arranged to conduct electric current therethrough, where at least a substantial length of such a conductive loop is arranged to have at least substantially similar electrical conductivity, electron mobility, and hole mobility. In the alternative, an inductor may include at least one (planar or flat) non-conductive substrate layer and at least one planar (or flat) conductive loop which is deposited over at least a substantial portion of the substrate layer and arranged to conduct electric current therethrough, where a total thickness of the substrate layer and the conductive loop may be arranged to be less than, e.g., 5 mm, 4 mm, 3 mm, 2 mm, 1 mm, 100 microns, 10 microns, 1 micron, etc. In another alternative, an inductor may include at least one (planar or flat) non-conductive substrate layer and at least one planar (or flat) induction layer deposited over the substrate layer and including at least one planar (or flat) conductive loop and at least one planar (of flat) insulative region, where the conductive loop is arranged to conduct electric current therethrough, where the insulative region is arranged to block electric conduction and to abut at least a portion of the conductive loop, where the conductive loop and the insulative region are arranged to collectively occupy at least a substantial portion of the substrate layer, and where at least a substantial length of the above conductive loop is arranged to have at least substantially similar electric conductivity, electron mobility, and hole mobility. Another inductor may include at least one (planar or flat) non-conductive substrate layer and at least one planar (or flat) induction layer deposited over the substrate layer and including at least one planar (or flat) conductive loop and at least one planar (or flat) insulative region, where the conductive loop is arranged to conduct electric current therethrough, where the insulative region is arranged to abut at least a portion of the conductive loop and to block electric conduction, and where a total thickness of the conductive loop and the insulative region may be arranged to be less than, e.g., 5 mm, 4 mm, 3 mm, 2 mm, 1 mm, 100 microns, 10 microns, 1 micron, etc. In another alternative, an inductor may include at least one planar (or flat) conductive loop conducting electric current therethrough, where at least a substantial length of such a conductive loop is arranged to have at least substantially similar electric conductivity, electron mobility, and hole mobility. In yet another alternative, an inductor may include at least one planar (or flat) conductive loop, where an entire portion of such a loop may be arranged to conduct electric current therethrough and also to have a thickness less than, e.g., 5 mm, 3 mm, 2 mm, 1 mm, 100 microns, 10 microns, 1 micron, etc.

Any of the foregoing inductors may also be arranged to include at least one induction layer on a top and a bottom of the substrate layer. When the conductive loops are directly disposed over the substrate layer without separately defining an induction layer, at least one conductive loop may also be provided on a top and a bottom of a substrate layer. Any of the foregoing processes may include the steps of defining a region at least partially surrounded by the conductive loop and changing over time an area of said region normally projected onto said magnetic fluxes or, alternatively, the steps of defining a region at least partially surrounded by the conductive loop and then changing over time an amount of magnetic fluxes intersecting the region.

In another aspect of the present invention, a planar inductor for an AC or DC electromagnetic induction generator may be provided by various methods (or processes) all including an initial step of forming a (planar or flat) non-conductive substrate layer. One method (or process) may include the step of providing at least one planar (or flat) conductive loop over at least a substantial area of such a substrate layer, where at least a substantial length of the conductive loop may be arranged to have at least substantially similar electric conductivity, electron mobility, and hole mobility. Another method (or process) may include the step of providing at least one planar (or flat) conductive loop over at least a substantial area of the substrate layer while maintaining a total thickness of the substrate layer and the conductive loop less than, e.g., 5 mm, 3 mm, 2 mm, 1 mm, 100 microns, 10 microns, 1 micron, etc., where at least a substantial length of such a conductive loop is arranged to have at least substantially similar electric conductivity, electron mobility, and hole mobility. Another method (or process) may also include the step of providing at least one planar (or flat) conductive loop over at least a substantial area of the substrate layer, where at least a substantial length of the conductive loop has at least one of at least substantially similar electric conductivity, electron mobility, and hole mobility and fabricating such a substrate layer into a single inductor (up to at most nine inductors). An alternative method (or process) may include the step of providing at least one planar (or flat) conductive loop over at least a substantial area of the substrate layer while maintaining a total thickness of the substrate layer and the conductive loop less than, e.g., 5 mm, 3 mm, 2 mm, 1 mm, 100 microns, 10 microns, 1 micron, etc., where at least a substantial length of such a conductive loop has at least substantially similar electric conductivity, electron mobility, and/or hole mobility, and fabricating such a substrate layer into a single inductor or up to nine inductors. Another method (or process) may also include the steps of placing the substrate layer in a chamber, depositing at least one planar (or flat) conductive loop over at least a substantial area of the substrate layer, where at least a substantial length of the conductive loop has at least substantially similar electric conductivity, electron mobility, and hole mobility, and fabricating the substrate layer into a single inductor or up to nine inductors.

A planar inductor for an AC or DC electromagnetic induction generator may also be provided by other methods (or processes) all of which include an initial step of forming a (planar or flat) non-conductive substrate layer. One method (or process) may include the step of depositing a planar (or flat) conductive layer on the substrate layer and etching a portion of the conductive layer to leave on the substrate layer at least one planar (or flat) conductive loop on the substrate layer, where at least a substantial length of the loop is arranged to have at least substantially similar electric conductivity, electron mobility, and hole mobility. Another method (or process) may include the steps of depositing a planar (or flat) conductive layer on the substrate layer while maintaining a total thickness of such a substrate layer and conductive layer not exceeding, e.g., 5 mm, 3 mm, 2 mm, 1 mm, 100 microns, 10 microns, 1 micron, etc., and etching a portion of the conductive layer to leave on the substrate layer at least one planar (or flat) conductive loop at least a substantial length of which is arranged to have at least substantially similar electric conductivity, electron mobility, and hole mobility. Another method (or process) may include the steps of depositing a planar (or flat) conductive layer on the substrate layer, etching a portion of the conductive layer to leave on the substrate layer at least one planar (or flat) conductive loop, where at least a substantial length of said loop may have at least substantially similar electric conductivity, electron mobility, and/or hole mobility, and fabricating the substrate layer into a single inductor or up to nine inductors. An alternative method may also include the steps of depositing a planar (or flat) conductive layer on the substrate layer while maintaining a combined thickness of the substrate layer and conductive layer less than, e.g., 5 mm, 4 mm, 3 mm, 2 mm, 1 mm, 100 microns, 10 microns, 1 micron, etc., etching a portion of the conductive layer to leave at least one planar (or flat) conductive loop on the substrate layer at least a substantial length of which has at least substantially similar electric conductivity, electron mobility, and/or hole mobility, and fabricating the substrate layer into a single inductor or up to nine inductors. A further alternative method (or process) may include the steps of depositing a planar (or flat) conductive layer on the substrate layer, etching a portion of the conductive layer so as to leave on the substrate layer at least one planar (or flat) conductive loop at least a substantial length of which has at least substantially similar electric conductivity, electron mobility, and hole mobility, and then fabricating the substrate layer into a single inductor or up to nine inductors).

A planar inductor for an AC or DC electromagnetic induction generator may also be provided by other methods (or processes) all of which include an initial step of forming a (planar or flat) non-conductive substrate layer. One method (or process) may include the step of depositing a planar (or least a substantial portion of a top of the substrate layer and filling the etched portion of the top of the substrate layer with at least one conductive substance to define on the substrate layer at least one planar (or flat) conductive loop at least a substantial length of which has at least substantially similar electric conductivity, electron mobility, and hole mobility. Another method (or process) may include the steps of etching at least a substantial portion of a top of such a substrate layer and filling the etched portion of the top of the substrate layer with at least one conductive material while maintaining a total thickness of the substrate layer with the conductive material less than, e.g., 5 mm, 3 mm, 2 mm, 1 mm, 100 microns, 10 microns, 1 micron, etc., to define on the substrate layer at least one planar (or flat) conductive loop at least a substantial length of which has at least one of at least substantially similar electric conductivity, electron mobility, and hole mobility. An alternative method (or process) may also include the steps of etching at least a substantial portion of a top of such a substrate layer, filling the etched portion of the top of the substrate layer with at least one conductive substance to define on the substrate layer at least one planar (or flat) conductive loop at least a substantial length of which is arranged to have at least substantially similar electric conductivity, electron mobility, and hole mobility, and fabricating the substrate layer into a single inductor or up to nine inductors. Another method (or process) may include the steps of etching at least a substantial portion of a top of the substrate layer, filling the etched portion of the top of the substrate layer with a conductive material while maintaining a total thickness of the substrate layer with the conductive material less than, e.g., 5 mm, 3 mm, 2 mm, 1 mm, 100 microns, 10 microns, 1 micron, etc., so as to define on the substrate layer at least one planar (or flat) conductive loop at least a substantial length of which has at least one of at least substantially similar electric conductivity, electron mobility, and hole mobility, and fabricating the substrate layer into a single inductor or up to nine inductors. An alternative method (or process) may further include the steps of etching at least a substantial portion of a top of the substrate layer, filling the etched portion of the top of the substrate layer with a conductive substance to define on the substrate layer at least one planar (or flat) conductive loop at least a substantial length of which is arranged to have at least substantially similar electric conductivity, electron mobility, and hole mobility, and then fabricating such a substrate layer into a single inductor or up to nine inductors.

A planar inductor for an AC or DC electromagnetic induction generator may be provided by other methods (or processes) all including an initial step of forming a (planar or flat) non-conductive substrate layer. One method (or process) may include the step of doping at least a substantial area of the substrate layer and curing such a doped area into at least one planar (or flat) conductive loop which conducts electric current therethrough, where at least a substantial length of the conductive loop has at least substantially similar electric conductivity, electron mobility, and hole mobility. Another method (or process) may include the steps of doping at least a substantial area of the substrate layer, curing such a doped area into at least one planar (or flat) conductive loop conducting electric current therethrough, where at least a substantial length of such a conductive loop has at least substantially similar electric conductivity, electron mobility, and hole mobility, and fabricating the substrate layer into at least one or up to nine inductors. Another method (or process) may include the steps of forming a (planar or flat) non-conductive substrate layer having a thickness less than, e.g., 5 mm, 3 mm, 2 mm, 1 mm, 100 microns, 10 microns, 1 micron, etc., doping at least a substantial area of the substrate layer, and curing such a doped area into at least one planar (or flat) conductive loop arranged to conduct electric current therethrough, where at least a substantial length of the conductive loop has at least substantially similar electric conductivity, electron mobility, and hole mobility. An alternative method (or process) may include the steps of forming a (planar or flat) non-conductive substrate layer having a thickness less than, e.g., 5 mm, 3 mm, 2 mm, 1 mm, 100 microns, 10 microns, 1 micron, etc., doping at least a substantial area of the substrate layer, curing the doped area into at least one planar (or flat) conductive loop arranged to conduct electric current therethrough, where at least a substantial length of the conductive loop has at least substantially similar electric conductivity, electron mobility, and hole mobility, and fabricating the substrate layer into at least one and at most seven inductors. A further method (or process) may include the steps of doping at least a substantial area of the substrate layer, curing such a doped area into at least one planar (or flat) conductive loop conducting electric current therethrough, where at least a substantial length of such a conductive loop has at least substantially similar electric conductivity, electron mobility, and hole mobility, and fabricating the substrate layer into at least one and at most nine inductors.

Any of the above methods may include the step of providing at least one conductive loop on a top and a bottom of the substrate layer. More particularly, the methods involving the conductive layers may include the step of providing at least one conductive layer on a top and a bottom of the substrate layer, where each conductive layer may include at least one conductive loop therein or thereon. The methods including the substrate layers may also include the steps of etching a top and a bottom of the substrate layer and filling etched portions to define at least one conductive loop on the top and bottom of the substrate layer and/or the steps of doping a top and a bottom of the substrate layer and curing doped portions to define at least one conductive loop on the top and the bottom of the substrate layer.

In another aspect of the present invention, planar inductors are provided for electromagnetic induction generators to induce electric current through various conductive loops of such inductors. A planar inductor may include at least one (non-conductive) substrate layer. In one embodiment, such an inductor also includes at least one curvilinear conductive loop provided on the substrate layer and arranged to have at least substantially similar electric conductivity, electron mobility, and hole mobility to conduct electric current therethrough bi-directionally, where the loop is arranged to have a length, e.g., at least 10,000, 5,000, 1,000, 500, 100, 50, 10 or 5 times longer than a characteristic dimension of the substrate layer and, e.g., at least 10,000, 5,000, 1,000, 500, 100, 50, 10 or 5 times greater than a thickness of the substrate layer. In another embodiment, the inductor includes multiple curvilinear conductive loops provided on the substrate layer and arranged to have at least substantially similar electric conductivity, electron mobility, and hole mobility to conduct electric current therethrough bi-directionally, where the loops are arranged to have a total length, e.g., at least 10,000, 5,000, 1,000, 500, 100, 50, 10 or 5 times longer than a characteristic dimension of the substrate layer and, e.g., at least 10,000, 5,000, 1,000, 500, 100, 50, 10 or 5 times greater than a thickness of the substrate layer. In yet another embodiment, the inductor includes at least one curvilinear conductive loop provided on the substrate layer and having at least substantially similar electric conductivity, electron mobility, and hole mobility to conduct electric current therethrough bi-directionally, where the loop is arranged to have a thickness less than, e.g., 5 mm, 4 mm, 3 mm, 2 mm, 1 mm, 100 microns, 10 microns, 1 micron, etc., and to have a length, e.g., at least 10,000, 5,000, 1,000, 500, 100, 50, 10 or 5 times longer than a characteristic dimension of the substrate layer and, e.g., at least 10,000, 5,000, 1,000, 500, 100, 50, 10 or 5 times greater than a thickness of such a substrate layer. In a further embodiment, the inductor may also include multiple curvilinear conductive loops provided on the substrate layer and arranged to have at least substantially similar electric conductivity, electron mobility, and hole mobility to conduct electric current therethrough bi-directionally, where such loops are arranged to have a thickness less than, e.g., 5 mm, 3 mm, 2 mm, 1 mm, 100 microns, 10 microns, 1 micron, etc., to have a length, e.g., at least 10,000, 5,000, 1,000, 500, 100, 50, 10 or 5 times longer than a characteristic dimension of such a substrate layer, and to have such a length, e.g., at least 10,000, 5,000, 1,000, 500, 100, 50, 10 or 5 times greater than a thickness of the substrate layer. Any of the foregoing planar inductors may also be arranged to have at least one conductive layer on a top and a bottom of the substrate layer.

A planar inductor may include at least one (non-conductive) substrate layer and at least one spiral conductive loop provided over the substrate layer and between a region near one edge of the substrate layer and a region near a center of the substrate layer. In one embodiment, such a loop is arranged to cover at least a substantial portion of the substrate layer. In another embodiment, such a loop may also be arranged to revolve about a center of the substrate layer by multiple revolutions. In an alternative embodiment, at least a substantial length of the loop may also have at least substantially similar electric conductivity, electron mobility, and hole mobility such that the loop may conduct current therethrough bi-directionally. In a further embodiment, the loop and substrate layer may have a total or combined thickness less than, e.g., 5 mm, 3 mm, 2 mm, 1 mm, 100 microns, 10 microns, 1 micron, etc.

A planar inductor may include at least one (non-conductive) substrate layer and multiple spiral conductive loops provided over the substrate layer, where at least one of the spiral conductive loops is disposed between a region near one edge of the substrate layer and a region near a center of the substrate layer. Such loops may be arranged to cover at least a substantial portion of the substrate layer. At least one of such loops may be arranged to revolve around a center of the substrate layer by multiple revolutions. At least two of the loops may also be radially disposed either symmetrically or asymmetrically about a center of the substrate layer. At least substantial lengths of such loops may have at least substantially similar electric conductivity, electron mobility, and hole mobility to conduct electric therethrough bi-directionally. Such loops and substrate layer may have a combined thickness less than, e.g., 5 mm, 3 mm, 2 mm, 1 mm, 100 microns, 10 microns, 1 micron, etc. At least one of such loops may be arranged to be interposed with at least one of others of the loops. In addition, the planar inductor may further include multiple induction layers each disposed over the substrate layer and each including at least one of the loops, where the substrate layer and induction layer having the loops are arranged to have a combined thickness less than, e.g., 5 mm, 4 mm, 3 mm, 2 mm, 1 mm, 100 microns, 10 microns, 1 micron, etc. At least two of the loops may be electrically connected to define a parallel conductive loop or a series conductive loop.

A planar inductor may also include at least one (non-conductive) substrate layer and at least one circular, arcuate or otherwise curved conductive loop provided over the substrate layer about a center of the substrate layer. In one embodiment, such a loop may cover at least a substantial portion of the substrate layer. In another embodiment, at least a substantial length of such a loop may have at least substantially similar electric conductivity, electron mobility, and hole mobility to conduct electric current therethrough bi-directionally. In yet another embodiment, such a loop and substrate layer may have a combined thickness less than, e.g., 5 mm, 4 mm, 3 mm, 2 mm, 1 mm, 100 microns, 10 microns, 1 micron, etc.

A planar inductor may include at least one (non-conductive) substrate layer as well as multiple circular, arcuate or otherwise curved conductive loops provided over the substrate layer and about a center of the substrate layer. The loops may be arranged to cover at least a substantial portion of the substrate layer. At least two of the loops may be disposed at least substantially concentrically about a center of the substrate layer. Alternatively, at least two of the loops may be radially disposed about a center of the substrate layer. At least substantial lengths of such loops may be arranged to have at least substantially similar electric conductivity, electron mobility, and hole mobility to conduct electric current therethrough bi-directionally. The loops and substrate layer may have a combined thickness less than, e.g., 5 mm, 4 mm, 3 mm, 2 mm, 1 mm, 100 microns, 10 microns, 1 micron, etc. In addition, at least one of the loops may be arranged to be interposed with at least one of others of the loops. The planar inductor may also include multiple induction layers each disposed over the substrate layer and each including at least one of the loops, where the substrate layer and induction layer including such loops may be arranged to have a combined thickness less than, e.g., 5 mm, 4 mm, 3 mm, 2 mm, 1 mm, 100 microns, 10 microns, 1 micron, etc. In addition, at least two of such loops may also be electrically connected to define a parallel conductive loop or a series conductive loop.

A planar inductor may further include at least one (non-conductive) substrate layer as well as least one curvilinear triangular conductive loop provided over the substrate layer. In one embodiment, such a loop may be arranged to cover at least a substantial portion of the substrate layer. In another embodiment, the loop may be arranged to enclose a center of the substrate layer therein or disposed between an edge and a center of the substrate layer. In another embodiment, at least a substantial length of the loop may have an at least substantially similar electric conductivity, electron mobility, and hole mobility to conduct current therethrough bi-directionally. In a further embodiment, such a loop and substrate layer may have a combined thickness less than, e.g., 5 mm,3 mm, 2 mm, 1 mm, 100 microns, 10 microns, 1 micron, etc.

A planar inductor may include at least one (non-conductive) substrate layer as well as multiple curvilinear triangular conductive loops provided over the substrate layer. The loops may be arranged to cover at least a substantial portion of the substrate layer. In addition, at least one of the loops may be arranged to enclose a center of the substrate layer therein, to be disposed between an edge and a center of the substrate layer, and the like. At least substantial lengths of the loops may have at least substantially similar electric conductivity, electron mobility, and hole mobility in order to conduct electric therethrough bi-directionally. The loops and the substrate layer may have a combined thickness less than, e.g., 5 mm, 3 mm, 2 mm, 1 mm, 100 microns, 10 microns, 1 micron, etc. At least one of the loops may be arranged to be interposed with at least one of others thereof. The planar inductor may also include multiple induction layers each disposed over the substrate layer and each including at least one of the loops, where the substrate layer and the induction layer having the loops may have a total or combined thickness not exceeding, e.g., 5 mm, 4 mm, 3 mm, 2 mm, 1 mm, 100 microns, 10 microns, 1 micron, etc. At least two of the loops may be electrically connected to define a parallel conductive loop or a series conductive loop.

A planar inductor may also include at least one (non-conductive) substrate layer and at least one curvilinear trapezoidal conductive loop provided over the substrate layer and each having four curvilinear sides, where a bottom side of the loop is flipped with respect to a top side thereof so that opposing curvilinear lateral sides of the loop are arranged to cross each other but do not electrically contact each other. In one embodiment, such a loop may be arranged to cover at least a substantial portion of the substrate layer. In another embodiment, the loop may enclose a center of the substrate layer therein or may not enclose a center of the substrate layer therein. In yet another embodiment, at least a substantial length of the loop has an at least substantially similar electric conductivity, electron mobility, and hole mobility to conduct current therethrough bi-directionally. In a further embodiment, the loop and substrate layer may have a combined thickness less than, e.g., 5 mm, 3 mm, 2 mm, 1 mm, 100 microns, 10 microns, 1 micron, etc.

A planar inductor may include at least one (non-conductive) substrate layer as well as multiple curvilinear trapezoidal conductive loops provided over the substrate layer. Each of such loops may include four curvilinear sides, where a bottom side of each of the loops is flipped with respect to a top side thereof so that opposing curvilinear lateral sides of each of the loops are arranged to cross each other but do not electrically contact each other. Such loops may cover at least a substantial portion of the substrate layer. At least one of such loops may be arranged to or not to enclose a center of the substrate layer therein. At least substantial lengths of the loops may have at least substantially similar electric conductivity, electron mobility, and hole mobility so as to conduct electric current therethrough bi-directionally. The loops and substrate layer may have a combined thickness less than, e.g., 5 mm, 3 mm, 2 mm, 1 mm, 100 microns, 10 microns, 1 micron, etc. At least one of the loops may be arranged to be interposed with at least one of others of the loops. The planar inductor may also include multiple induction layers each disposed over the substrate layer and each including at least one of the loops, where the substrate layer and the induction layer having the loops are arranged to have a combined thickness less than, e.g., 5 mm, 4 mm, 3 mm, 2 mm, 1 mm, 100 microns, 10 microns, 1 micron, etc. At least two of the loops may also be electrically connected to form a parallel conductive loop or a series conductive loop.

A planar inductor may also include at least one (non-conductive) substrate layer and multiple curvilinear semi-diagonal conductive loops or multiple curvilinear diagonal conductive loops provided over the substrate layer. Either of such loops may cover at least a substantial portion of the substrate layer, and may be disposed radially about a center of the substrate layer intersecting one another in a region near the center of the substrate layer. At least substantial lengths of either of such loops may have at least substantially similar electric conductivity, electron mobility, and hole mobility to conduct electric therethrough bi-directionally. Such loops and substrate layer may have a combined thickness less than, e.g., 5 mm, 4 mm, 3 mm, 2 mm, 1 mm, 100 microns, 10 microns, 1 micron, etc. In addition, the planar inductor may include multiple induction layers each disposed over the substrate layer and each including at least one of either of the loops, where the substrate layer and the induction layer having the loops may be arranged to have a combined thickness less than, e.g., 5 mm, 4 mm, 3 mm, 2 mm, 1 mm, 100 microns, 10 microns, 1 micron, etc. At least two of either of such loops may be electrically connected to define a parallel conductive loop or a series conductive loop.

A planar inductor may also include at least one (non-conductive) substrate layer and multiple linear conductive loops provided over the substrate layer, where at least some of the linear loops are arranged to be at least substantially parallel to one another. Such loops may be arranged to cover at least a substantial portion of the substrate layer. At least substantial lengths of the linear loops may have at least substantially similar electric conductivity, electron mobility, and hole mobility to conduct electric current therethrough bi-directionally. Such loops and substrate layer may have a combined or total thickness less than, e.g., 5 mm, 4 mm, 3 mm, 2 mm, 1 mm, 100 microns, 10 microns, 1 micron, etc. The planar inductor may include multiple induction layers each disposed over the substrate layer and each including at least one of the loops, where the substrate layer and the induction layer having the loops are arranged to have a combined thickness less than, e.g., 5 mm, 4 mm, 3 mm, 2 mm, 1 mm, 100 microns, 10 microns, 1 micron, etc. At least two of the loops may be electrically connected to define a parallel conductive loop or a series conductive loop.

Alternatively, a planar inductor may also include at least one (non-conductive) substrate layer and multiple linear conductive loops provided over the substrate layer, where some of the loops are parallel to each other, while others of the loops are parallel to each other and cross other loops at a predetermined angle. Such loops may cover at least a substantial portion of the substrate layer. At least substantial lengths of the loops may have at least substantially similar electric conductivity, hole mobility, and electron mobility in order to conduct electric therethrough bi-directionally. Such loops and substrate layer may have a combined thickness less than, e.g., 5 mm, 4 mm, 3 mm, 2 mm, 1 mm, 100 microns, 10 microns, 1 micron, etc. The planar inductor may include multiple induction layers each disposed over the substrate layer and each including at least one of the loops, where the substrate layer and induction layer having the loops may be arranged to have a combined or total thickness less than, e.g., 5 mm, 4 mm, 3 mm, 2 mm, 1 mm, 100 microns, 10 microns, 1 micron, etc. At least two of the loops may be electrically connected to define a parallel conductive loop or a series conductive loop.

The foregoing planar inductors may also be arranged to have multiple conductive loops which are provided in multiple levels along heights of the substrate layers. For example, multiple conductive loops may be provided on one side of the substrate layer in such a way that each level may include at least one conductive loop having, e.g., triangular, trapezoidal, semi-diagonal, polygonal, linear, spiral, circular, arcuate or otherwise curved, configurations. When desirable, the conductive loops having different configurations may be provided to each level over the substrate layer and/or each level may also be defined as an individual induction layer by, e.g., embedding such conductive loops between or inside insulative materials. In addition, at least one triangular, trapezoidal, semi-diagonal, linear, spiral, circular, arcuate, otherwise curved conductive loop may be provided on both sides or on a top and a bottom of the substrate layer.

Planar inductors and, more particularly, various conductive loops of such planar inductors for electromagnetic generators may also be provided by various methods or processes so as to generate electric current by electromagnetic induction. In general, such methods or processes may include the steps of disposing at least one (non-conductive) substrate layer and selecting at least one conductive material for conducting electric current therethrough bi-directionally. In one embodiment, the method or process includes the step of providing on the substrate layer at least one curvilinear conductive loop made of the material while configuring the loop to have a total length at least, e.g., about 1,000, 500, 250, 100, 50, 10 or 5 times longer than a characteristic dimension (e.g., a length, width or diameter) of the substrate layer and also at least, e.g., about 1,000, 500, 250, 100, 50, 10 or 5 times greater than a thickness or a height of the substrate layer. In another embodiment, the method or process includes the step of providing over the substrate layer multiple curvilinear conductive loops from the material while configuring the loops to have a total length at least, e.g., about 1,000, 500, 250, 100, 50, 10 or 5 times longer than the characteristic dimension of the substrate layer and similarly at least, e.g., about 1,000, 500, 250, 100, 50, 10 or 5 times greater than a thickness or a height of the substrate layer. In another embodiment, the method or process includes the step of providing on the substrate layer at least one curvilinear conductive loop made of the material while configuring the loop to have a length at least, e.g., about 1,000, 500, 250, 100, 50, 10 or 5 times longer than the characteristic dimension of the substrate layer and also at least, e.g., about 1,000, 500, 250, 100, 50, 10 or 5 times greater than a thickness of the layer and to have a total thickness less than, e.g., about 10 mm, 5 mm, 3 mm, 2 mm, 1 mm, 100 microns, 10 microns, 1 micron, etc. In yet another embodiment, the method or process may include the step of providing on the substrate layer multiple curvilinear conductive loops made of the above material while configuring the loops to have a length at least, e.g., about 1,000, 500, 250, 100, 50, 10 or 5 times longer than the characteristic dimension of the layer and at least, e.g., about 1,000, 500, 250, 100, 50, 10 or 5 times greater than a thickness of the layer, and further to have a thickness less than, e.g., about 10 mm, 5 mm, 3 mm, 2 mm, 1 mm, 100 microns, 10 microns, 1 micron, etc.

Planar inductors may also be provided by various methods or processes including the steps of disposing at least one (non-conductive) substrate layer and providing over the substrate layer at least one spiral conductive loop between a region near one edge of the substrate layer and a region near a center of the substrate layer. Such a method or process may include one of the steps of covering at least a substantial portion of the substrate layer by the loop, revolving the loop around a center of the substrate layer by multiple turns, arranging at least substantial lengths of such a loop to have at least substantially similar electron mobility, hole mobility, and electric conductivity to conduct electric current therethrough bi-directionally, and configuring the loop and the substrate layer have a combined or total thickness less than, e.g., about 10 mm, 5 mm, 3 mm, 2 mm, 1 mm, 100 microns, 10 microns or 1 micron

Planar inductors may also be provided by various methods or processes including the steps of disposing at least one (non-conductive) substrate layer and providing over the substrate layer multiple spiral conductive loops by disposing at least one of the loops between a region near one edge of the substrate layer and a region near a center of the substrate layer. Such a method or process includes one of the steps of covering at least a substantial portion of the substrate layer by the loops, winding at least one of the loops about a center of the substrate layer by multiple turns, radially disposing two or more of the loops about a center of the substrate layer, arranging at least substantial lengths of the loops to have at least substantially similar electron mobility, hole mobility, and electric conductivity to conduct electric current therethrough bi-directionally, configuring the loop and the substrate layer to have a combined or total thickness less than, e.g., about 5 mm, 3 mm, 2 mm, 1 mm, 100 microns, 10 microns, 1 micron, etc., interposing at least one of the loops with at least one of others of the loops, connecting at least two of the loops and defining a parallel conductive loop., and connecting at least two of the loops to define a series conductive loop. Such a method or process may also include the steps of providing multiple induction layers over the planar inductor and providing at least one of the loops in each of the induction layers while maintaining a total or combined thickness of the substrate layer and the induction layers to be less than, e.g., 10 mm, 5 mm, 3 mm, 2 mm, 1 mm, 100 microns, 10 microns, 1 micron, etc.

Planar inductors may also be provided by various methods or processes including the steps of disposing at least one (non-conductive) substrate layer and providing over the substrate layer multiple circular, arcuate or otherwise curved conductive loop around a center of the substrate layer. Such a method or process further includes the step of covering at least a substantial portion of the substrate layer by the loop, arranging at least a substantial length of the loop to have at least substantially similar electron mobility, hole mobility, and electric conductivity so as to conduct electric current therethrough bi-directionally, and/or configuring the loop and the substrate layer have a combined or total thickness less than, e.g., about 10 mm, 5 mm, 3 mm, 2 mm, 1 mm, 100 microns, 10 microns, 1 micron, etc.

Planar inductors may also be provided by various methods or processes including the steps of disposing at least one (non-conductive) substrate layer and providing over the substrate layer multiple circular, arcuate or otherwise curved conductive loops about a center of the substrate layer. Such a method or process may also include one of the steps of covering at least a substantial portion of the substrate layer by the loop, concentrically disposing at least two of such loops around a center of the substrate layer, disposing at least two of the loops radially with respect to a center of the substrate layer, arranging at least substantial lengths of the loops to have at least substantially similar electron mobility, hole mobility, and electric conductivity to conduct electric current therethrough bi-directionally, configuring the loops and the substrate layer to have a total or combined thickness less than, e.g., about 10 mm, 5 mm, 3 mm, 2 mm, 1 mm, 100 microns, 10 microns, 1 micron, etc., interposing at least one of the loops with at least one of others of the loops, connecting at least two of the loops to define a parallel conductive loop, and connecting at least two of the loops to define a series conductive loop. Such a method or process may also include the steps of providing a plurality of induction layers over the planar inductor and providing at least one of the loops in each of the above induction layers while maintaining a total or combined thickness of the substrate layer and the induction layers not to exceed, e.g., about 10 mm, 5 mm, 3 mm, 2 mm, 1 mm, 100 microns, 10 microns, 1 micron, etc.

Planar inductors may also be provided by various methods or processes including the steps of disposing at least one (non-conductive) substrate layer and providing over the substrate layer at least one curvilinear triangular conductive loop. The method or process may also include at least one of the steps of covering at least a substantial portion of the substrate layer by such a loop, at least partially enclosing a center of the substrate layer within or inside the loop, disposing such a loop between an edge and a center of the substrate layer, arranging at least a substantial length of the loop to have at least substantially similar electron mobility, hole mobility, and electric conductivity in order to conduct electric current therethrough bi-directionally, and configuring the loop and the substrate layer have a total or combined thickness not exceeding, e.g., about 10 mm, 5 mm, 3 mm, 2 mm, 1 mm, 100 microns, 10 microns, 1 micron, etc.).

Planar inductors may also be provided by various methods or processes including the steps of disposing at least one (non-conductive) substrate layer and providing over the substrate layer multiple curvilinear triangular conductive loops. The method or process may further include one or more of the steps of covering at least a substantial portion of the substrate layer by the loop, enclosing a center of the substrate layer inside at least one of the loops, disposing at least one of the loops between an edge and a center of the substrate layer, arranging at least substantial lengths of the loops to have at least substantially similar electron mobility, hole mobility, and electric conductivity to conduct electric current therethrough bi-directionally, configuring the loops and the substrate layer have a combined or total thickness not exceeding, e.g., about 10 mm, 5 mm, 3 mm, 2 mm, 1 mm, 100 microns, 10 microns, 1 micron, etc., interposing at least one of the loops with at least one of others of the loops, connecting at least two of the loops to define a parallel conductive loop, and connecting at least two of the loops to define a series conductive loop. Such a method or process may also include the steps of providing a plurality of induction layers over the planar inductor and providing at least one of the loops in each of the induction layers while maintaining a total or combined thickness of the substrate layer and the induction layers less than, e.g., about 10 mm, 5 mm, 3 mm, 2 mm, 1 mm, 100 microns, 10 microns or 1 micron.

Planar inductors may also be provided by various methods or processes including the steps of disposing at least one (non-conductive) substrate layer and providing over the substrate layer at least one curvilinear trapezoidal conductive loop having four curvilinear sides, where a bottom side of such a loop is flipped with respect to a top side thereof so that opposing curvilinear lateral sides of the loop are arranged to cross but do not electrically contact each other. Such a method or process includes one or more of the steps of covering at least a substantial portion of the substrate layer by the loop, enclosing or nor enclosing a center of the substrate layer within or inside the loop, arranging at least a substantial length of the loop to have at least substantially similar electron mobility, hole mobility, and electric conductivity to conduct electric current therethrough bi-directionally, configuring the loop and the substrate layer to have a combined or total thickness less than, e.g., 10 mm, 5 mm, 3 mm, 2 mm, 1 mm, 100 microns, 10 microns, 1 micron, etc.

Planar inductors may also be provided by various methods or processes including the steps of disposing at least one (non-conductive) substrate layer and providing over the substrate layer multiple curvilinear trapezoidal conductive loops with four curvilinear sides, where bottom sides of the loops are flipped with respect to top sides thereof so that opposing curvilinear lateral sides of the loops are arranged to cross but do not electrically contact each other. The method or process may include one or more of the steps of covering at least a substantial portion of the substrate layer by the foregoing loops, enclosing or not enclosing a center of the substrate layer within or inside at least one of such loops, arranging at least substantial lengths of the loops to have at least substantially similar electron mobility, hole mobility, and electric conductivity to conduct electric current therethrough bi-directionally, configuring the loops and the substrate layer to have a combined or total thickness less than, e.g., 10 mm, 5 mm, 3 mm, 2 mm, 1 mm, 100 microns, 10 microns, 1 micron, etc., interposing at least one of the loops with at least one of others of the loops, connecting at least two of the loops to define a parallel conductive loop, and connecting at least two of the loops to define instead a series conductive loop. Such a method or process may include the steps of providing multiple induction layers over the planar inductor and providing at least one of the loops in each of the induction layers while maintaining a total or combined thickness of the substrate layer and the induction layers less than, e.g., 10 mm, 5 mm, 3 mm, 2 mm, 1 mm, 100 microns, 10 microns, 1 micron, etc.

Planar inductors may also be provided by various methods or processes including the steps of disposing at least one (non-conductive) substrate layer and providing over the substrate layer multiple curvilinear semi-diagonal conductive loops or diagonal conductive loops. The method or process may include one or more of the steps of covering at least a substantial portion of the substrate layer by the loops, disposing the loops radially with respect to a center of the substrate layer, arranging at least substantial lengths of the loops to have at least substantially similar electron mobility, hole mobility, and electric conductivity to conduct electric current therethrough bi-directionally, configuring the loops and the substrate layer to have a combined or total thickness less than about, e.g., 10 mm, 5 mm, 3 mm, 2 mm, 1 mm, 100 microns, 10 microns, 1 micron, etc., and connecting at least two of the loops to define a parallel conductive loop or a a series conductive loop. The method or process may also include the steps of providing a plurality of induction layers over the planar inductor and providing at least one of the loops in each induction layer while maintaining a combined or total thickness of the substrate layer and the induction layers not exceeding, e.g., about 10 mm, 5 mm, 3 mm, 2 mm, 1 mm, 100 microns, 10 microns, 1 micron, etc. The method or process may further include the step of radially disposing the loops about a center of the substrate layer intersecting one another in a region near the center of the substrate layer.

Planar inductors may also be provided by various methods or processes including the steps of disposing at least one (non-conductive) substrate layer and providing over the substrate layer multiple parallel linear conductive loops. The method or process includes at least one of the steps of covering at least a substantial portion of the substrate layer by the loop, arranging at least substantial lengths of such conductive loops to have at least substantially similar electric conductivity, hole mobility, and electron mobility to conduct electric current therethrough bi-directionally, configuring the loops and the substrate layer have a combined thickness less than, e.g., about 10 mm, 5 mm, 3 mm, 2 mm, 1 mm, 100 microns, 10 microns, 1 micron, etc., electrically connecting at least two of the loops to define a parallel and/or conductive loop. The method or process may include the steps of providing multiple induction layers over the planar inductor and providing at least one of the loops in each of the induction layers while maintaining a total (or combined) thickness of the substrate layer and the induction layers less than, e.g., about 10 mm, 5 mm, 3 mm, 2 mm, 1 mm, 100 microns, 10 microns, 1 micron, etc.

Planar inductors may also be provided by various methods or processes including the steps of disposing at least one (non-conductive) substrate layer, providing over the substrate layer having first multiple parallel linear conductive loops, and providing over the substrate layer second multiple parallel linear conductive loops which are at least partially normal to the first multiple conductive loops. Such a method or process includes at least one of the steps of covering at least a substantial portion of the substrate layer by some or all of the loops, arranging at least substantial lengths of the loops to have at least substantially similar electron mobility, hole mobility, and electric conductivity to conduct electric current therethrough bi-directionally, configuring the loops and the substrate layer to have a combined thickness less than, e.g., about 10 mm, 5 mm, 3 mm, 2 mm, 1 mm, 100 microns, 10 microns, 1 micron, etc., and connecting at least two of such loops to define at least one parallel and/or serial conductive loop. The method or process may also include the steps of providing multiple induction layers over the planar inductor and providing at least one of the loops in each of the induction layers while maintaining a total or combined thickness of the substrate layer and all of the induction layers not exceeding, e.g., about 10 mm, 5 mm, 3 mm, 2 mm, 1 mm, 100 microns, 10 microns, 1 micron, etc.

Any of the above methods or processes for providing such planar inductors may also include one or more of the steps of providing multiple levels each of which includes at least one of the above conductive loops, configuring each level to have at least one different loop, and providing at least one conductive loop on a top and a bottom of the substrate layer.

In another aspect of the present invention, magnetic assemblies are also provided for various electromagnetic induction generators. An exemplary magnetic assembly may include at least one first magnet and at least one second magnet disposed vertically apart from the first magnet, where such a magnetic assembly is arranged to have a total thickness less than, e.g., about 5 cm, 4 cm, 3 cm, 2 cm, 1 cm, 5 mm or 3 mm. Another exemplary magnetic assembly may include at least one first magnet and at least one second magnet disposed vertically apart from the first magnet, where at least one of the first magnet and the second magnet is arranged to have a thickness less than, e.g., about 3 cm, 2 cm, 1 cm or 5 mm. In another embodiment, a magnetic assembly may include at least one first magnet and at least one second magnet disposed vertically apart from the first magnet, where such a first magnet forms a first planar surface, where the second magnets defines a second planar surface, and where the first and second planar surfaces are arranged to oppose each other and separated by a distance less than, e.g., about 4 cm, 3 cm, 2 cm, 1 cm, 5 mm or 3 mm. Another exemplary magnetic assembly may include at least one first magnet and at least one second magnet disposed vertically apart from the first magnet, where each of the first and second magnets has a thickness less than, e.g., about 3 cm, 2 cm, 1 cm, 5 mm or 3 mm, where the first and second magnets respectively define a first planar surface and a second planar surface thereon, and where the first and second planar surfaces are arranged to oppose each other and to be separated by a distance less than, e.g., 4 cm, 3 cm, 2 cm, 1 cm or 5 mm.

Any of the foregoing magnetic assemblies may include the first and second magnets arranged respectively as an upper magnet and a lower magnet disposed at least substantially parallel to each other. The first and second magnets may have any shape, e.g., any polygonal and/or curved shapes. The magnetic assembly may include multiple first magnets and/or multiple second magnets. In addition, at least one of the magnets may define an aperture therein, and the magnetic assembly may include at least one center magnet disposed in such an aperture. The first and/or second magnets may include at least one shunt disposed around the magnet and having substantially higher magnetic permeability than air to reroute magnetic fluxes emitted by the magnet therethrough. In addition, at least one of the first and second magnets may be arranged to move with respect to the other thereof.

Another magnetic assembly may also include at least one first magnet and at least one second magnet disposed laterally apart from the first magnet. In one embodiment, the magnetic assembly may be arranged to have a total thickness less than, e.g., about 5 cm, 4 cm, 3 cm, 2 cm or 1 cm. In another embodiment, the magnetic assembly may have the same total thickness, and the first and/or second magnet may be arranged to have a thickness less than, e.g., about 3 cm, 2 cm, 1 cm or 5 mm. Any of the foregoing embodiments may be arranged so that the first and second magnets are disposed as a left magnet and a right magnet, that the first and/or second magnet may be arranged to define therein a rectangular, hexagonal, otherwise polygonal, circular, arcuate, elliptic or otherwise curved aperture, and/or that at least one center magnet may be disposed in the aperture. The magnetic assembly may also include multiple first and/or second magnets. The magnetic assembly may further include at least one shunt disposed around the first and/or second magnet and having substantially higher magnetic permeability than air to reroute magnetic fluxes emitted by the magnet therethrough. In addition, one or both of the first and second magnets may be arranged to move with respect to the other thereof.

Another magnetic assembly may include at least one first magnet arranged to include at least one curved section therealong, to form at least one cavity therein, and to have a thickness or a height less than, e.g., about 5 cm, 4 cm, 3 cm, 2 cm, 1 cm or 5 mm. Another magnetic assembly may instead include at least one first magnet arranged to include at least one curved section therealong, to form at least one cavity therein, and to have a thickness less than, e.g., about 5 cm, 4 cm, 3 cm, 2 cm, 1 cm or 5 mm. Another magnetic assembly may also include at least one first magnet and at least one second magnet disposed laterally apart from the first magnet. In one embodiment, the magnetic assembly may have a total thickness less than, e.g., about 5 cm, 4 cm, 3 cm, 2 cm or 1 cm. In another embodiment, such a first magnet may have a thickness less than, e.g., about 3 cm, 2 cm, 1 cm or 5 mm, while the magnetic assembly may have a total thickness less than, e.g., about 5 cm, 4 cm, 3 cm, 2 cm or 1 cm.

Any of these magnets may be used in combination with the upper magnet, the lower magnet, and/or the center magnet described in the preceding paragraphs. When desirable, such a magnetic assembly may also include multiple first and/or second magnets. The magnetic assembly may further include at least one shunt which is disposed around the first and/or second magnet and which has substantially higher magnetic permeability than air to reroute magnetic fluxes emitted by the magnet therethrough. In addition, one or both of the first and second magnets may be arranged to move with respect to the other thereof.

A magnetic assembly may also include at least one contiguous magnet which defines a planar surface and which is arranged to have on the planar surface at least two magnetic poles and to have a thickness less than, e.g., about 2 cm, 1 cm, 0.5 cm or 0.3 cm. Another magnetic assembly may also include at least one magnet defining a planar surface and arranged to define multiple magnetic regions having opposite magnetic polarities in an at least substantially alternating mode on the planar surface. Another magnetic assembly may further include at least one magnet and at least one shunt, where the magnet may have a planar surface and be arranged to define on the planar surface multiple magnetic regions and where the magnet may have a thickness less than, e.g., about 2 cm, 1 cm, 5 mm or 3 mm and where the shunt may be arranged to mechanically couple together at least two of such magnetic regions and to have magnetic permeability which is at least, e.g., about 100, 1,000, 10,000 or 100,000 times higher than that of air. Another magnetic assembly may include at least one magnet and at least one support. The magnet may form a planar surface and defining multiple magnetic regions on such a planar surface, where the magnet may preferably have a thickness less than, e.g., about 2 cm, 1 cm, 0.5 cm or 0.3 cm). The support may be arranged to mechanically couple at least two of the magnetic regions and to have magnetic permeability similar to that of air.

The above multiple magnetic regions of the magnet may be disposed in various arrangements, e.g., side by side in an at least partly parallel mode, at least partly radially about a center or inner zone of the magnet, at least partly spirally about such a center or inner zone, at least partly concentrically about the center or inner zone of the magnet, and the like. At least one of the magnets may also be arranged to move with respect to the other magnet and, when the magnetic assembly may include a single magnet, the magnet may be arranged to move with respect to a body of the magnetic assembly Yet another magnetic assembly may include at least one first magnet and at least one second magnet disposed apart from the first magnet such that such magnets may generate therebetween a magnetic field. In one embodiment, at least one of the magnets may be arranged to move with respect to the other thereof in order to vary spatial distribution pattern of magnetic fluxes in the magnetic field. In another embodiment, at least one of such magnets may be arranged to move in different directions to vary spatial distribution pattern of magnetic fluxes in the magnetic field. In another embodiment, at least one of the magnets may also be arranged to move in different speeds to vary spatial distribution pattern of magnetic fluxes in the magnetic field.

The foregoing magnets may be arranged to move in various directions and/or various speeds with respect to each other and/or to a body of the magnetic assembly. For example, the magnets may be arranged to move along the same (or different) circular path in opposite directions at the same (or different) speed. In the alternative, the magnets may move along the same (or different) circular path in the same direction at the same (or different) speed. Such magnets may be arranged to be linearly translated along the same (or different) linear path in opposite directions at the same (or different) speed or, alternatively, along the same (or different) linear path in the same direction at the same (or different) speed. The magnets may also be arranged to move along noncircular and nonlinear paths as long as they may induce electric current through various conductive loops described hereinabove and heretofore by varying spatial distribution of the magnetic fluxes between or around the magnets. The magnetic array may further include at least one shunt disposed around the first and/or second magnet and having substantially higher magnetic permeability than air so as to reroute magnetic fluxes emitted by the magnet therethrough.

In another aspect of the present invention, an electromagnetic induction generator is provided to generate electric current. Such a generator may include at least one magnetic member, at least one induction member, and at least one actuator. The magnetic member includes at least one (permanent) magnet which emits magnetic fluxes, while the induction member includes at least one planar (or flat) conductive loop disposed apart from the magnetic member and arranged to receive at least a portion of the magnetic fluxes. The actuator is arranged to move the magnetic member and/or the induction member with respect to the other thereof to generate electric current through the conductive loop by electromagnetic induction. In another embodiment, the above induction member may additionally be arranged to have a thickness less than, e.g., about 3 mm, 2 mm, 1 mm, 100 microns, 10 microns or 1 micron. In yet another embodiment, the above induction member is arranged to be disposed adjacent to the planar (or flat) surface of the magnet within a distance of, e.g., about 5 mm, 3 mm, 2 mm, 1 mm, 100 microns, 10 microns or 1 micron.

The foregoing generator may also be arranged to have a total thickness less than, e.g., about 5 cm, 4 cm, 3 cm, 2 cm or 1 cm. The magnetic member of the generator may also be arranged to form at least one planar surface. The conductive loop may also form a region at least partially surrounded thereby and an area of such a region normally projected onto the magnetic fluxes may be arranged to change over time. Alternatively, the conductive loop may form a region at least partially surrounded thereby and an amount of the magnetic fluxes intersecting such a region may be arranged to change over time. The magnetic member and/or the induction member may be arranged to move with respect to the other as described above. Multiple magnetic members or multiple magnets of a single magnetic member may be arranged to sandwich the induction member. Alternatively, multiple induction member or multiple conductive loops of a single induction member may be arranged to sandwich the magnetic member. The foregoing generator may include at least one coupling member arranged to mechanically couple the electromagnetic induction generator to an electrical device and to deliver electric current generated by the generator to such a device. Examples of such devices may include, but not limited to, various communication devices (e.g., mobile phones, PDAs, etc.), various data processing devices (e.g., laptop computers, organizers, etc.), audiovisual equipment (e.g., cameras, camcorders, compact disk players, DVD players, tape players, radios, portable TVs, etc.), positioning equipment (e.g., GPS, etc.), flash lights, and other electric or electronic devices whichever may be operable by the electric current and/or electric voltage generated by the foregoing generator. The foregoing generator may be arranged to deliver the electric current directly to the foregoing devices. Alternatively, the generator may include at least one energy storage member (e.g., rechargeable batteries, capacitors, etc.) and deliver the electric current to the energy storage member so that electric energy generated by such a generator is stored in the energy storage member which delivers electric current to the above devices thereafter. The above generator may be provided as a portable generator which may be electrically and/or mechanically coupled to the device. Alternatively, the above generator may be implemented to the device in such a way that entire portions of the magnetic member and the induction member and at least a portion of the actuator may be disposed inside an outer housing of the generator.

As used herein, a term “curvilinear” represents “curved” as well as “linear” collectively. Thus, a “curvilinear” conductive loop means a loop made of one or more conductive substances arranged to have a linear shape or a curved configuration which may be defined in a two-dimensional plane or in a three-dimensional space.

A term “planar” means pertaining to a two-dimensional plane or a three-dimensional plane. As any object has a finite thickness, no object can be defined on and only in a two-dimensional plane per se. Therefore, a “planar” object as used throughout this specification is practically defined in a three-dimensional space, where a patent difference between a “planar” object and a non-planar object lies in a thickness of such an object as whole. In this context, a “planar” object as used herein is defined as an object defined in a three-dimensional space having a finite length, a finite width, and a thickness or height less than about several millimeters. Typically, a “planar” layer or a “planar” conductive loop of this invention has thickness ranging from a few millimeters down to a few microns. Thinner layers and/or thinner loops may also be constructed, subject to limitations that such layers may maintain their mechanical integrity and such loops do not exhibit excessive resistance to electric current. In general, a term “flat” is interchangeably used with the term “planar” throughout this specification. Accordingly, within the context of this definition, a “planar” or “flat” object may have a flat upper surface and a flat lower surface parallel with the upper surface or, alternatively, may have a curved upper surface and a curved lower surface disposed at least partly parallel with the curved upper surface as far as two surfaces satisfy the foregoing thickness limitation. When desirable, one of the surfaces may be flat, while the other of such surfaces may be curved.

As used herein, terms “induction member” and “inductor” are used interchangeably to denote a part of an electromagnetic induction generator of the present invention. Therefore, both the “inductor” and the “induction member” means such a part of such a generator which includes or defines at least one conductive loop thereon or therein. Similarly, terms “magnetic member” and “magnetic assembly” are used interchangeably to denote a part of an electromagnetic induction generator of the present invention which creates magnetic fields therearound.

In addition, a term “magnet” generally refers to an article capable of emanating magnetic fluxes therefrom and forming a magnetic field therearound. As used herein, a “magnetic element” refers to a basic element which includes a single N pole and a single S pole, emanates the magnetic fluxes from the N pole toward the S pole, and forms the magnetic field therearound. To the contrary, a “magnet” as used herein refers to an array of such “magnetic element” and, accordingly, may include multiple N poles and/or multiple S poles.

A “conductive loop” is, by definition, a loop made of conductive substances and provided on or in the induction member by various processes. As used herein, the “conductive loop” includes both of a “closed” loop and an “open” loop. Therefore, the “conductive loop” may be provided to have various closed and open configurations. In order to harness electric current induced through the conductive loop, however, even a closed conductive loop has to be open at preselected locations so that electric current can be generated and delivered to an internal energy storage member and/or an external load. Therefore, all “closed” conductive loops exemplified in this specification are to be interpreted that they may be opened in any location therealong. By the same token, all “open” conductive loops exemplified herein are also to be interpreter that they may be closed to form a closed circuit to deliver the electric current therefrom. As used herein and unless otherwise specified, additional terms “basic conductive element,” “conductive element,” “basic element,” and “element” are interchangeably used to represent the foregoing conductive loop.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Terms “conductive” and “insulative” denotes intensive physical properties of materials defined based on conventional technical definitions. Therefore, a “conductor” is a “conductive” material, while an “insulator” is an “insulative” material. As used herein, however, such a “conductor” also includes a “semiconductive” material, whereas a “non-conductive” material only refers to an “insulative” material. In addition, when referring to planar technologies, a “conductive” material or a “conductor” collectively includes a precursor which is not yet conductive per se but can later be converted or cured into such a “conductive” material by a proper curing process known in the art. Therefore, a step of a method or a process referring to depositing or providing a “conductive layer” as used herein means depositing or providing a layer composed of an already “conductive” material or a precursor thereof.

Other features and advantages of the present invention will be apparent from the following detailed description, and from the claims.

### BRIEF DESCRIPTION OF THE DRAWING

FIG. 1A is a perspective view of an exemplary electromagnetic induction generator including an induction member and a magnetic member with two magnets according to of the present invention;

FIG. 1B is a side view of the exemplary electromagnetic induction generator shown in FIG. 1A according to the present invention;

FIG. 1C is a top view of the induction member of the exemplary generator of FIG. 1A having a substantially planar configuration according to the present invention;

FIG. 1D is a top view of a lower magnet of the magnetic member of the exemplary generator of FIG. 1A having substantial planar configurations according to the present invention;

FIG. 1E is a bottom view of an upper magnet of the same magnetic member of the exemplary generator of FIG. 1A having a substantial planar configuration according to the present invention;

FIG. 2A is a top view of the induction member in operation over the lower magnet of FIG. 1A, where magnetic fluxes conduct downwardly and upwardly on left and right halves of the induction member (as seen from above), respectively, according to the present invention;

FIG. 2B is a top view of the induction member in operation over the lower magnet of FIG. 1A, where magnetic fluxes conduct downwardly and upwardly on top and bottom halves of the induction member (as seen from above), respectively, according to the present invention;

FIG. 2C is a top view of the induction member in operation over the lower magnet of FIG. 1A, where magnetic fluxes conduct upwardly and downwardly on left and right halves of the induction member (as seen from above), respectively, according to the present invention;

FIG. 2D is a top view of the induction member in operation over the lower magnet of FIG. 1A, where magnetic fluxes conduct upwardly and downwardly on top and bottom halves of the induction member (as seen from above), respectively, according to the present invention;

FIGS. 3A to 3X are top views of exemplary induction members with various basic conductive elements according to the present invention;

FIG. 4A is a top view of the induction member of FIG. 3M having a pair of curvilinear triangular conductive units in operation over the lower magnet of FIG. 1A according to the present invention;

FIG. 4B is a top view of another induction member having a pair of wider curvilinear triangular conductive units in operation over the lower magnet of FIG. 1A according to the present invention;

FIG. 4C is a top view of the induction member of FIG. 1C having a flipped curvilinear trapezoidal conductive unit in operation over the lower magnet of FIG. 1A according to the present invention;

FIG. 4D is a top view of another induction member with a wider flipped curvilinear trapezoidal conductive unit in operation over the lower magnet of FIG. 1A according to the present invention;

FIG. 5A is a perspective view of the induction member of FIG. 1A including identical conductive loops in identical locations of its top and bottom surfaces according to the present invention;

FIG. 5B is a temporal profile of EMF attainable by the exemplary generator having the induction member of FIG. 5A according to the present invention;

FIG. 5C is a temporal profile of EMF attainable by the exemplary generator having the induction member of FIG. 5A and a commutator according to the present invention;

FIG. 5D is a perspective view of an induction member including conductive loops disposed on its top and bottom surfaces and angularly apart by 90 degrees according to the present invention;

FIG. 5E is a temporal profile of EMF attainable by the exemplary generator having the induction member of FIG. 5D according to the present invention;

FIG. 5F is a perspective view of an induction member including conductive loops disposed on its top and bottom surfaces and angularly apart by 45 degrees according to the present invention;

FIG. 5G is a temporal profile of EMF attainable by the exemplary generator having the induction member of FIG. 5F according to the present invention;

FIG. 6A is a perspective view of an interconnecting mesh of conductive lines shown in FIG. 3E according to the present invention;

FIG. 6B is a perspective view of another interconnecting mesh of conductive lines of FIG. 3E according to the present invention;

FIG. 6C is a perspective view of a non-contacting mesh of conductive lines shown in FIG. 3E according to the present invention;

FIG. 6D is a perspective view of another non-contacting mesh of conductive lines of FIG. 3E according to the present invention;

FIG. 6E is a perspective view of a layer structure of a non-contacting mesh of conductive lines of FIG. 3E according to the present invention;

FIGS. 7A to 7L are top views of exemplary series and parallel electrical connections of various basic conductive elements and/or units of the induction members according to the present invention;

FIGS. 8A to 8D are top views of exemplary multilayer connections of parallel conductive lines of the induction member of FIGS. 3A and 7A according to the present invention;

FIGS. 8E to 8H are top views of exemplary multilayer connections of a mesh with overlapping horizontal and vertical conductive lines of the induction member of FIGS. 3D and 7E according to the present invention;

FIGS. 81 to 8N are top views of exemplary multilayer connections of diagonal conductive lines of the induction member of FIG. 3J according to the present invention;

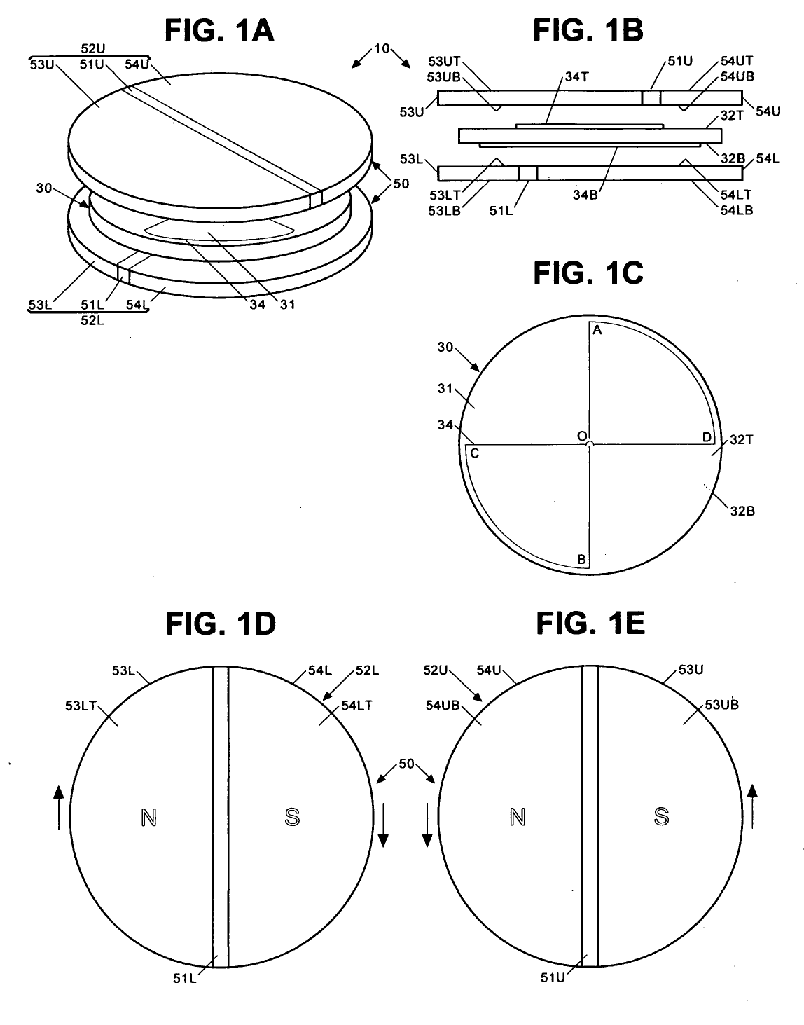

FIG. 9A is a top view of an induction member in operation between a mobile magnetic member of FIG. 1A, where magnetic fluxes conduct downwardly and upwardly on left and right halves of the induction member (as seen from above), respectively, according to the present invention;

FIG. 9B is another top view of the induction member in operation between the mobile magnetic member of FIG. 9A, where magnetic fluxes flow downwardly and upwardly on left and right halves of the induction member (as seen from above), respectively, according to the present invention;

FIG. 9C is a temporal profile of EMF attainable by the exemplary generator having the induction member of FIGS. 9A and 9B according to the present invention;

FIG. 9D is a top view of a rotating induction member having a pair of commutators in operation, where magnetic fluxes conduct downwardly and upwardly on left and right halves of the induction member (as seen from above), respectively, according to the present invention;

FIG. 9E is another top view of the rotating induction member and the commutators of FIG. 9D, where magnetic fluxes conduct downwardly and upwardly on left and right halves of the induction member (as seen from above), respectively, according to the present invention;

FIG. 9F is a temporal profile of EMF attainable by the exemplary generator having the induction member and commutators of FIGS. 9D and 9E according to the present invention;

FIGS. 10A to 10H are perspective views of exemplary magnets consisting of a single magnetic segment according to the present invention;

FIGS. 11A to 11H are perspective views of exemplary magnets each including two magnetic segment according to the present invention;

FIGS. 12A to 12H are perspective views of exemplary magnets each including three magnetic segment according to the present invention;

FIGS. 13A to 13H are perspective views of exemplary magnets each including four magnetic segment according to the present invention;

FIGS. 14A to 14G show perspective views of exemplary electromagnetic induction generators including a magnetic member with a single planar magnet according to the present invention; and

FIGS. 15A to 15P show perspective views of exemplary electromagnetic induction generators including a magnetic member with multiple or non-planar magnets according to the present invention.

### DETAILED DESCRIPTION OF THE PREFERRED EMBODIMENTS

The present invention generally relates to electromagnetic induction generators for generating AC or DC electric currents (or voltages) through electromagnetic induction in response to user inputs manually applied thereto. More particularly, the present invention relates to planar induction members and/or planar magnetic members for compact electromagnetic induction generators portably applied to various electronic and/or electric devices. The present invention further relates to various methods of generating AC or DC currents (or voltages) using the foregoing electromagnetic induction generators and various methods of providing the electromagnetic induction generators, planar induction members thereof, and planar and/or non-planar magnetic members thereof. The planar induction members may be provided in various configurations of this invention through conventional semiconductor fabrication technologies, while the magnetic members may be provided in various configurations of this invention to induce electric currents (or voltages) through such induction members. Therefore, electromagnetic induction generators of this invention may be provided as relatively thin, compact, lightweight portable generators which have enough efficiency to provide sufficient electrical power for various electronic and/or electrical devices.

An electromagnetic induction generator of the present invention typically includes, e.g., at least one magnetic member (i.e., magnetic assembly), at least one induction member (i.e., inductor), and at least one actuator. FIG. 1A denotes a schematic diagram of an exemplary electromagnetic induction generator of the present invention, while FIG. 1B is a side view of the exemplary generator of FIG. 1A according to the present invention. The exemplary generator 10 includes an induction member 30 and a magnetic member 50, where the induction member 30 is sandwiched between an upper magnet 52U and a lower magnet 52L of the magnetic member 50. It is noted that, for simplicity of illustration, FIGS. 1A and 1B do not include the actuator which will, however, be described in greater detail below. The induction member 30 may be typically disposed apart from the upper and lower magnets 52U, 52D at a preset distance such that the induction member 30 (or magnetic member 50) may move with respect to the magnetic member 50 (or induction member 30) by an actuator. Details of the induction member 30 and the magnetic member 50 will now be illustrated using FIGS. 1C through 1E, where FIG. 1C is a top view of the induction member of the exemplary generator of FIG. 1A, where FIG. 1D is a top view of a lower magnet of the magnetic member of the exemplary generator of FIG. 1A having substantial planar configurations, and where FIG. 1E is a bottom view of an upper magnet of the same magnetic member of the exemplary generator of FIG. 1A having a substantial planar configuration according to the present invention.

The induction member 30 is generally provided to have a substantially planar structure so that its thickness (or height) is preferably less than several millimeters, e.g., less than about 5 mm, 4 mm, 3 mm, 2 mm, 1 mm, 500 microns, 100 microns, 50 microns, 10 microns, 1 micron or less. For mechanical integrity reasons, however, the thickness of the induction member 30 is typically maintained in a range of about a few millimeters. The induction member 30 has a substrate layer (i.e., body) 31 on which at least one conductive loop 34 is disposed by various processes as will be discussed in greater detail below. The exemplary substrate layer 31 is generally cylindrical and defines a top surface 32T and a bottom surface 32B, where the substrate layer 32 is typically responsible for most of the thickness of the induction member 30. At least one top conductive loop 34T is disposed on the top surface 32T of the substrate layer 31 while defining a flipped curvilinear trapezoidal loop starting from a point A near a first edge of the substrate layer 31, diagonally extending to another point B near a second edge of the substrate layer 31 and opposite to the first edge, arcuately winding along the opposite edge in a clockwise direction by about 90 degrees up to a point C near a third edge of the substrate layer 31, diagonally extending to a point D near a fourth edge opposite to the third edge, and arcuately winding along the fourth edge in a counterclockwise direction by about 90 degrees back to the starting point A. It is noted that a segment AB of the conductive loop 34 overlaps a segment CD thereof at a region o but does not electrically contact the segment CD so that the loop ABCDA forms the single curvilinear conductive loop 34 of the induction member 30. A similar or identical conductive loop 34B may also be provided on the bottom surface 32B of the substrate layer 31, where such a bottom loop 34B may be provided according to an image of the top conductive loop 34T as projected onto the bottom surface 32B, as a mirror image of the top conductive loop 34T, or as a linearly translated or angularly rotated projected or mirror image of the top conductive loop 34T.

The magnetic member 50 is typically comprised of the lower magnet 52L and the upper magnet 52U, where the lower magnet 52L has a first magnetic segment 53L and a second magnetic segment 54L which is separated from the first segment 53L by a divider 51L, and where the upper magnet 52U has a first magnetic segment 53U and a second magnetic segment 54U which is also separated from the first segment 53U by another divider 51U. In the exemplary embodiment of FIGS. 1A to 1E, each of the magnetic segments 53L, 54L, 53U, 54U occupies approximately the same semicircular area, while the dividers 51L, 51U extend diagonally and narrowly to form thin strips. In addition, the first magnetic segment 53L of the lower magnet 52L is oriented to have a north pole (will be abbreviated as the “N” herein after) on its top surface 53LT and a south pole (to be abbreviated as the “S” herein after) on its bottom surface 53LB, whereas the second magnetic segment 54L thereof is oriented to have the S on its top surface 54LT and the N on its bottom surface 54LB. Similarly, the first magnetic segment 53U of the upper magnet 52U is oriented to have the S on its bottom surface 53UB and to have the N on its top surface 53UT, whereas the second magnetic segment 54U thereof is oriented to have the N on its bottom surface 54UB and to have the S on its top surface 54UT.

In operation of the exemplary electromagnetic induction generator 10 of FIGS. 1A through 1E, the upper and lower magnets 52U, 52L of the magnet member 50 are disposed such that the bottom surfaces 53UB, 54UB of the upper magnet 52U face the top surfaces 53LT, 54LT of the lower magnet 52L, respectively, thereby creating a first magnet field between the first magnetic segments 53U, 53L of the upper and lower magnets 52U, 52L in which magnetic fluxes flow (or conduct) upwardly, and generating a second magnetic field between the second magnetic segments 54U, 54L of the magnets 52U, 52L where magnetic fluxes flow downwardly. Thereafter, the induction member 30 is disposed between the upper and lower magnets 52U, 52L of the magnetic member 50, while preferably aligning a center of the induction member 30 between those of the upper and lower magnets 52U, 52L of the magnetic member 50. It is preferred that the induction member 30 be disposed as close to the bottom surfaces 53UB, 54UB of the upper magnet 52U and the top surfaces 53LT, 54LT of the lower magnet 52L to minimize distances therebetween and, therefore, to maximize intensities of the magnetic fluxes received by the conductive loops 34T, 34B of the induction member 30. Such distances between the conductive loops 34T, 34B and the foregoing surfaces are generally arranged to be less than several millimeters, e.g., about 10 mm, 8 mm, 6 mm, 5 mm, 4 mm, 3 mm, 2 mm, 1 mm, 500 microns, 100 microns, 50 microns, 10 microns, 1 micron or less. Once both the induction and magnetic members 30, 50 are placed in position, both of the upper and lower magnets 52U, 52L are rotated in unison in a clockwise direction (as seen from above) with respect to the stationary magnetic member 30, thereby changing an amount and/or a direction of magnetic fluxes intersecting regions ADO and BCD surrounded by the conductive loops 34T, 34B over time and thereby inducing electric current through the loops 34T, 34B by electromagnetic induction.

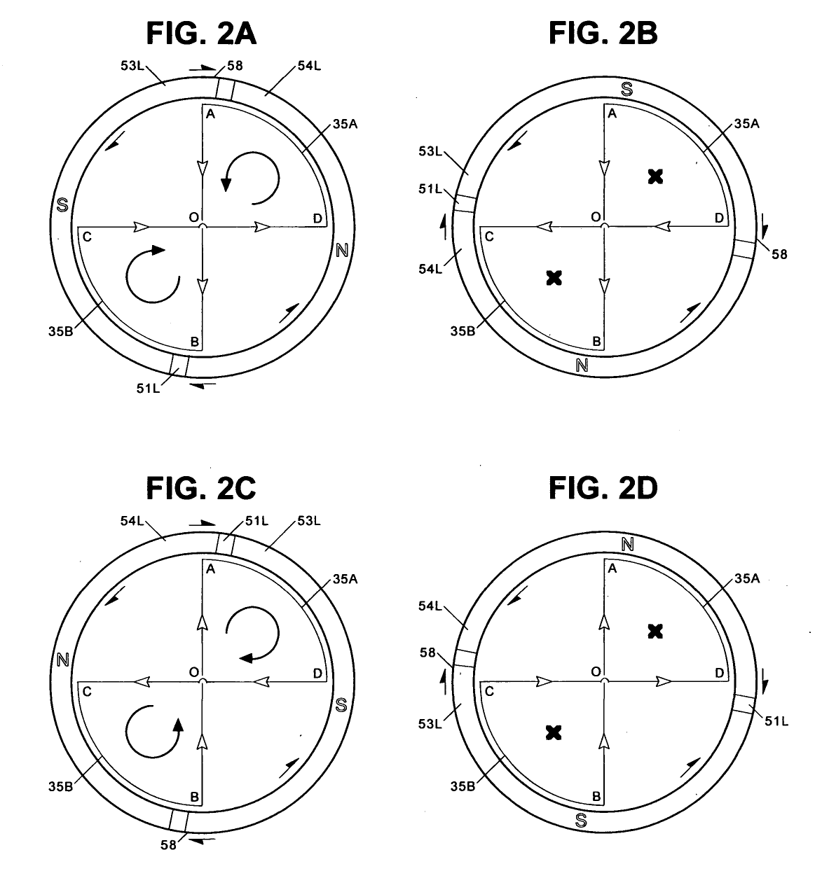

Detailed mechanisms of such electromagnetic induction are illustrated in FIGS. 2A through 2D, where FIG. 2A is a top view of the induction member in operation over the lower magnet of FIG. 1A where magnetic fluxes conduct downwardly and upwardly on left and right halves of the induction member (as seen from above), respectively, where FIG. 2B is a top view of the induction member in operation where magnetic fluxes conduct downwardly and upwardly on top and bottom halves of the induction member, respectively, where FIG. 2C is also a top view of the induction member in operation where magnetic fluxes conduct upwardly and downwardly on left and right halves of the induction member, respectively, and where FIG. 2D is another top view of the induction member in operation where magnetic fluxes conduct upwardly and downwardly on top and bottom halves of the induction member, respectively, according to the present invention. It is appreciated in FIGS. 2A through 2D that the upper magnet 52U of the magnetic member 50 is not shown for simplicity of illustration. In addition, a leading edge 58 is designated in the lower magnet 52L as an edge of the first magnetic segment 53L as shown in the figures. In FIG. 2A, the segments AO and CO of the conductive loop 34T are subject to the downwardly conducting magnetic fluxes, while segments BO and DO thereof are subject to the upwardly conducting magnetic fluxes. The Fleming's right-hand-law dictates the mobile magnets 52U, 52L rotating about the stationary induction member 30 in a clockwise direction (or the mobile induction member 30 rotating about the stationary magnets 52U, 52L in a counterclockwise direction) such that inward (or centripetal) electric currents are induced toward a center of the conductive loop 34T along the segments AO and CO. In contrary, the segments BO and DO of the conductive loop 34T in FIG. 2A are subject to the upwardly flowing magnetic fluxes and, therefore, outward (or centrifugal) electric currents are induced toward a periphery of the conductive loop 34T. Accordingly, the electric current flows through a first half-loop 35A through a path ODAO and through a second half-loop 35B through a path OBCO as the magnets 52U, 52L rotate in a clockwise direction or as the induction member 30 rotates in a counterclockwise direction. As shown in FIG. 2B, the upper and lower magnets 52U, 52L rotate about 90 degrees clockwise thereafter or the induction member 30 thereafter rotates about 90 degrees counterclockwise thereafter such that the leading edge 58 of the lower magnet 52L travels slightly past the point D. Inward electric currents are then induced through the segments AO and DO, whereas outward electric currents are induced through the segments BO and CO. These currents, however, cancel each other in each of the half-loops 35A, 35B and, therefore, no net electric current can be induced when the leading edge 58 travels from the point D to the point B. As shown in FIG. 2C where the magnets 52U, 52L and/or the induction member 30 may further rotate about 90 degrees and the leading edge 58 may travel slightly past the point B, inward electric currents are induced through the segments BO and DO, while outward electric currents are induced through the segments AO and CO. Accordingly, the electric current flows through the first half-loop 35A through a path OADO and through the second half-loop 35B through a path OCBO as the leading edge 58 travels from the point B to the point C. When the magnets 52U, 52L and/or the induction member 30 rotates about another 90 degrees as shown in FIG. 2D, inward electric currents are induced through the segments BO and CO and outward electric currents are induced through the segments AO and DO. Similar to the case of FIG. 2B, these currents again cancel each other in each of the half-loops 35A, 35B and, therefore, no net electric current is generated when the leading edge 58 travels from the point C to the point A.

In the foregoing embodiment, it is to be noted that only linear segments of the induction member 30 such as AO, BO, CO, and DO actively contribute to generation of the induced current, whereas the arcuate segments such as AD and BD do not generate any current at all regardless of the position of the leading edge 58 of the lower magnet 53L, because such curved segments extend along the same direction as the direction of movement of the magnetic member 50 or induction member 30. Therefore, the electric current induced through the induction member 30 and/or electric power attained therefrom would increase in proportion to a number of radially or diagonally extending segments provided on the induction member 30. Relationship between configurations of the induction member 30 and generation of electric current and power will be provided in greater detail below.

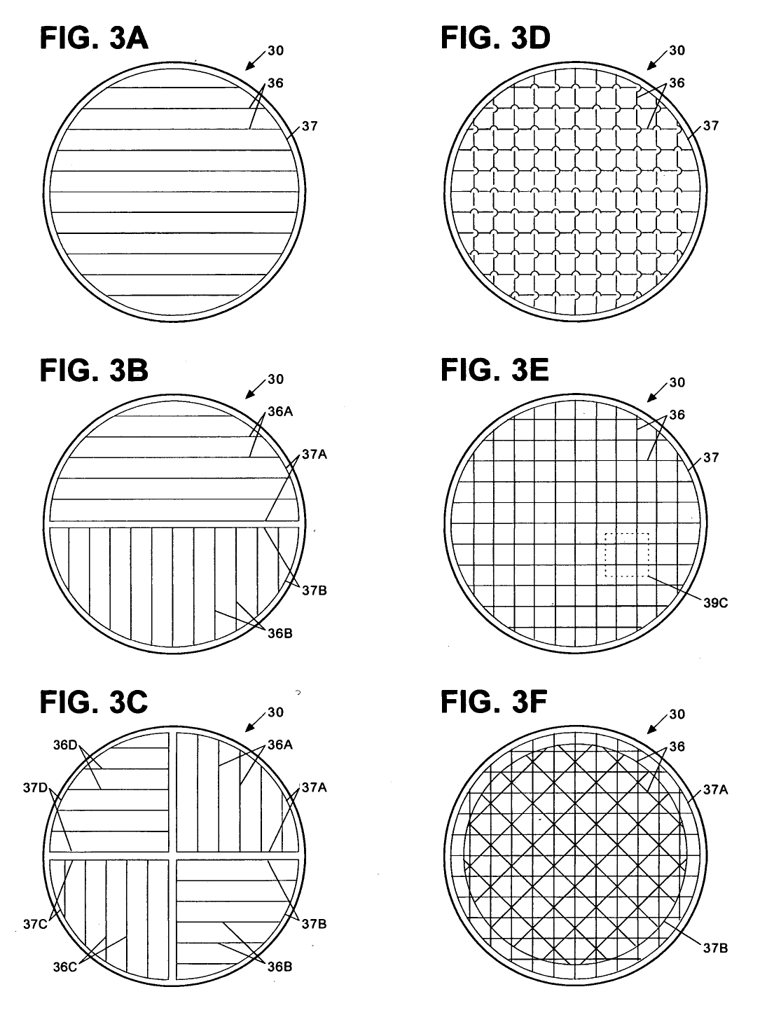

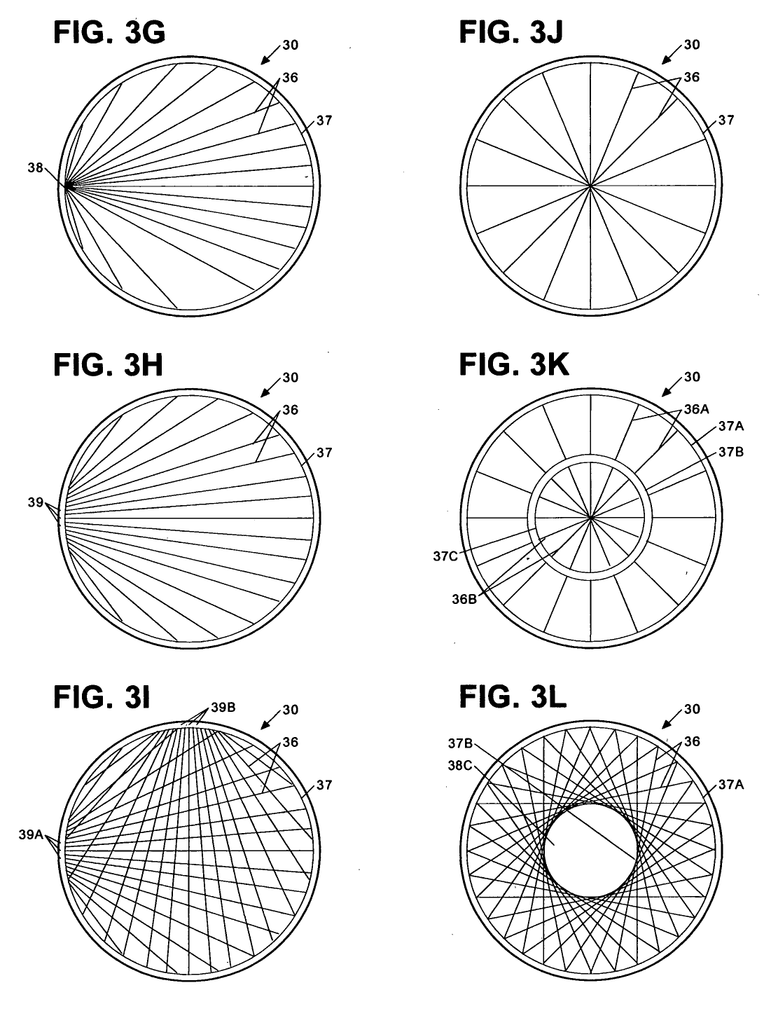

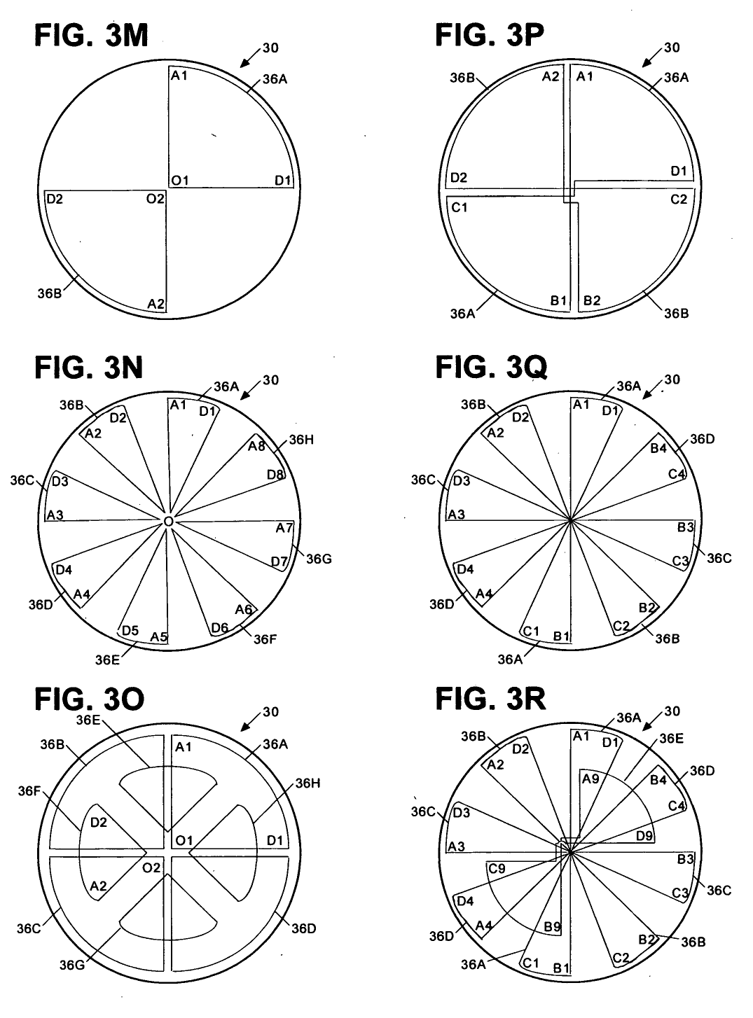

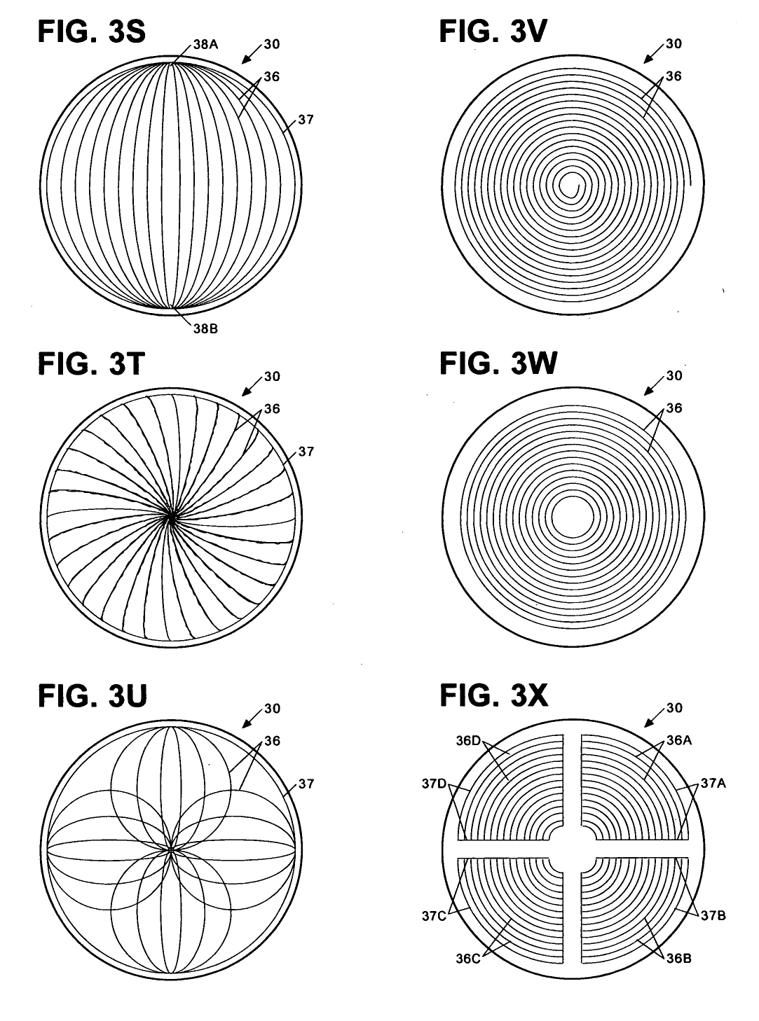

As described above, the induction member 30 of the electromagnetic induction generator 10 of the present invention may require conductive loops 34 disposed on its top and/or bottom surface and capable of inducing electric current therethrough in response to changes in magnitudes or directions of magnetic fluxes intersecting therethrough. Such a conductive loop 34 of the present invention may have various configurations which may be different from those shown in FIGS. 1A through 1E and 2A through 2D. Examples of such configurations may include, but not limited to, a loop comprised of one or more curvilinear conductive lines, a loop of a polygonal shape, a loop having a shape of a polygon including at least one curved segment (i.e., “curvilinear polygon”), a loop having an otherwise curved shape (e.g., a circle, an oval, etc.), and so on. Such a conductive loop 34 may consist of a single unit or multiple units of the foregoing lines and/or shapes, where such a unit or each of the units may form a closed circuit, an open circuit or a combination thereof. Following exemplary embodiments illustrate some of such configurations for the induction member 30 (and/or conductive loops 34 therefor) of the present invention, where those shown in FIGS. 3A to 3R generally relate to the induction members 30 (or conductive loops 34) comprised of a single unit or multiple units of mostly linear conductive lines or segments, and where those of FIGS. 3S to 3X relate to the induction members 30 (or conductive loops 34) comprised of a single unit or multiple units of mostly curved conductive lines or segments.

FIG. 3A is a top view of an exemplary induction member with multiple parallel linear conductive lines on its top surface according to the present invention. As shown in the figure, such an induction member 30 consists of a single unit 36 of such conductive lines, where all such lines are enclosed by a peripheral circular conductive path 37 and both ends of all such lines are electrically connected to the peripheral path 37. In an alternative embodiment, the conductive lines may be individually isolated on the surface of the induction member 30 so that the lines do not make any electrical contacts on the surface thereof but may make necessary connections to harness induced electric power elsewhere in the generator 10. Depending on configurations and/or movement directions of the magnetic member 50, the electric current may be induced in either direction along the conductive lines. FIG. 3B is a top view of another exemplary induction member including on its top surface two different units of linear conductive lines of FIG. 3A according to the present invention. For example, the induction member 30 of FIG. 3B includes a first unit 36A of horizontal conductive lines disposed parallel to each other and a second unit 36B of vertical conductive lines also disposed parallel to each other. Accordingly, electric current may be induced along different directions through the conductive lines of each unit 36A, 36B. Similar to those of FIG. 3A, the conductive lines of both units 36A, 36B are electrically connected to individual peripheral conductive paths 37A, 37B or, in the alternative, may be isolated from each other to prevent electrical connection therebetween. FIG. 3C is a top view of another exemplary induction member including on its top surface four different units of linear conductive lines of FIG. 3A according to the present invention. For example, the induction member 30 includes four individual units 36A-36D each occupying an arcuate quadrant of the induction member 30 and each having multiple conductive lines arranged either horizontally or vertically. Similar to the foregoing embodiments, such conductive lines of the unit 36A-36D are electrically connected to individual peripheral conductive paths 37A-37D or, alternatively, may be individually isolated to prevent electrical connection therebetween. It is noted that a total length of the conductive lines may be approximately same for all embodiments of FIGS. 3A through 3C. However, the lines of FIG. 3B and 3C extend both horizontally and vertically, while those of FIG. 3A extend only horizontally. Accordingly, the conductive lines of FIGS. 3B and 3C may induce electric current more constantly than those of FIG. 3A.

FIG. 3D is a top view of another exemplary induction member having on its top surface a mesh of linear conductive lines disposed at about 90 degrees according to the present invention, where the induction member 30 includes a single unit 36 of multiple horizontal and vertical conductive lines. Each of the horizontal conductive lines passes through or overlaps but is not electrically connected to each of the vertical conductive lines. FIG. 3E shows a top view of yet another exemplary induction member having on its top surface a mesh of linear conductive lines shown in FIG. 3D according to the present invention, where the induction member 30 includes another single unit 36 of identical conductive lines and where each horizontal line is electrically connected to the vertical lines. FIG. 3F represents a top view of another exemplary induction member including on its top surface a mesh of linear conductive lines disposed at about 45 degrees and about 90 degrees according to the present invention. That is, such an induction member 30 includes a single unit 36 of conductive lines of FIG. 3E overlapped with multiple slanted lined. Each of the vertical, horizontal, and slanted conductive lines may be arranged to electrically contact or to bypass the other lines. In the embodiments of FIGS. 3D and 3E, both terminals of the conductive lines may be electrically connected to a common peripheral conductive path 37 or, in the alternative, such conductive lines may be isolated from the rest of such lines to prevent electrical contact therebetween. In addition, different conductive lines may be connected to different peripheral conductive paths so that, as shown in FIG. 3F, each and every horizontal and vertical conductive line is electrically connected to an outer peripheral conductive path 37A, while all slanted conductive lines are electrically connected to an inner peripheral conductive path 37B. When desirable, the outer and inner peripheral paths may be electrically connected in a serial or parallel mode on the surface of such an induction member 30 or elsewhere in the generator 10 to obtain a desirable intensity of the electric current. It is noted that a total length of the conductive lines of FIGS. 3D and 3D may be approximately same, however, that the lines of FIG. 3D may be effectively extended by serially connecting the lines as will be explained below. To the contrary, a total length of the conductive lines of FIG. 3F is greater than those of FIGS. 3D and 3E and, in addition, the lines of FIG. 3F extend horizontally, vertically, and at 45 degrees to induce electric current more constantly than those of FIGS. 3D and 3E.

FIG. 3G is a top view of another exemplary induction member having on its top surface multiple conductive lines extending from a common point thereof according to the present invention. Such an induction member 30 includes a single unit 36 of linear conductive lines which are arranged to extend from (or converge at) a single point 38 on or near an edge of the induction member 30 and to terminate on or near an opposing side thereof. Such lines are preferably arranged to fan out from the point 38 to be radially distributed about the point 38. FIG. 3H shows a top view of another exemplary induction member having on its top surface multiple conductive lines extending from an edge thereof according to the present invention. The induction member 30 includes a similar single unit 36 of linear conductive lines which are arranged to extend from an edge 39 having a finite length and, therefore, is different from those of FIG. 3G in that multiple conductive lines of FIG. 3H do not precisely coincide at the point 38. FIG. 31 shows a top view of another exemplary induction member including on its top surface two overlapping units of linear conductive lines shown in FIG. 3H according to the present invention. The induction member 30 consists of a single unit 36 of linear conductive lines which correspond to those extending from an edge 39A overlapped with those extending from another edge 39B. Both terminals of the conductive lines of FIGS. 3G to 31 are electrically connected to a common peripheral conductive path 37 or, in the alternative, each conductive line may be isolated from the rest of the lines to prevent electrical contact therebetween. In addition, the lines of FIG. 3G may be electrically connected to each other at the point 38 or may be disposed one over the other without making any electrical connection. Similarly, the lines of FIG. 31 extending from different edges 39A, 398 may be electrically connected to each other or may be insulated therefrom.

FIG. 3J is a top view of another exemplary induction member having on its top surface multiple conductive lines radially arranged about a center of the member according to the present invention. In this embodiment, the induction member 30 has a single unit 36 of multiple conductive lines which span diagonally and coincide each other at a center of the member 30 where such lines may be electrically connected or simply overlaid one over the others without making such connections. FIG. 3K is a top view of another exemplary induction member including on its top surface two concentric units of such lines shown in FIG. 3J according to the present invention. The induction member 30 includes an outer unit 36A of lines extending inwardly from a periphery to a midpoint of the induction member 30 and an inner unit 36B of lines extending further inwardly from the midpoint to a center of the induction member 30, where each unit 36A, 36B includes multiple lines radially arranged about such a center. Similar to those of FIG. 3J, the conductive lines of the inner unit 36B of FIG. 3K may be electrically connected to each other or disposed simply one over the others without any electrical connections. FIG. 3L shows a top view of another exemplary induction member having on its top surface multiple conductive lines extending radially and arranged about an aperture defined in or near a center of the induction member according to the present invention. Such an induction member 30 generally defines an annular unit 36 of multiple lines each of which extends from one point on an edge of the induction member 30 toward a point on a substantially opposing edge thereof but not exactly through the center of the member 30. Thus, such an induction member 30 forms an internal or central aperture 38C in which no conductive lines are provided. The lines of the annular unit 36 of FIG. 3L may be electrically connected or may be insulated from one another. As described above, both terminals of the conductive lines of FIG. 3J or those of the inner unit 36B of FIG. 3K may be electrically connected to common peripheral conductive paths 37, 37B, respectively. Each terminal of the lines of the outer unit 36A of FIG. 3K and that 36 of FIG. 3L may be electrically connected to outer and inner conductive paths 37A, 37B as well.

FIG. 3M is a top view of another exemplary induction member including on its top surface a pair of curvilinear triangular conductive units according to the present invention. The induction member 30 includes, e.g., a first triangular unit 36A in its first quadrant and a second triangular unit 36B in its third quadrant. Each curvilinear triangular conductive unit 36A, 36B includes two linear segments and one arcuate curved segment, and two triangular units 36A are not electrically connected to each other on the surface of the induction member 30. FIG. 3N is a top view of another exemplary induction member including on its top surface multiple identical curvilinear triangular conductive units shown in FIG. 3M according to the present invention. More particularly, each unit 36A-36H of the induction member 30 is narrower than those of FIG. 3M, and such units 36A-36H are radially distributed about a center of the induction member 30 without generally making any electrical connection therebetween on the surface of the induction member 30. FIG. 30 is a top view of another exemplary induction member having on its top surface multiple curvilinear triangular conductive units according to the present invention. As shown in the figure, the induction member 30 includes four triangular units 36A-36D of FIG. 3M about its center and four smaller triangular units 36E-36H therein without making any electrical connections on the surface of the induction member 30. It is noted from FIGS. 3M to 30 that the induction member 30 may have thereon the greater length of the conductive loops as the member 30 defines thereon the more units of such conductive loops and, therefore, may induce much stronger electric current and/or generate greater electric power. It is noted that the induction member 30 of FIG. 3M has four radially extending segments (i.e., A₁O₁, D₁O₁, A₂O₂, and D₂O₂) on its top surface 32T, while that of FIG. 3N has a total of sixteen of such segments and that of FIG. 30 also includes additional shorter segments in the inner smaller units 36E-36H. Accordingly, the induction members 30 including more loops therein such as those of FIGS. 3N and 30 may induce stronger electric current or generate greater power.

FIG. 3P shows a top view of another exemplary induction member including on its top surface two opposing flipped curvilinear trapezoidal conductive units according to the present invention. The induction member 30 includes a pair of flipped trapezoidal conductive units 36A, 36B each of which is identical to that shown in FIGS. 2A to 2D. Two units 36A, 36B are arranged to overlap near a center of the induction member 30 but preferably not to electrically contact each other. FIG. 3Q is a top view of another exemplary induction member having on its top surface multiple trapezoidal conductive units according to the present invention. The induction member 30 includes four identical trapezoidal units 36A-36D arranged at a preset angles about the center and not to electrically contact each other. FIG. 3R shows a top view of yet another exemplary induction member including on its top surface multiple trapezoidal conductive units according to the present invention. The induction member 30 includes the trapezoidal units 36A-36D of FIG. 3Q in addition to a smaller trapezoidal unit 36E. It is appreciated that the induction member 30 of FIGS. 2A to 2D has only two diagonally extending segments (i.e., AB and CD) on its top surface 32T, while that of FIG. 3P has four such segments, (i.e., A₁B₁, C₁D₁, A₂B₂, and C₂D₂) and that of FIG. 3Q has eight such segments, thus capable of inducing higher electric currents or providing greater electric power.

FIG. 3S is a top view of another exemplary induction member having on its top surface multiple arcuate diagonal conductive lines according to the present invention. The induction member 30 has a single unit 36 consisting of multiple curved lines each extending from a point 38A on or near an edge of the member 30 and terminating at another point 38B on or near an opposing edge thereof. The lines may be electrically connected at the points 38A, 38B or may be overlaid one over the others without making any connections. FIG. 3T is a top view of another exemplary induction member including on its top surface arcuate radial conductive lines according to the present invention. The induction member 30 also has a single unit 36 consisting of multiple curved lines angularly arranged about the center of the member 30, where each of such lines extends from various points of edges of the member 30 and terminates at or near the center thereof. The lines may be electrically connected at the center or may be overlaid one over the others without any connections. FIG. 3U is a top view of another exemplary induction member including on its top surface four different groups of curved conductive lines of FIG. 3S according to the present invention. Such an induction member 30 includes a single unit 36 in which a group of shorter lines of FIG. 3S is repeatedly disposed in each quadrant of the induction member 30 in such a way that one end of such groups coincide in the center of the member 30. The lines may be electrically connected at the center of the member 30 or may be overlaid one over the others without any connections. Furthermore, both terminals of the curved lines of FIGS. 3S to 3U may be electrically connected to common peripheral conductive paths 37.

FIG. 3V is a top view of another exemplary induction member having on its top surface a spiral conductive line according to the present invention. The induction member 30 includes a single unit 36 consisting of a single spiral loop which winds outwardly in a clockwise direction from a center of the member 30 to a periphery thereof. FIG. 3W shows a top view of another exemplary induction member having on its top surface multiple concentric conductive lines according to the present invention. The induction member 30 includes another single unit 36 consisting of multiple circular lines concentrically disposed around the center of the member 30. FIG. 3X is a top view of another exemplary induction member including conductive lines of FIG. 3W segmented into four radial units on a top surface thereof according to the present invention. The induction member 30 includes four units 36A-36D

The foregoing induction members, their conductive loops, and/or their conductive units or lines may be modified and/or arranged to have further characteristics according to the present invention. It is appreciated that following modifications and/or further characterizations may be applied to induction members, their conductive loops, and/or their conductive units or lines described hereinabove as well as hereinafter unless otherwise specified.

As described above, an induction member of the present invention is basically comprised of at least one substrate layer and at least one conductive loop provided on the substrate layer by various methods. Such a conductive loop is in turn comprised of its basic elements such as, e.g., curvilinear conductive lines (including straight lines and curves), curvilinear conductive segments, and such lines or segments forming curvilinear polygons or other curved configurations such as, e.g., circles, ovals, spirals, and so on. Such an induction member or conductive loop may be comprised of a single unit of such elements or, alternatively, multiple units of such elements arranged on the substrate layer based on a preset pattern. In addition, the induction member may include thereon at least one induction layer which may simply designate a thin (and preferably planar) layer solely comprised of such conductive loops or represent a layer consisting of the conductive loops and insulative substances or fillers filling voids around, over, and/or under the conductive loops.

The substrate layer of the induction member is generally made of insulative materials such that electric current induced through the conductive loop is not leaked and lost through the substrate layer. Examples of such insulative materials generally includes, but not limited to, metals having low electrical conductivity, polymers, various crystalline or amorphous substances, and so on. Other materials may be used as far as they may have proper mechanical strength and readily allow deposition of various substances to form the foregoing conductive loops. When desirable, crystalline or amorphous silicon and/or other conventional semiconductive materials may also be used to construct the substrate layer. Other criteria may also have to be accounted for in selecting substances for the substrate layer. For example, the substrate layer may be made of or include substances with high magnetic permeabilities when the conductive loops are provided on the top and bottom surfaces of the substrate layer.

Such a substrate layer may be provided in various configuration, although a planar structure is mostly preferred. For a stationary induction member, the substrate layer may have almost any shapes and sizes as long as its height (or thickness) may satisfy the foregoing definition of a planar layer and may be less than several centimeters or millimeters, e.g., about 5 cm, 4 cm, 3 cm, 2 cm, 1 cm, 9 mm, 8 mm, 7 mm, 6 mm, 5 mm, 4 mm, 3 mm, 2 mm, 1 mm, 500 microns, 100 microns, 50 microns, 10 microns, 5 microns or less. For a mobile induction member, however, the substrate layer preferably has a shape of a cylinder with a minimum thickness to facilitate rotational movement thereof.

The induction member may also include multiple induction layers which are sandwiched by the insulative substrate layers in order to prevent formation of undesirable electrical contact between the conductive loops of the adjacent induction layers and to allow induced electric current to flow through designated connection paths provided between or across such induction layers. In this embodiment, all induction layers may be disposed between a top and a bottom of the substrate layer. Alternatively, the top and the bottom of the substrate layer may be occupied by the induction layers of the induction member. To facilitate transmission of magnetic fluxes therethrough, the induction member may include at least one additional layer made of or including materials of high magnetic permeability, where such a layer may be disposed over or below the induction layer. The induction member may further include at least one layer made of or including ferromagnetic materials to augment intensities of magnetic fluxes transmitting therethrough. Examples of such ferromagnetic materials may include, but not be limited to, Fe, Ni, Co, other ferromagnetic elements, alloys or mixtures thereof, and the like.

Conductive loops of this invention may be constructed in almost any imaginable configurations, although some rules may preferably be observed in designing such loops. First of all, the conductive loops are preferably arranged to occupy at least a substantial portion of or as much of an available area on a top surface and/or a bottom surface of the substrate layer, because it would otherwise be a waste of valuable real estate of the substrate layer. Secondly, the conductive loops are preferably arranged to have a total length which may be at least, e.g., about 10,000, 5,000, 1,000, 500, 100 or 50 times greater than a thickness (or height) and/or a characteristic dimension (e.g., a length or width) of the induction member, regardless of whether or not the foregoing conductive elements of such loops may be electrically connected to each other. Thirdly, the conductive loops are preferably patterned or electrically connected to avoid or suppress induction of adverse electric current as shown in FIGS. 2B and 2D. There is no general rule regarding how to minimize such adverse current, because detailed mechanisms of electromagnetic induction depend not only upon configurational characteristics of the induction member but also upon configurational and magnetic characteristics of the magnetic member. It is appreciated, however, that adverse electric current may also be harnessed by providing interunit, interloop, and/or interlayer electrical connections in proper locations of the conductive loops as will be described in detail below. When a segment of a conductive loop may have significantly low electrical conductivity, electron mobility, and/or hole mobility than the rest thereof, current flow may be impeded in one or both directions along the segment. Therefore, at least a substantial length of the conductive loop may preferably be made to have identical or at least substantially similar electrical conductivity, electron mobility, and/or hole mobility, thereby ensuring electrons and/or holes to flow through such a loop at the same or at least substantially similar speed or rate in both direction therealong. Such loops may be readily provided by forming the conductive loops from identical or similar conductive materials. The conductive loops are preferably provided on the top and/or bottom surface of the substrate layer and/or in one or multiple induction layers embedded therein. It is preferred, however, the thickness (or height) of the conductive loop be maintained less than several centimeters or less, e.g., about 5 cm, 3 cm, 1 cm, 9 mm, 7 mm, 5 mm, 3 mm, 2 mm, 1 mm, 500 microns, 100 microns, 50 microns, 10 microns, 5 microns or 1 micron. It is also preferred that an overall height (or thickness) of the induction member be maintained less than several centimeters, e.g., about 5 cm, 3 cm, 1 cm, 9 mm, 7 mm, 5 mm, 3 mm, 1 mm, 500 microns, 100 microns or 50 microns, to provide the planar induction members of the present invention including thereon or therein a single or multiple planar conductive loops.

Various exemplary embodiments of conductive loops and units thereof have been described in FIGS. 3A through 3X. However, other conductive loops and units having different configurations also fall within the scope of the present invention as long as they may meet the foregoing design rules and induce electric current when they move across the magnetic field or when the intensity or direction of magnetic fluxes change over time across a region at least partially enclosed by such loops or units.

In one embodiment, the conductive loop includes at least one spiral conductive line of which the length may range from a fraction of a radius of the substrate layer up to or beyond its diameter. In particular, the spiral conductive line may be arranged to wind around a preset point of revolution for multiple turns to increase its length over several ten or hundred times of the diameter of the substrate layer. The embodiment shown in FIG. 3V exemplifies such a spiral conductive loop. As a variation, a single long spiral element may be cut into multiple segments which may then be electrically connected in various modes as will be explained below. In the alternative, the conductive loop may be formed by intertwining or concentrically overlapping multiple spiral lines about the point of revolution, in which a length of each spiral line may not increase but a total length thereof may be easily doubled or tripled. Multiple units of the spiral conductive lines may also be distributed symmetrically or asymmetrically on the substrate layer according to a preset pattern, where such spiral units may have identical, similar or different shapes and/or sizes. For example, different units of spiral lines may be wound to fit into half-circles, quadrants or other segments of the substrate layer to form multiple separate spiral units, or to fit into curvilinear polygons defined on the substrate layer. Each of such spiral units may then be arranged angularly or radially around the center of the substrate layer apart from each other, or may be arranged to overlap one another with or without making electrical connections therebetween. The conductive loop may be made as a combination of the foregoing spiral units or arranged according to a combination of the above patterns. It is appreciated that such spiral conductive lines may not induce electric current efficiently when used in conjunction with the magnetic member shown in FIGS. 1D and 1E, because the direction along which the spiral lines extend generally coincides with the direction of their rotational movement. The electromagnetic induction generator with such spiral conductive loops, therefore, may have to employ magnetic members having pole configurations different from those of FIGS. 1D and 1E or may have to translate but not rotate the induction member or the magnetic member with respect to the other as will be described in detail below.

In another embodiment, the conductive loop may include at least one circular conductive line or at least one arcuate conductive line each having a length typically corresponding to only a fraction of a peripheral length of the substrate layer. A generalized embodiment of such circular or arcuate loop would be multiple circles or arcs of such conductive lines disposed concentrically or radially around a center of the substrate layer, as have been exemplified in FIG. 3W. Another generalized embodiment of such a loop would be a cluster of multiple circles or arcs which are disposed angularly or radially around the center of the substrate layer at preset angular intervals. Such conductive units of circular or arcuate lines may be arranged symmetrically or asymmetrically on the substrate layer according to a preset pattern, where such units may have identical, similar or different shapes and/or sizes. For example, different units with such circles or arcs may be provided to fit into half-circles, quadrants or other segments of the substrate layer and to form multiple separate units as exemplified in FIG. 3X. In the alternative, each unit may fit into curvilinear polygons defined and arranged on the substrate layer. Multiple circular or arcuate units may then be arranged angularly or radially around the center of such a substrate layer apart from each other or may alternatively be arranged to overlap one another with or without electrically connecting each other. The conductive loops may be made as a combination of the foregoing circular or arcuate units, or arranged according to a combination of the above patterns. Similar to the foregoing spiral lines, the circular or arcuate conductive lines may neither induce electric current efficiently when used in conjunction with the magnetic member of FIGS. 1 D and I E, because the direction along which the circular or arcuate lines extend also coincides with the direction of their rotational movement. Thus, the electromagnetic induction generator may preferably employ magnetic members having specific pole configurations and/or may translate but not rotate the induction and/or magnetic members.

In another embodiment, the conductive loop includes at least one conductive line with a shape of a curvilinear triangle having a length of about a fraction of a peripheral length of the substrate layer. Such triangular conductive loops have been exemplified in FIGS. 3M to 3O, although most generalized embodiments of the triangular conductive loops would be a set of multiple triangles of conductive lines disposed concentrically around a center of the substrate layer, multiple triangles disposed angularly or radially about such a center at preset angular intervals, and the like. Such triangular conductive units may be arranged symmetrically or asymmetrically on the substrate layer according to a preset pattern, where such units may have identical, similar or different shapes and/or sizes. Thus, different units of the triangular lines may be arranged to fit into half-circles, quadrants or other internal segments of the substrate layer or, in the alternative, each unit may fit into curvilinear polygons defined and arranged on the substrate layer. Such triangular conductive units may be arranged angularly (radially) around the center of the substrate layer apart from each other or, in the alternative, arranged to overlap one another with or without electrically connecting each other. Such conductive loops may also be made as a combination of the foregoing units or according to a combination of the foregoing patterns.

In yet another embodiment, the conductive loop includes at least one conductive line having a shape of a curvilinear polygon, e.g., a curvilinear quadrangle (e.g., a curvilinear trapezoid, rectangle, diamond, square, and so on), a curvilinear pentagon or hexagon, a circle, an oval, otherwise curved configurations, etc. Generalized embodiments of such polygonal conductive loops would be a set of multiple polygons of conductive lines disposed concentrically, angularly or radially around a center of the substrate layer, a cluster of multiple polygons of such lines disposed angularly or radially around the center at preset angular intervals. Multiple polygonal units may also be arranged symmetrically or asymmetrically on the substrate layer according to preset patterns, where such polygonal units may have identical, similar or different shapes and/or sizes. For example, different units of the polygonal units may be arranged to fit into half-circles, quadrants or other segments of the substrate layer, or to fit into polygonal regions defined and arranged on the substrate layer. The polygonal units may also be arranged angularly or radially about the center of the substrate layer apart from each other or, in the alternative, arranged to overlap one another with or without electrically connecting one another. Such conductive loops may be made as a combination of the foregoing polygonal units or according to a combination of the foregoing patterns.

In yet another embodiment, the conductive loop includes at least one conductive line having a shape of a flipped curvilinear polygon, as exemplified by the flipped curvilinear trapezoidal conductive loop of FIGS. 1C and 2A through 2D. Generalized embodiments of such conductive loops would be a set of multiple flipped polygons of such lines disposed concentrically, angularly or radially around the center of the substrate layer, a cluster of multiple flipped polygons of such lines disposed angularly or radially about such a center at preset angular intervals. Such flipped polygonal units may be arranged symmetrically or asymmetrically on the substrate layer according to preset patterns, where such units may have identical, similar or different shapes and/or sizes, e.g., to fit into half-circles, quadrants or other segments of the substrate layer and/or to fit into polygonal regions defined and arranged on the substrate layer. The flipped polygonal units may be arranged angularly or radially about the center of the substrate layer apart from each other or, in the alternative, arranged to overlap one another with or without electrically connecting one another. The flipped conductive loops may also be made as a combination of the foregoing polygonal units or according to a combination of the foregoing patterns.

As demonstrated in FIGS. 2B and 2D, an inherent drawback of such polygonal embodiments is generation of adverse electric current along one or more conductive lines of such polygons. Several provisions may be made to prevent or to suppress induction of such adverse current.

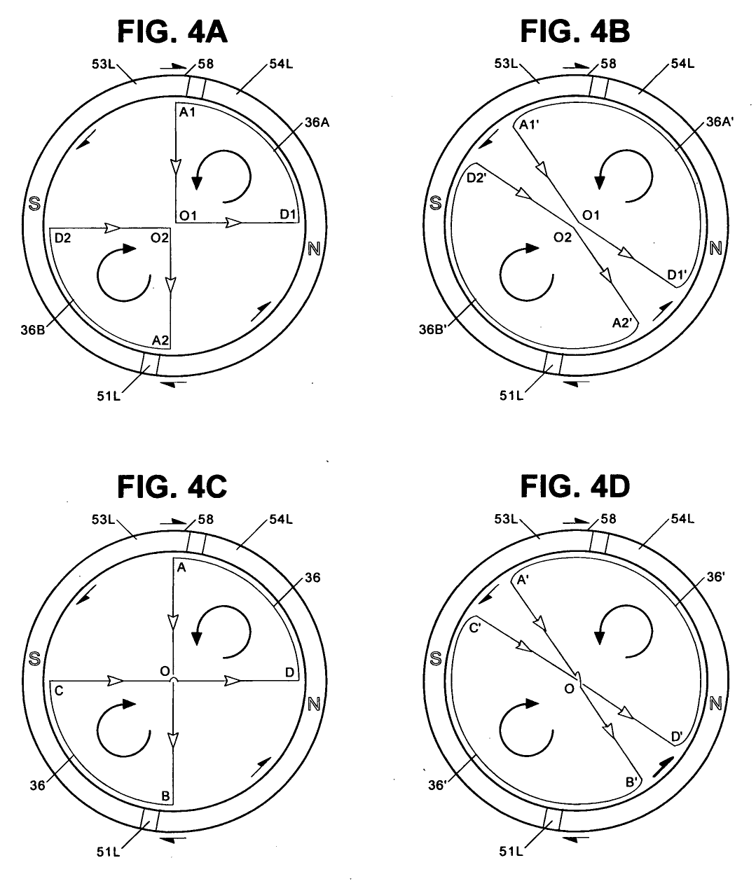

First of all, the conductive loop may be arranged to include curvilinear lines defining broader or wider curvilinear polygon which occupies as much of an area of the substrate layer. FIG. 4A is a top view of the induction member shown in FIG. 3M having a pair of curvilinear triangular conductive units in operation over the lower magnet of FIG. 1A according to the present invention. As is the case with the flipped trapezoidal conductive loops of FIGS. 2A and 2C, triangular conductive units 36A, 36B may induce current when the leading edge 58 of the lower magnet 52L travels between vertices A₁ and D₁ of the first triangular unit 36A about 90 degrees and between other vertices A₂ and D₂ of the second triangular unit 36B about another 90 degrees. When the leading edge 58 travels between D₁ and A₂ and between D₂ and A₁, however, electric current induced along the lines A₁O₁, A₂O₂ is respectively countered by adverse electric current flowing in the same direction along the lines D₁O₁, D₂O₂. Thus, no net current flows in either of the triangular units 36A, 36B. Therefore, the conductive loop of FIG. 4A can induce the current for 180 degrees out of 360 degrees around the induction member or during 50% of cyclic movement of the magnetic member. FIG. 4B is a top view of another induction member with a pair of wider curvilinear triangular conductive units in operation over the lower magnet of FIG. 1A according to the present invention. Such an embodiment is identical to that of FIG. 4A, except that angles A₁′O₁D₁′, A₂′O₂D₂′ of their triangular units 36A′, 36B′ are obtuse, e.g., about 150 degrees each. Therefore, the conductive loop including two broader or wider curvilinear triangular units 36A′, 36B′ may induce the current for about 300 degrees out of 360 degrees or during 83% of the movement of the magnetic member. The same applies to the conductive lines forming flipped curvilinear polygons. FIG. 4C shows a top view of the induction member of FIG. 1C having a flipped curvilinear trapezoidal conductive unit in operation over the lower magnet of FIG. 1A, while FIG. 4D is a top view of another induction member including a wider flipped curvilinear trapezoidal conductive unit in operation over the lower magnet of FIG. 1A according to the present invention. Similar to the case of the triangular units 36A′, 36B′, a broader flipped trapezoidal unit 36′ of FIG. 4D may induce electric current during 83% of the cyclic movement of the magnetic member compared to 50% of a narrower flipped trapezoidal unit 36 shown in FIG. 4C. It is appreciated that broader or wider polygonal conductive loops may prove to be beneficial particularly when the upper and lower magnets of the magnetic member are comprised of two semicircular magnetic elements as shown in FIGS. 1D and 1E. That is, whether or not to use the wider polygonal conductive loops generally depends upon various configurational and/or magnetic characteristics of the magnetic member which may include, but not be limited to, a number of magnetic elements in each magnet of the magnetic member, distribution of the N and/or S poles of the magnets, strengths and/or orientation of such magnetic elements, and the like.

Secondly, the polygonal conductive loop are first divided into multiple curvilinear segments and then electrically connected by proper interunit, interloop, and/or interlayer connections which will be described in greater detail below. Thirdly, the conductive loop may be formed by flipping one or more sides of a polygon as described hereinabove. In addition, conventional directional electronic elements such as diodes may be incorporated into the conductive loop or an external circuit to prevent flow of the adverse current in the adverse direction. In the alternative, IC-type semiconductive diodes of this invention may be fabricated on the substrate layer and incorporated into the conductive loop and/or an external circuit to prevent the adverse current. Conventional commutators or IC-type commutators of this invention may be incorporated to manipulate the desired and/or adverse electric current to flow in desirable directions as well.

In another embodiment for the conductive loop of the induction member, such a loop includes at least one curvilinear line of which the length may vary from only a fraction to several hundred times of a characteristic dimension of the substrate layer. For efficiency reasons, multiple curvilinear lines are typically provided on the substrate layer. General examples of such conductive loops include a unit of multiple straight lines as exemplified in FIG. 3A and another unit of multiple curved lines as described in FIGS. 3S and 3T. More than one unit of such curvilinear lines may also be distributed symmetrically or asymmetrically on the substrate layer according to a preset pattern, where the lines of each unit may have identical, similar or different numbers, shapes, sizes, gaps therebetween, orientations, patterns of arrangements,etc. For example, the conductive loops may be comprised of a cluster of such units each having identical or similar curvilinear lines or such units in each of which the lines are disposed to have different orientation as described in FIGS. 3B and 3C, arrangement, gaps or lengths, and the like. Such lines in each unit may be arranged parallel to each other as exemplified in FIGS. 3A to 3C, may be arranged to fan out from one or more preset points as shown in FIGS. 3G, 3J, 3K, 3L, 3S, 3T, and 3U or from one or more regions as shown in FIGS. 3H and 31, and/or may be arranged to overlap or intersect each other at preset angles as exemplified in FIGS. 3D, 3E, 3F, 3J, 3K, 3L, 3T, and 3U with or without making electrical connections therebetween. Such units may be shaped and/or sized to fit into half-circles, quadrants or other segments of the substrate layer or to fit into curvilinear polygons defined and arranged on the substrate layer. The curvilinear lines of a unit and/or those lines in each of the units may be arranged angularly or radially around the center of the substrate layer apart from each other by preset distances as shown in FIGS. 3B, 3C, 3J, 3T, 3U, and 3X or may also be arranged concentrically as exemplified in FIG. 3K. Alternatively, the curvilinear lines of a unit and/or those lines in each of the units may also be arranged to overlap or intersect each other as exemplified in with or without making electrical connections therebetween as described in FIGS. 3D, 3F, 31 to 3L, 3T, and 3U. Such conductive loop may be made as a combination of the foregoing units of curvilinear lines or may be arranged according to a combination of the above patterns. It is appreciated that such curvilinear conductive lines may be readily provided and oriented to effectively induce electric current regardless of detailed configurational and/or magnetic characteristics of the magnetic. It is also appreciated that all the foregoing embodiments of the conductive loops are more or less a cluster of multiple curvilinear lines, where a key to the efficient current induction centers around how to connect each curvilinear lines constituting such curvilinear polygons as will be described in detail below.

In yet another embodiment, the conductive loop includes a mesh consisting of curvilinear lines intersecting or overlapping each other at preset angles. Examples of such loops may include a mesh of multiple straight lines overlapping one another at 90 degrees without making electric connections therebetween as exemplified in FIG. 3D and a similar mesh of such lines electrically contacting each other as described in FIG. 3E. The straight conductive lines may also overlap or intersect each other at other preset angles as exemplified in FIGS. 3F, 3J, and 3K or at varying angles as shown in FIGS. 3I and 3L. Such a mesh may also be comprised of multiple curved lines overlapping or intersecting one another as exemplified in FIGS. 3T and 3U. Multiple meshes of such curvilinear lines may be arranged symmetrically or asymmetrically on the substrate layer according to a preset pattern, where the lines of each unit may have identical, similar or different numbers, shapes, sizes, gaps, orientations, and/or arrangements. Such meshes may also be shaped and sized to fit into half-circles, quadrants or other segments of the substrate layer or to fit into curvilinear polygons defined and arranged thereon. The meshes may be arranged angularly or radially about the center of the substrate layer apart from each other or concentrically. Multiple meshes may also be arranged to overlap or intersect each other with or without making electrical connections therebetween. The conductive loops may also be made as a combination of the foregoing meshes or according to a combination of the foregoing patterns.

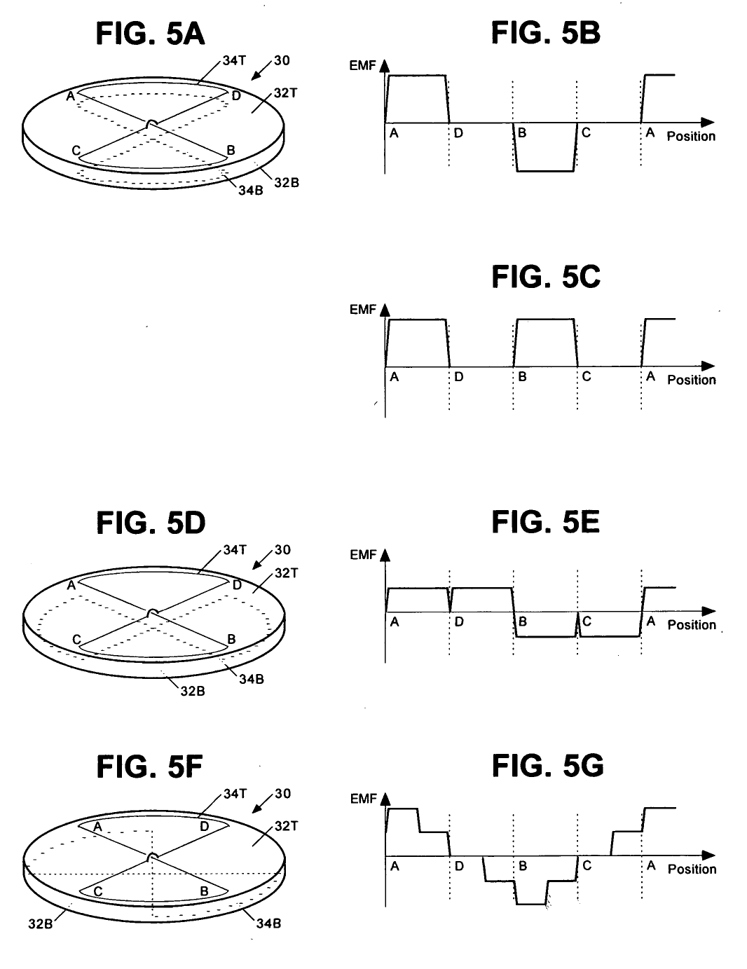

Upon being incorporated along with the magnetic members into the electromagnetic generators of the present invention, the foregoing induction members may generate electric currents with various temporal profiles depending upon various factors such as, e.g., configurational characteristics of the induction members, magnetic and configurational characteristics of the magnetic members, orientation and/or arrangements between such induction and magnetic members, directions and/or speeds of the movements of the induction members and/or magnetic members, and the like. For example, FIG. 5A is a perspective view of the induction member of FIGS. 1A through 1E having identical conductive loops in identical locations of a top surface and a bottom surface thereof and FIG. 5B is a temporal profile of electromotive force (i.e., EMF) attainable by the exemplary generator including the induction member of FIG. 5A according to the present invention. It is assumed in this embodiment that the induction member 30 includes a first flipped trapezoidal conductive loop 34T on its top surface 32T as well as a second flipped trapezoidal conductive loop 34B on its bottom surface 32B, and that such top and bottom loops are connected in series by appropriate intralayer and/or interlayer connectors as will be described in detail below. The induction member 30 which is placed between the upper and lower magnets of the magnetic member 50 of FIGS. 1A to 1E and 4A to 4D operates in four cycles as shown in FIGS. 2A to 2D. By representing an intensity of the EMF (or current flowing across a constant external load) in an ordinate and denoting positions of the leading edge 58 of the magnets 52U, 52L as an abscissa using the locations of the points, A, D, B, and C disposed along arcuate peripheries of the conductive loops 34T, 34B, the EMF is represented by a voltage pulse train consisting of square waves with alternating polarities with idle intervals disposed therebetween.

Such an induction member 30 may also be used to generate a DC voltage (or current) instead of the above AC voltage (or current). For example, a conventional commutator or a planar commutator of the present invention may be implemented to alter directions of the voltage (or current) supplied to a load as the upper and/or lower magnets 52U, 52L of the magnetic member 50 or the induction member 30 rotates a specific angle, e.g., about 180 degrees for the embodiment of FIGS. 1A to 1E and 2E. As in FIG. 4C which is a temporal profile of EMF attainable by the exemplary generator with the induction member of FIG. 5A and the commutator according to the present invention, the EMF is again a voltage (or current) pulse train consisting of square waves having same polarities with idle intervals disposed therebetween.

As described hereinabove, the temporal profiles of the induced voltage (or current) may also be varied by manipulating, e.g., configurational characteristics of the induction member, magnetic and configurational characteristics of the magnetic members, orientation or arrangements between such induction and magnetic members, directions or speeds of the movements of the induction members or magnetic members, and the like. For example, the conductive loops 34T, 34B may be provided on the top and bottom surfaces 32T, 32B of the induction member 30 in different configurations to minimize or to avoid the idle intervals disposed between the square waves of FIGS. 5B and 5C. FIG. 5D shows a perspective view of an exemplary induction member having conductive loops disposed on its top and bottom surfaces and angularly apart by 90 degrees, and FIG. 5E is a temporal profile of EMF attainable with the exemplary generator with the induction member of FIG. 5D according to the present invention. As described above, the current is flows through the conductive loop 34T on the top surface 32T of the induction member 30 when the leading edge 58 travels between the points A and D and between the points B and C. Because the bottom conductive loop 34B is disposed apart by about 90 degrees counterclockwise from the top conductive loop 34T, the bottom conductive loop 34B rather generates the electric current when the leading edge 58 travels between the points D and B and between the points C and A. As a result, the EMF attainable by the generator 10 having the induction member 30 of FIG. 5D is a pulse train consisting of square waves which alternate its polarity by every other square wave and which do not have any significant idle intervals therebetween. It is appreciated, however, that, contrary to the top and bottom conductive loops 34T, 34B of the induction member 30 of FIG. 5A which simultaneously generate the current in two of the foregoing four cycles, those 34T, 34B of the induction member 30 of FIG. 5D generates the current in each of such cycles. Therefore, an intensity of the square waves of FIG. 5E has to amount to about one half of those of FIG. 5B.

Another exemplary embodiment is shown in FIG. 5F which denotes a perspective view of an induction member including conductive loops disposed on its top and bottom surfaces and angularly apart by 45 degrees and FIG. 5G represents a temporal profile of EMF attainable by another exemplary generator with the induction member of FIG. 5F according to the present invention. In this embodiment, the conductive loop 34B on the bottom surface 32B of the induction member 30 is disposed apart by about 45 degrees counterclockwise from the conductive loop 34T on the top surface 32T thereof and, therefore, induces the current while the leading edge 58 is located between a halfway point of C and A and a halfway point of A and D and between a halfway point of D and B and a halfway point of B and C. As a result, the EMF attainable by the generator 10 having the induction member 30 of FIG. 5F is a pulse train consisting of compounded steps with alternating polarities and short intervals between the steps.

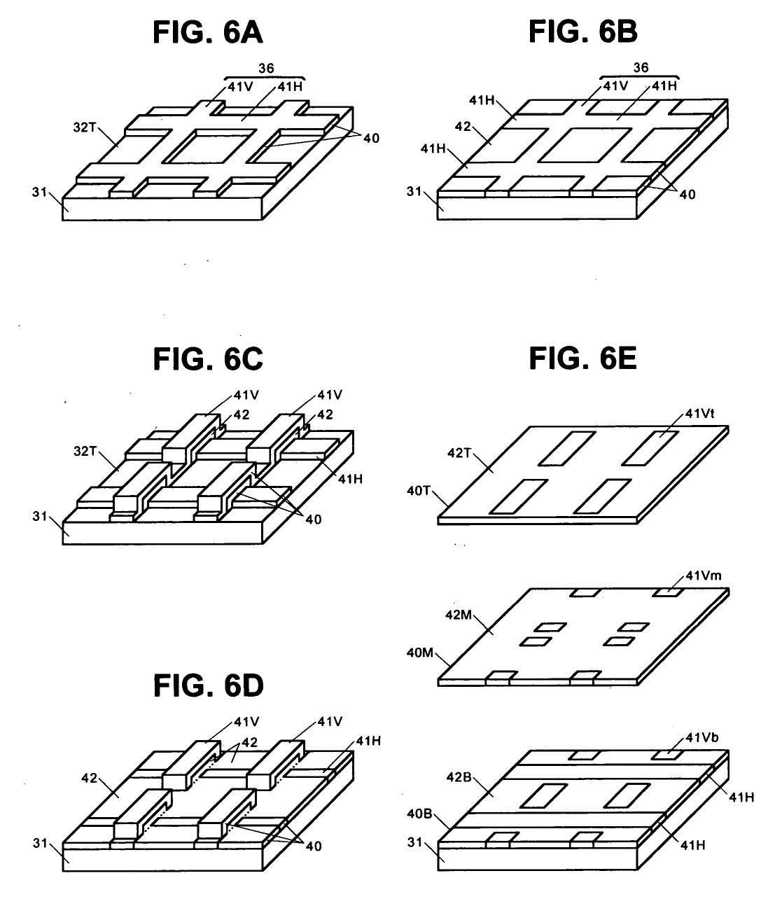

The above conductive loops 34 of this invention may be constructed by various methods, e.g., by disposing loops of thin conductive wire on the top and/or bottom surface 32T, 32B of the substrate layer 31, by winding such wire around the substrate layer 31, and the like. Processes similar to those conventionally used in semiconductor fabrication may also be applied to construct various conductive loops 34 and/or units 36 thereof. FIG. 6A shows a perspective view of an exemplary interconnecting mesh of conductive lines according to the present invention, where a portion described in the figure is an exploded view of the dotted region 39C of the induction layer 40 of FIG. 3E. In this embodiment, the induction member 30 includes a single induction layer 40 which is disposed on the substrate layer 31 and which consists of a single unit 36 of multiple vertical wires 41V and multiple horizontal wires 41 H intersecting each other at 90 degrees. Such an induction layer 40 may be provided by depositing a layer of conductive substances on the substrate layer 31 by, e.g., chemical vapor deposition, physical vapor deposition, ion bombardment deposition, and other conventional equivalent or similar deposition processes capable of forming thin or planar layers of various conductive substances or precursors thereof over the substrate layer 31. It is preferred that the wires 41V, 41H be arranged to occupy as much a portion of the substrate layer 31 such that the conductive unit 36 of such wires 41V, 41H may have a greater length, number, and/or cross-sectional area. FIG. 6B is another perspective view of the dotted region 39C of the contacting mesh of FIG. 3E according to the present invention. Such an induction member 30 also includes an induction layer 40 which not only includes the interconnecting vertical and horizontal wires 41V, 41H but also defines multiple insulative regions 42 formed between or around such wires 41V, 41H. Such an induction layer 40 may be provided by various processes. In one process, e.g., a layer of insulative substances is deposited on top of the substrate layer 31 by one of the foregoing deposition methods. Portions of such a layer is then etched away according to a preset pattern to provide thereon interconnecting trenches, preferably using a conventional masking method, and such trenches are subsequently filled by conductive substances to form the conductive unit 36. Alternatively, the trenches may be filled by precursors which are to be subsequently treated thermally or chemically to form the conductive unit 36. It is noted that such insulative substances are generally non-conductive substances or those having minimal conductivity but not causing significant current leakage therethrough. It is preferred that the insulative layer be etched as aggressively as possible such that the trenches occupy as much a portion of the substrate layer 31, thereby providing the conductive unit 36 having a greater length, number or cross-sectional area. In another process, a layer of non-conductive or semiconductive substances is provided over the substrate layer 31 using one of the foregoing deposition methods. Selected portions of such a layer is then treated according to a preset pattern by appropriate chemicals capable of manipulating electrical conductivity, electron mobility, and/or hole mobility thereof. The layer may be cured thermally and/or chemically thereafter to convert the treated portions of the layer into the conductive unit 36. As much a portion of the layer is preferably treated to define the conductive unit 36 having a greater length, number or cross-sectional area as well.

Conventional semiconductor fabrication techniques may also be applied to construct various non-contacting conductive loops 34 and/or non-contacting units 36 thereof. FIG. 6C is a perspective view of the dotted region 39C of a non-contacting mesh of FIG. 3E according to the present invention. The induction member 30 includes an induction layer 40 consisting of horizontal wires 41H, insulative regions 42, and vertical wires 41V, where each insulative region 42 is disposed between the lower horizontal wires 41H and the top vertical wires 41V to prevent interconnection therebetween. Such an induction member 30 may be provided by a series of deposition, etching, and/or filling processes by, e.g., depositing a bottom conductive layer over the substrate layer, etching away portions of the bottom conductive layer to form multiple horizontal conductive lines 41H, depositing an insulative layer thereover, etching away selected portions of the insulative layer to form the insulative regions 42 on the preselected portions of the horizontal conductive lines 41H, depositing another conductive layer thereover, and etching away portions of such a conductive layer to form the top vertical conductive lines 41V. The above process may also be modified to construct functional equivalents of the non-contacting conductive unit of FIG. 6C. FIG. 6D is another perspective view of the dotted region 39C of the non-contacting mesh of FIG. 3E according to the present invention. As manifest in the figure, this embodiment is generally identical to that of FIG. 6C, except that the induction layer 40 rather includes a contiguous three-dimensional insulative layer 42. Such an induction member 30 may be provided by a series of deposition, etching, and/or filling processes such as, e.g., depositing an insulative layer over the substrate layer 31, etching away portions of the insulative layer to define multiple parallel trenches and a series of multiple short segments aligned normal to such trenches, filling both the trenches and the segments with conductive substances to define the horizontal conductive lines 41H and the small lower portions of the vertical conductive lines 41V, respectively, depositing a second insulative layer thereover, etching away small portions of the second insulative layer to form multiple short segments, filling the segments with the conductive substances, etching away the rest of the remaining portions of the second insulative layer while leaving multiple short segments over the overlapping locations of the horizontal conductive lines 41H, and depositing another conductive layer to form the top portions of the vertical conductive lines 41V. In all of the foregoing embodiments, such trenches and/or short segments may be filled with the precursors of such conductive substances and treated chemically or thermally thereafter to convert such precursors into the conductive materials. It is also preferred that the vertical and horizontal conductive lines 41V, 41H occupy as much a portion of the substrate layer 31 to form the conductive unit 36 having a greater length, number, and/or cross-sectional area.

Such an induction member 30 may further be constructed by providing multiple induction layers over the substrate layer 31. For example, the induction member 30 may include a first induction layer which is disposed over the substrate layer 31 and includes multiple parallel horizontal conductive lines 41H therein, an insulation layer deposited thereover, and a second induction layer disposed over the insulation layer and including multiple parallel vertical conductive lines 41V therein. Alternatively, the horizontal and vertical conductive lines 41H, 41V may also be distributed in multiple induction layers as exemplified in FIG. 6E which shows a perspective view of a layer structure of the dotted region 39C of a non-contacting mesh of FIG. 3E according to the present invention, where the induction member 30 consists of the substrate layer 31, a bottom induction layer 40B, a median induction layer 40M, and a top induction layer 40T. The bottom induction layer 40B includes parallel horizontal conductive lines 41H, two columns of short bottom segments 41Vb of the vertical conductive lines 41V, and insulative regions 42B separating the horizontal conductive lines 41H from the bottom segments 41Vb, while the top induction layer 40T defines long top segments 41Vt of the vertical conductive lines 41V separated by a contiguous insulative layer 42T. The median induction layer 40M includes multiple short segments 41Vm of vertical conductive lines 41V which are shaped, sized, and positioned to electrically contact the long top segments 41Vt to the short bottom segments 41Vb of the vertical conductive lines 41V so that the vertical conductive lines 41V forms continuous interlayer paths therealong. It is noted that the exemplary layer configuration of FIG. 6E may also be modified in various ways, e.g., by distributing the horizontal conductive lines 41H in more than two layers, including another set of vertical or horizontal conductive lines, and the like. It is also noted that the vertical and horizontal conductive lines 41V, 41H preferably occupy as much portions of at least the top and bottom induction layers 40T, 40B to define the conductive unit 36 having a greater length, number, and/or cross-sectional area.

As described above, various conductive loops and units thereof may be made by conventional semiconductor fabrication techniques. It is noted, however, that an entire wafer which is disposed in a vacuum chamber for the foregoing deposition techniques and which is processed therein may be used as a single induction member 30 after minimal polishing and/or cleaning processes but preferably without any cutting processes. When desirable, the processed wafer may also be divided to produce multiple, e.g., up to nine induction members 30 of this invention.

Induction members incorporating the foregoing substrate and induction layers including various conductive elements, loops, and/or units of this invention may also be shaped and sized in a variety of configurations. An induction member generally has a cross-sectional shape and/or size similar to that of the induction layer. Therefore, such an induction member may form a cylindrical or slab-like article with curvilinear polygonal cross-section. In addition, the induction member preferably forms a planar article having a thickness (or height) less than, e.g., about 10 cm, 8 cm, 6 cm, 4 cm, 2 cm, 1 cm, 8 mm, 6 mm, 4 mm, 2 mm, 1 mm, 500 microns, 100 microns, 50 microns, 10 microns, and so on. The induction member may be arranged to define in its center region or in its off-center region at least one aperture in which no conductive elements are provided, in which a rotating shaft of an actuating member may be disposed, and/or through which the conductive elements and units of the top and bottom surfaces of the induction member are to be connected.

Various basic elements of the foregoing conductive loops and conductive units thereof may be electrically connected for different reasons. First of all, proper electrical connections may be needed to harness electric power of the induced electric voltage and/or current by supplying such to internal loads (such as, e.g., rechargeable batteries or other energy storage members of the electromagnetic induction generator of this invention) and/or to external loads (such as, e.g., laptop computers, cellular phones, PDAs, GPS equipment, and other electronic and electric devices). Secondly, proper electrical connections, more particularly, serial connections of terminals of such basic elements having opposite polarities may preferably increase total lengths of the conductive loops which increase a magnitude of the induced currents. In contrary, parallel connections of terminals of such basic elements having the same polarities may augment electric power associated with such electromagnetic induction, without necessarily increasing the magnitude of the current. Thirdly, proper electrical connections may avoid or minimize the adverse current induced along such basic elements or, alternatively, proper electrical connections may augment the induced current by converting the polarity of the adverse current and adding the converted induced current to the main current. Furthermore, proper electrical connections allow construction of compact induction members and compact electromagnetic induction generators including such induction members.

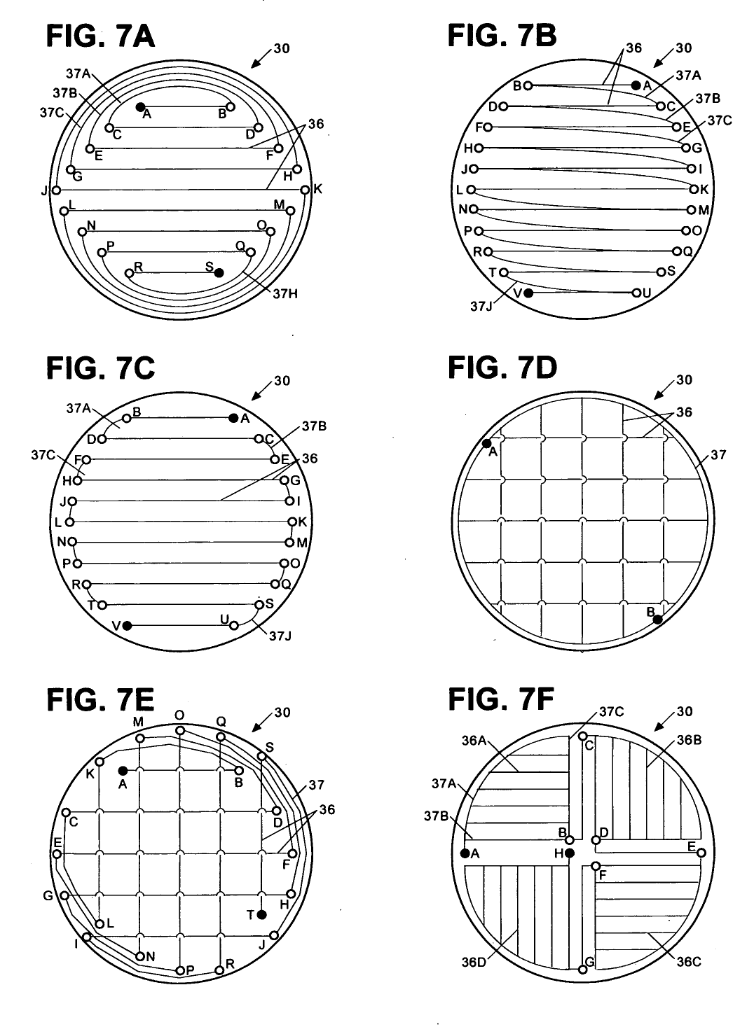

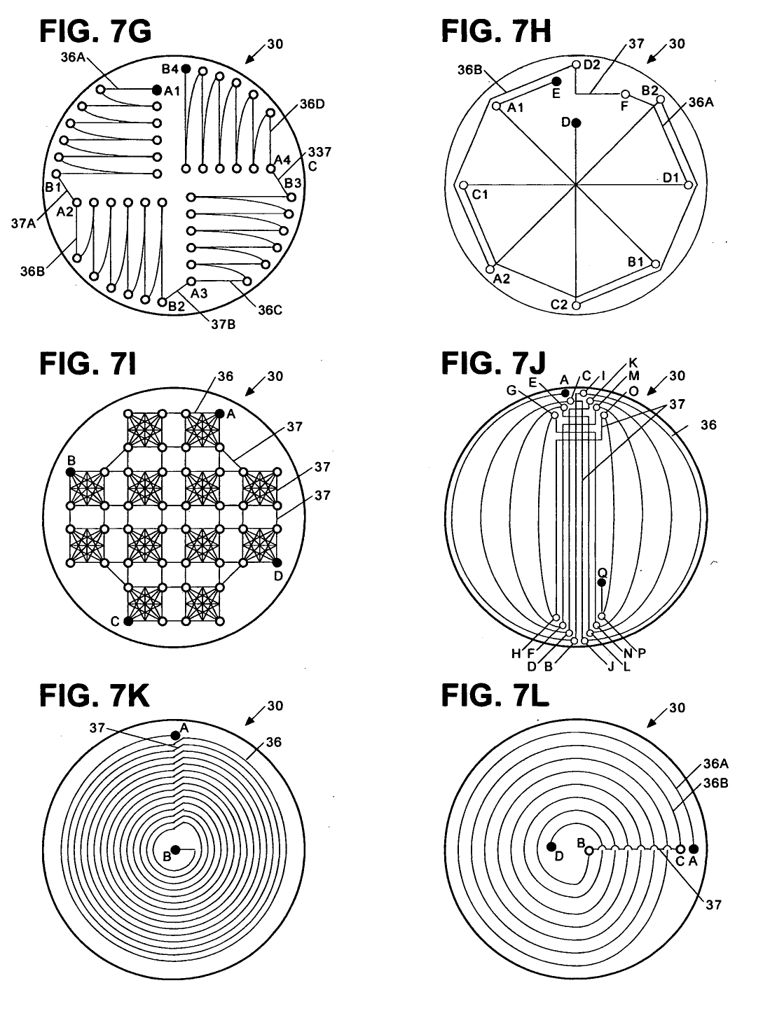

The conductive loops, their conductive units, and their curvilinear lines and/or polygons may be electrically connected in a variety of parallel and/or series modes. FIG. 7A is a top view of exemplary series electrical connections of parallel conductive lines of the induction member of FIG. 3A according to the present invention, where blank circles denote electrical nodes formed along a series or parallel conductive loop, while solid circles denote electrical contacts which may be connected to electrical contacts of other conductive loops, conductive lines, conductive units, internal loads, and/or external loads. The conductive lines of the conductive unit 36 are typically connected from top to bottom such that a node B of a top line AB is connected to a node C of a second top line CD in series by a curved peripheral conductive path 37A which is generally provided in a top half of the induction member 30 and concentric (or arcuately parallel) with a boundary of the induction member 30. Another node D of the line CD is connected to a node E of a line EF in series through another curved conductive path 37B which is also disposed on the top half and concentric with the first conductive path 37A. Other lines are similarly connected in series, until a node Q of a line PQ is connected to a node R of a line RS by an arcuate conductive path 37H disposed on a bottom half of the induction member 30 and concentric with the boundary of the induction member 30, leaving another node S of the line RS as an electrical contact. Accordingly, the foregoing parallel conductive lines and arcuate peripheral conductive paths constitute a single conductive loop starting at a first contact A and terminates at the second contact S (or vice versa), and the electromagnetic induction generator 10 incorporating the induction member 30 may generate electric current from the contact A toward the contact S (or vice versa), depending on various factors such as, e.g., configurational and/or magnetic characteristics of the magnetic member 50, its orientation, and/or its movement direction. It is noted that, when the induction member 30 of this embodiment is incorporated into the exemplary generator 10 of FIGS. 1A to 1E, only parallel conductive lines may actively induce electric current, whereas the arcuate conductive paths 37A-37H which are arcuately extending in the same direction as the rotational movement direction of the magnetic member 50 may not induce any electric current. In this context, the parallel conductive lines of this embodiment may be referred to as “active,” “active” lines or “active” elements, while the arcuate conductive paths may be referred to as “passive,” “passive” lines or “passive” elements. The conductive paths may be arranged to be passive, if not at least partially active, to avoid or minimize induction of adverse current therethrough, e.g., by providing appropriate shapes, sizes, and/or orientations thereto. The foregoing concentric conductive paths may be provided in different configurations so that, e.g., the conductive paths 37A-37H may consist of multiple linear segments. In addition, a pair of electrical contacts A, S or more contacts may be provided in appropriate locations of the induction member 30, the paths 37A-37H may be disposed preferentially on the top half or the bottom half of the induction member 30, the electrical contacts A, S and/or nodes B-R may be designated in other locations, the conductive lines may be differently connected, and the like. It is appreciated that the above series conductive loop is arranged so that the induced current may flow through each of the conductive lines in a consistent direction, thereby minimizing induction of the adverse current.

FIG. 7B is a top view of another exemplary series electrical connections of parallel conductive lines of the induction member of FIG. 3A according to the present invention. Such a series conductive loop typically starts from a contact A, extends along a line AB, is connected to a line CD by an arcuate conductive path 37A between nodes B and C, extends along the line CD, is connected to a line EF by another arcuate conductive path 37B between nodes D and E, and the like, until a line ST is connected to a line UV by another arcuate conductive path 37J between nodes T and U, and finally terminates at an opposite contact U. Therefore, depending upon configurational and magnetic characteristics of the magnetic member 50, its orientation, and/or its movement direction, the electric current may be induced through the loop from the contact A toward the contact S (or vice versa). The series conductive loop of FIG. 7B is generally similar to that of FIG. 7A, except that a total length of the conductive loop of FIG. 7B is shorter than that of FIG. 7A and, therefore, a larger portion of a top area of the induction member 30 may be favorably used to include more conductive lines thereon as manifest from the figures (e.g., eleven conductive lines of FIG. 7B compared to nine conductive lines of FIG. 7A). However, because the conductive paths 37A-37H shown in FIG. 7B are not concentric with the boundary of the induction member 30 and instead generally extend in the same direction as their conductive lines, some adverse current may inevitably be induced therethrough. It is appreciated that the foregoing series conductive loop is also constructed in such a way that the induced current flows through each of the conductive lines in a consistent direction. Different electrical connections may fall within the scope of the present invention. For example, the electrical contacts and/or nodes may be designated in different locations of the conductive lines 36A-36D or the conductive paths 37A-37J may also be differently connected in parallel and/or in series.

FIG. 7C is a top view of another exemplary series electrical connections of parallel conductive lines of the induction member of FIG. 3A according to the present invention. A series conductive loop starts from an electrical contact A, extends along a top conductive line AB, is connected to a line DC through an arcuate conductive path 37A connecting adjacent nodes B and D, extends along a line DC, is connected to a line EF by another conductive path 37B connecting adjacent nodes C and E, and the like, until a line ST is connected to a bottom line UV through a conductive path 37J connecting nodes S and U, and finally terminates at another electrical contact V. Therefore, depending on configurational and magnetic characteristics of the magnetic member 50, its orientation, and/or its movement direction, electric current may be induced from the contact A to the contact S (or vice versa) through the series conductive loop. The conductive loop of this embodiment is generally similar to those of FIGS. 7A and 7B, except that such a loop is constructed in such a way that the induced current flows through each of the parallel conductive lines in alternating directions. Therefore, opposing adverse currents may be induced therealong and such an induction member may be incapable of producing net induced current. Other electrical connections may also fall within the scope of the present invention. For example, the electrical contacts A, V and/or nodes B-U may be designated in different locations, or the conductive lines or paths 37A-37J may be differently connected in parallel and/or in series.

FIG. 7D is a top view of exemplary parallel electrical connections of a mesh having overlapping conductive lines of the induction member of FIG. 3D according to the present invention. The peripheral conductive path 37 of this embodiment connects both terminals of each of the conductive lines of the conductive unit 36 and, accordingly, all conductive lines may be connected in parallel. The conductive path 37 further defines two electrical contacts, A and B, preferably on its opposite sides. Depending upon detailed characteristics of the magnetic member 50, its orientation, and/or its movement direction, electric current may be induced in either direction along the vertical conductive lines and/or horizontal conductive lines of the conductive unit 36. Such electric current may be collected along the peripheral conductive path 37 and retrieved across the contacts A, B. When the induction member 30 is used with the magnetic element 50 of FIGS. 1A to 1E, the active elements of the conductive unit 36 are the overlapping conductive lines, whereas the passive element of the unit 36 is the peripheral conductive path 37. It is appreciated that, when the induction members of FIGS. 3D and 3E are implemented with two electrical contacts, they generally have similar or identical operational characteristics regardless of whether the conductive lines may be overlapping or interconnecting one another. Other electrical connections may fall within the scope of the present invention. For example, the electrical contacts A, B may be designated in different locations along the conductive unit 36 or path 37 or conductive lines may be differently connected in parallel and/or in series.

FIG. 7E is a top view of exemplary series electrical connections of a mesh having overlapping but not interconnecting conductive lines of the induction member of FIG. 3D according to the present invention. In this embodiment, a series conductive line may be provided by connecting horizontal and vertical conductive lines in an appropriate order. For example, a node B of a top horizontal line AB is connected in series to a node K of a vertical line KL by a multi-segmental conductive path connecting such nodes, a node L of the line KL is connected in series to a node C of a next horizontal line CD by another conductive path, a node D of the line CD is connected in series to a node M of a vertical line MN, and the like, so that a series conductive loop starts from an electrical contact A, extends through the lines AB, KL, CD, MN, EF, OP, GH, QR, IJ, and ST, and terminates at another contact T. Depending upon detailed characteristics of the magnetic member 50, its orientation, and/or its movement direction, electric current may be induced and retrieved across the contacts A and T. When such an induction member 30 is used with the magnetic element 50 of FIGS. 1A to I E, active elements of the conductive unit 36 are the overlapping vertical and horizontal conductive lines, while the passive elements are the multi-segmental peripheral conductive paths 37. Other electrical connections may fall within the scope of the present invention. For example, the conductive lines may be connected in different order, some conductive lines may be connected in parallel, electrical contacts A, T may be designated in different locations of different conductive lines, and the like.

FIG. 7F is a top view of exemplary series electrical connections of multiple quadrant units with parallel conductive lines of the induction member of FIG. 3C according to the present invention, where a first conductive unit 36A includes an electric contact A and a node B, a second unit 36B forms two nodes C and D, a third unit 36C includes two nodes E and F, and a last unit 36D includes a node G and another contact H. In each unit 36A-36D, multiple horizontal or vertical conductive lines are connected in parallel between a peripheral conductive path 37A and one of internal conductive paths 37B, 37C. In addition, the first and second units 36A, 36B are connected in series by a line connecting the nodes B and C, the second and third units 36B, 36C by a line connecting the nodes D and E, and the third and fourth units 36C, 36D by a line connecting the nodes F and G. Electric current may be induced in each of the units 36A-36D along either direction of their horizontal or vertical conductive lines, converges to the nodes B, D, F, and H (or A, C, E, and G) respectively along its peripheral and/or internal conductive paths 37A-37C, and retrieved across the contacts A and H. It is noted that the connections shown in FIG. 7C are an exemplary embodiment of a combinational series-parallel connections. It is also noted that the peripheral conductive path 37A of the above embodiment may generally be passive, whereas the internal conductive paths 37B, 37C may become active depending upon the above features of the magnetic member 50. Other electrical connections may also fall within the scope of this invention. For example, the electrical contacts A, H and/or nodes B-G may be disposed in different locations of each quadrant unit 36A-36D or the units 36A-36D may be differently connected in parallel and/or in series.

FIG. 7G is a top view of exemplary series electrical connections of parallel conductive lines of multiple quadrant units of the induction member of FIG. 3C according to the present invention, in which the peripheral and internal conductive paths of FIG. 7F are removed from each quadrant unit 36A-36D and in which the horizontal or vertical conductive lines of each unit 36A-36D are connected in series by curvilinear internal conductive paths. Thereafter, an interunit series conductive loop is formed by connecting a node B₁ of the first unit 36A to a node A₂ of the second unit 36B by a first interunit path 37A, another node B₂ of the second unit 36B to a node A₃ of the third unit 36C by a second interunit path 37B, another node B₃ of the third unit 36C to a node A₄ of the fourth unit 36D by a third interunit path 37C, and using a node A₁ of the first unit 36A and a node B₄ of the fourth unit 36D as electrical contacts. Thus, the series conductive loop may be defined to start from the contact A₁, to extend in a zigzag mode through each unit 36A-36D, and to terminate at the contact B₄. Depending upon detailed characteristics of the magnetic member 50, its orientation, and its movement direction, induced electric current may flow from the contact A₁ to the contact B₄ (or vice versa) and may be retrieved across the contacts A₁, B₄. When the induction member 30 is used with the magnetic element 50 of FIGS. 1A to 1E, the active elements are the vertical and horizontal conductive lines, while the passive elements are the curved internal conductive path and the interunit conductive paths 37A-37C. Other electrical connections may fall within the scope of this invention. For example, the conductive lines of each unit 36A-36D may be connected in series in different orders, such lines of different units 36A-36D may be connected in another order, some conductive lines of one or more units 36A-36D may be connected in parallel, the electrical contacts A₁, B₄ may be designated in different locations of different conductive lines, and the like.

FIG. 7H is a top view of exemplary series electrical connections of multiple flipped trapezoidal units of an induction member of FIG. 3Q according to the present invention, where the units 36A, 36B are overlapping each other in the center region of the induction member 30 but their conductive lines do not electrically contact each other. To connect the flipped trapezoidal units 36A, 36B, the first unit 36A is opened between the nodes A₁ and D₁ to define a contact E and a node F, and the second unit 36B is opened between the nodes C₂ and D₂ to form another contact G. A peripheral conductive path 37 is also provided to connect the trapezoidal units 36A, 36B between the nodes F and D₂. When the induction member 30 is used in the generator 10 of FIGS. 1A to 1E, the induced current flows through a loop EA₁B₁C₁D₁ of the first unit 36A, the conductive path 37, and a loop of D₂A₂B₂C₂ of the second unit 37B, and is retrieved across the contacts E and G. It is appreciated that, as shown in FIGS. 2A to 2D, each of the flipped trapezoidal conductive units 36A, 36B does not induce net current when the leading edge 58 of the lower magnet 52L is disposed between A₁C₁, B₁D₁, A₂C₂ or B₂C₂. Because the units 36A, 36B overlap each other at 90 degrees, however, such a generator 10 may always induce some current during any phase of its periodic movement. Even when the leading edge 58 is disposed in one of the above intervals, e.g. A₁C₁ (or A₂C₂), only the inner unit 36A (or outer unit 36B) becomes inactive, and adverse current induced along one edge of the inactive unit 36A (or 36B) is canceled by favorable current induced along the other edge of the unit 36A (or 36B), while not directly diminishing an intensity of the current induced through the active unit 36B (or 36A). It is noted that the conductive lines of the units 36A, 36B simply overlap but do not electrically contact each other in the center of the induction member 30, and several exemplary embodiments of such will be described in detail below. It is also appreciated that such an embodiment of FIG. 6D may be regarded as an exemplary embodiment of the series electrical connection of multiple curvilinear lines overlapping and/or interconnecting at the center of the induction member 30 as in FIG. 3J. Other electrical connections may fall within the scope of this invention. For example, the conductive lines of each unit 36A, 36B may be connected in series in different order, the conductive lines of different units 36A, 36B may be connected in another order, some conductive lines may be connected in parallel, electrical contacts D, E may be placed in different locations of different conductive lines, and the like.

The conductive units of the induction member 30 of the present invention invention may also be arranged to have more complex configuration and/or in more complex connection patterns. FIG. 71 is a top view of exemplary series electrical connections of multiple combinational units each of which has various conductive lines of an induction member according to the present invention. For example, the induction member 30 consists of twelve conductive units 36 each of which defines four nodes therein and in each of which conductive lines are overlapped and/or connected to inter connect the nodes or internode points of each unit 36. Multiple electrical contacts A-D may also be designated in four of the peripheral conductive units 36, and each conductive unit 36 is electrically connected to adjacent units 36 by various conductive paths 37.

FIG. 7J is a top view of exemplary series electrical connections of curved conductive lines of the induction member of FIG. 3U according to the present invention. In this embodiment, each circular conductive line of the conductive unit 36 is opened at a top portion and a bottom portion to define four nodes, and vertical conductive paths are provided to connect such broken halves of the conductive lines in an appropriate order. Accordingly, an exemplary series conductive path may extend from a contact A, a left outermost half-circle AB, a vertical center conductive path connecting the node B to a node 1, a right outermost half-circle IJ, a right vertical conductive path connecting the node J to a node C, a second left half-circle CD, a left vertical conductive path which connects the node D to a node K, a second right half-circle KL, and the like, until a node H of a left innermost half-circle GH is connected to a node O of a right innermost half-circle OP, and then terminates at another contact O. Depending on the magnetic and configurational characteristics of the magnetic member 50, its orientation, and/or its movement direction, the electric current may be induced along the series conductive loop from the contact A to the contact Q (or vice versa) and retrieved across such contacts A, Q. It is appreciated that the active elements of this embodiment are the curved half-circles, whereas the passive elements are the vertical linear conductive paths. In this aspect, the induction member 30 shown in FIG. 7J may be regarded as a reversed embodiment of FIG. 7A where the active elements are the linear lines and the passive elements are the curved conductive paths, with a main difference that the active curved half-circles are arranged to occupy more area in the embodiment of FIG. 7J, whereas the active linear lines are arranged to occupy more area in that of FIG. 7A. Other electrical connections may fall within the scope of this invention. For example, such left and right half-circles may be connected in series in different orders, the left half-circles may first be connected in series and then connected in series to those on the right side, one or more half-circles may be connected in parallel, two (or more) electrical contacts may be designated in different locations, and the like.

FIG. 7K is a top view of exemplary series electrical connections of concentric circular lines of the induction member of FIG. 3W according to the present invention. Each of circular conductive lines of the conductive unit 36 is opened and then connected to an adjacent line through one of conductive paths 37. For example, an outermost circular line is opened to form a contact A and a node which is connected to one of two nodes of a second outermost circular line through a first conductive path 37, and the other node of the second outermost line is connected to one of two nodes of a third line by a second conductive path 37, and so on, until one node of a second innermost circular line is connected to one of the nodes of an innermost circular line through a last conductive path 37, and the other node of the innermost line defines another contact B, thereby constituting a single spiral conductive unit 36 which is similar to that of FIG. 3V. To the contrary, FIG. 7L is a top view of exemplary series electrical connections of a pair of intertwining spiral conducive lines according to the present invention. In this embodiment, each spiral unit 36A, 36B has a length which is about one half of that of the spiral unit 36 of FIG. 3V, and defines outer nodes A, C and inner nodes B, D, respectively. By connecting the inner node B of the first spiral unit 36A with the outer node C of the second spiral unit 36B through a radial conductive path 37, a single spiral loop may be constructed. It is appreciated that the spiral units 36A, 36B of FIG. 7F connected in series is functionally equivalent to that of FIG. 3V, although the composite loop of FIG. 7F offers more options of connections to other conductive loops of other induction layers. Other electrical connections may also fall within the scope of this invention. For example, the circular or spiral conductive lines may be connected in series in different orders, one or more circular or spiral lines may be connected in parallel, two or more electrical contacts may also be designated in different locations, and the like.

It is appreciated that all exemplary embodiments of the basic conductive elements, conductive curvilinear lines and/or polygons, and/or conductive units having peripheral conductive paths may be regarded to include at least one built-in parallel electrical connection therein. It is also appreciated that the curvilinear conductive polygons or otherwise closed conductive configurations may be connected directly in series or parallel as exemplified in FIG. 7C or that their conductive lines may be appropriately connected after opening at least a portion of such polygons or configurations. In addition, the parallel and/or series electrical connections exemplified in FIGS. 7A through 7L may be used to connect other basic conductive elements and/or conductive units. For example, the series connections of FIGS. 7A to 7C may be applied to any other curvilinear conductive lines which may be arranged parallel to each other, arranged at angles, and/or overlapping each other, while the parallel and/or series connections of FIGS. 7D and 7E may be applied to any other meshes of interconnecting or overlapping curvilinear conductive lines. The parallel and/or series connections of multiple conductive units of FIGS. 7F to 7I may further be applied to series and/or parallel connections of multiple conductive units or polygons which may include therein any number of basic curvilinear conductive elements having any shapes or sizes, which may be arranged symmetrically or asymmetrically, and which may be arranged angularly around the center of or other point inside the induction member, disposed along the boundary thereof, disposed preferentially on one side thereof, or distributed otherwise thereon. In addition, the parallel and/or series connections of FIG. 7I may be applied to any curvilinear conductive lines, polygons, and units. The series and/or parallel connections of FIGS. 7J to 7L may further be applied to series and/or parallel connections of any curved conductive lines such as circular lines, semicircular lines, arcuate lines, spiral lines, and the units including such lines.

Electrical connections other than those exemplified hereinabove may also fall within the scope of the present invention. For example, various contacts and/or nodes may be designated in different locations depending upon various factors including, but not limited to, magnetic and/or configurational characteristics of the magnetic member, movement directions of the magnetic member, a total number of conductive loops in each induction layer, direction of the induced current, electrical connections of the conductive elements or units provided in different induction layers, and so on. Whether a specific basic conductive element may be a passive element or an active element may generally be determined by any of the foregoing factors. In other words, any basic conductive elements may play the role of the active conductive line or the passive conductive path when incorporated into magnetic members which may have different characteristics or move or rotate in different directions. Furthermore, the conductive elements and units may also be connected by combinations of the foregoing embodiments

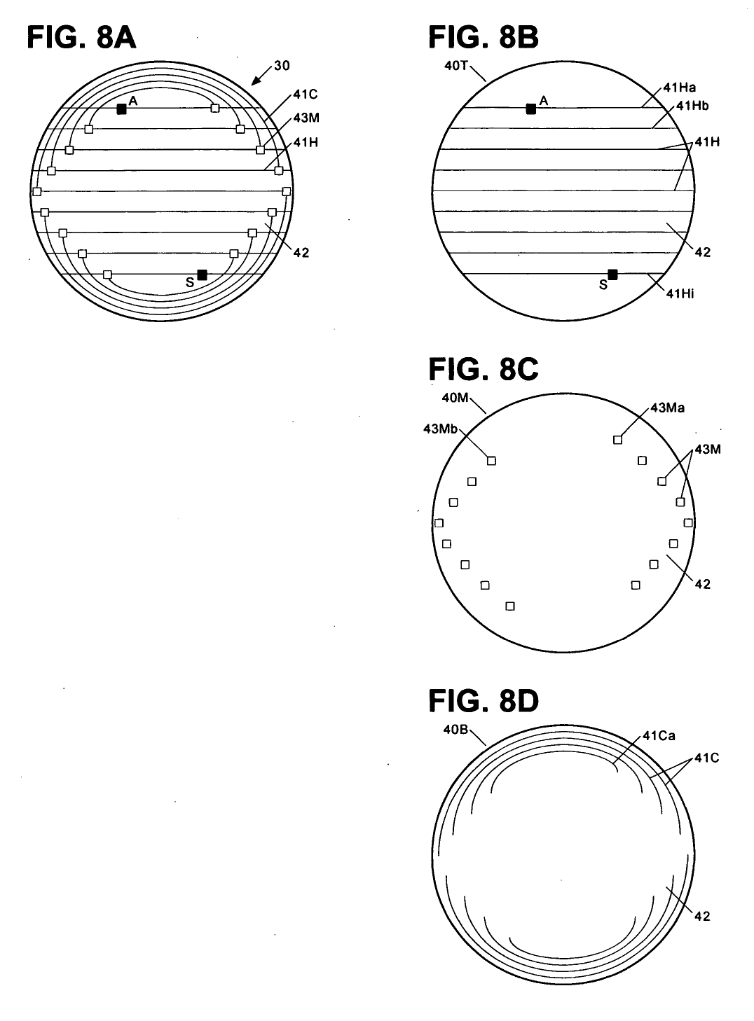

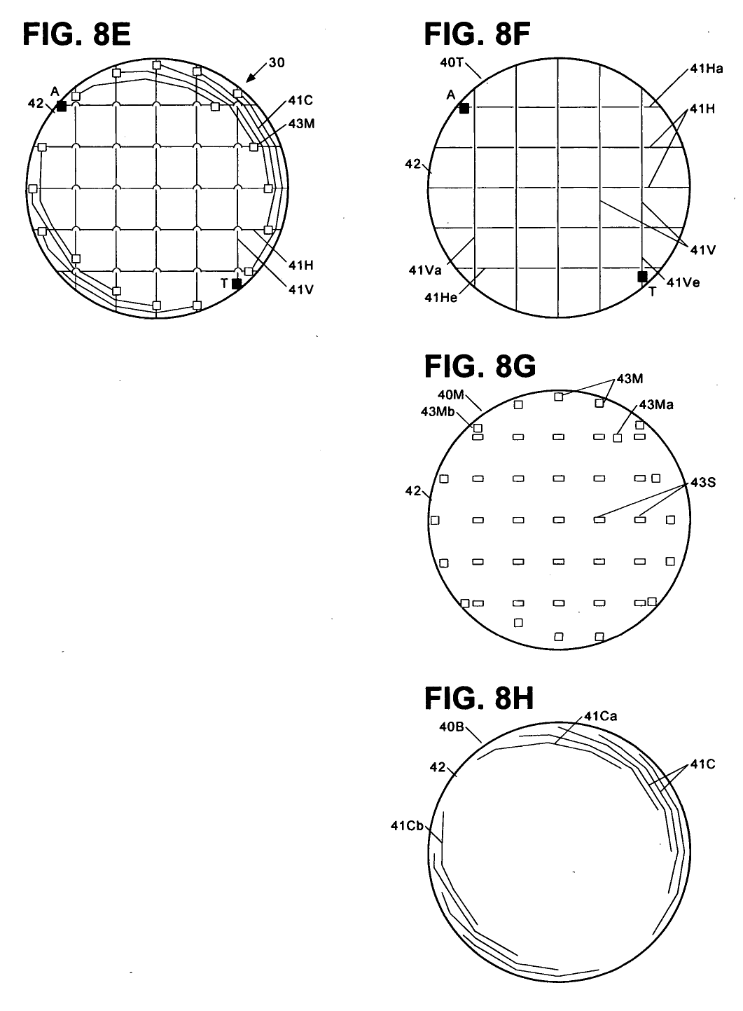

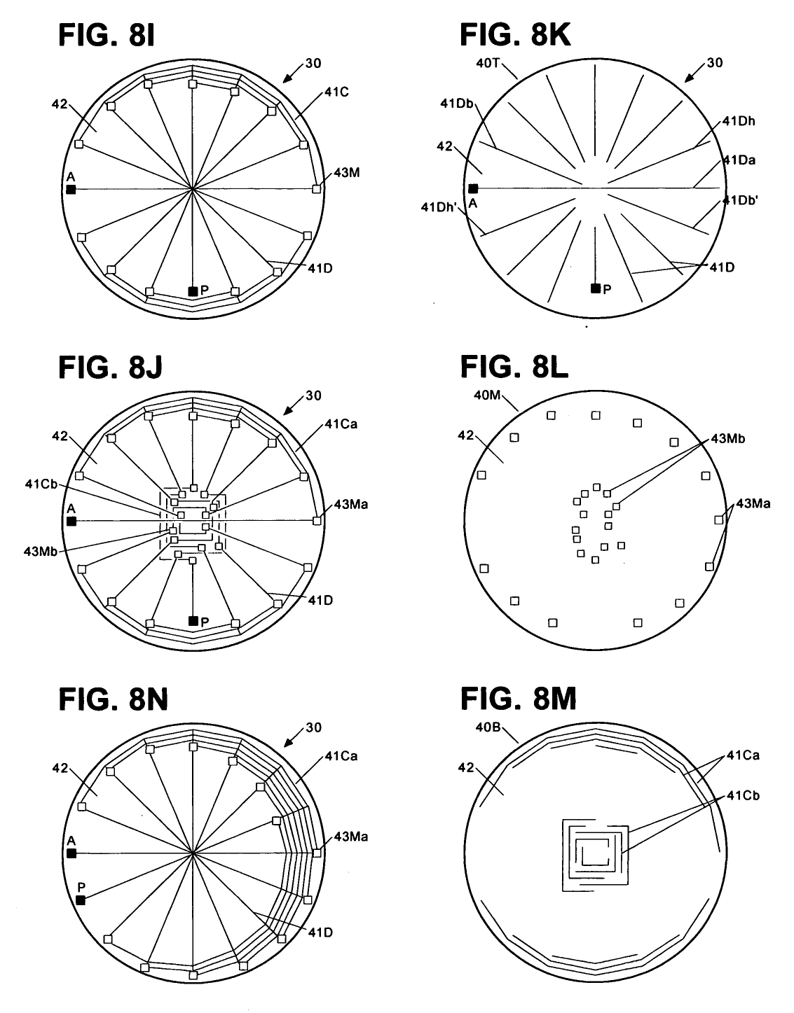

All of the foregoing embodiments generally relate to various modes of electrical connection of the basic conductive elements and/or units provided in a single layer (i.e., “intralayer” connection) by various peripheral and/or internal conductive paths (i.e., “interlayer” conductive paths). In particular, the embodiments shown in FIGS. 7A to 7E and 7J to 7L exemplify the intralayer connections between the basic conductive elements provided in a single unit (i.e., “intraunit” electrical connections through various “intraunit” conductive paths). Such intraunit connections may be applied to series or parallel connections of the conductive elements of those shown in FIGS. 3E to 3G, 3I to 3L, and 3S to 3U. To the contrary, the connections of FIGS. 7F to 7I exemplify the intralayer connections between multiple conductive units (i.e., “interunit” connections) through the intraunit and/or interunit conductive paths. In addition to such intralayer connections, the foregoing basic conductive elements, conductive units, and curvilinear conductive lines or polygons disposed in different induction layers may be electrically connected in series and in parallel by “interlayer” electrical connections using a variety of “interlayer” conductive paths. FIGS. 8A to 8N illustrate several examples of such “interlayer” connections.

Interlayer connections may be applied to contact the basic conductive elements to conductive paths. FIG. 8A is a top view of exemplary multilayer electrical connections of parallel conductive lines of the induction member shown in FIGS. 3A and 6A according to the present invention. Such multiple parallel horizontal conductive wires 41H are connected in series from top to bottom by multiple arcuate conductive wires 41C concentrically disposed at a top and bottom portion of the induction member 30 to form a series conductive loop which starts from the contact A and terminates at another contact S. Such horizontal and arcuate wires 41H, 41C which seemingly intersect each other in FIG. 8A may be arranged in multiple induction layers not to electrically contact to each other. For example, FIG. 8B is a top view of a top layer of the induction member of FIG. 8A, FIG. 8C is a top view of a median layer of the induction member of FIG. 8A, and FIG. 8D is a top view of a bottom layer of the induction member of FIG. 8A according to the present invention. A top induction layer 40T of such an induction member 30 includes multiple horizontal wires 41H, where a first contact A is defined on a first horizontal wire 41Ha, where a second contact S is defined on a bottom horizontal wire 41Hi, and where each wire 41H is insulated from the rest by insulative regions 42. To the contrary, a bottom induction layer 40B includes concentrically arranged multiple arcuate wires 41C which are preferentially disposed either in its top portion or its bottom portion and insulated from the others by insulative regions 42. A median induction layer 40M includes multiple interlayer connectors 43M electrically isolated from the others by a contiguous insulative region 42. Multiple interlayer connectors 43M are preferably arranged so that a first interlayer connector 43Ma is disposed below a right portion of the first horizontal wire 41Ha of the top induction layer 40T and over a right portion of a first arcuate wire 41 Ca of the bottom induction layer 40B, that a second interlayer connector 43Mb is provided underneath a left portion of a second horizontal wire 41Hb of the top induction layer 40T and above a left portion of the first arcuate wire 41Ca of the bottom induction layer 30B, and the like. In such a manner, each interlayer connector 43M connects one parallel conductive wire of the top induction layer 40T to one arcuate conductive wire of the bottom induction layer 40B, thereby defining a series conductive loop which is similar to the one of FIG. 7A. It is appreciated that the multilayer series conductive loop of FIGS. 8A to 8D is functionally equivalent to that of FIG. 7A. However, the multilayer embodiment offers the benefit of providing more horizontal conductive lines 41H on the top induction layer 40T and more arcuate conductive lines 41C on the bottom induction layer 40B, and inducing higher electric current than its single layer counterpart of FIG. 7A. Accordingly, as long as a total thickness of the induction member 30 may be maintained in the above criteria, the multilayer embodiment may be used to provide more basic conductive elements in the induction member 30. It is also appreciated that the horizontal and/or arcuate conductive wires 41H, 41 C may be the active or passive elements, depending upon the magnetic and/or configurational characteristics of the magnetic member 50, its orientation, and/or its movement direction.

Interlayer connections may also be applied to connect overlapping basic conductive elements, overlapping conductive paths, and basic conductive elements overlapping with the conductive paths. FIG. 8E shows a top view of exemplary multilayer electrical connections of a mesh having overlapping horizontal and vertical conductive lines of the induction member of FIGS. 3D and 7E according to the present invention, where multiple horizontal conductive wires 41H are connected in series to multiple vertical conductive wires 41V by multiple arcuate conductive wires 41C concentrically disposed at a first and third quadrant of the induction member 30 to form a series conductive loop which starts from the contact A and terminates at another contact T. The horizontal and vertical wires 41H, 41V which overlap each other in FIG. 8E may be arranged in multiple induction layers not to electrically contact to each other. For example, FIG. 8F is a top layer of the induction member of FIG. 8E, FIG. 8G shows a top view of a median layer of the induction member shown in FIG. 8E, and FIG. 8H shows a top view of a bottom layer of the induction member shown in FIG. 8E according to the present invention. A top induction layer 40T of the induction member 30 includes multiple parallel vertical conductive wires 41V and parallel horizontal wires 41H, where each horizontal wire 41H consists of multiple segments not contacting the continuous vertical wires 41V. In addition, a first contact A is defined on a left end of a top horizontal wire 41Ha, while a second contact T is disposed on a lower end of a right vertical wire 41Ve. Each vertical wires 41V and each segment of the horizontal wires 41H are insulated from the others by insulative regions 42. A bottom induction layer 40B preferentially includes multiple arcuate conductive wires 41C each of which is insulated from the others by a contiguous insulative region 42. A median induction layer 40M includes a set of intralayer connectors 43S and another set of multiple interlayer connectors 43M, where each intralayer connector 43S is positioned under a gap between the segments of the horizontal wires 41H of the top induction layer 40T. Therefore, upon depositing the top induction layer 40T over the median induction layer 40M, the segments of the horizontal wires 41H are electrically connected by the underlying intralayer connectors 43S, thereby forming multiple continuous horizontal wires 41H. In addition, the interlayer connectors 43M are preferably arranged so that a first interlayer connector 43Ma is disposed below a right portion of the first horizontal wire 41Ha of the top induction layer 40T and over a right portion of a first arcuate wire 41Ca of the bottom induction layer 40B, that a second interlayer connector 43Mb is provided underneath a top portion of a first vertical wire 41Va of the top induction layer 40T and above a left portion of the first arcuate wire 41Ca of the bottom induction layer 30B, and the like. In such a manner, each interlayer connector 43M alternatingly connects one of the horizontal and vertical conductive wire of the top induction layer 40T to one arcuate conductive wire of the bottom induction layer 40B and defines a series conductive loop similar to that of FIG. 7E. It is appreciated that the multilayer series conductive loop of FIGS. 8E to 8H is functionally equivalent to the one of FIG. 7E, except that the multilayer embodiment may include more horizontal and/or vertical conductive lines 41H, 41V on the top induction layer 40T and more arcuate conductive lines 41C on the bottom induction layer 40B. By including more conductive lines or wires in the foregoing induction layers while keeping its total thickness within the above criteria, the multilayer embodiment may induce stronger current than its counterpart of FIG. 7E. It is also appreciated that the horizontal, vertical, and/or arcuate conductive wires 41H, 41V, 41C may also be the active or passive elements, depending upon the magnetic and/or configurational characteristics of the magnetic member 50, its orientation, and/or its movement direction.

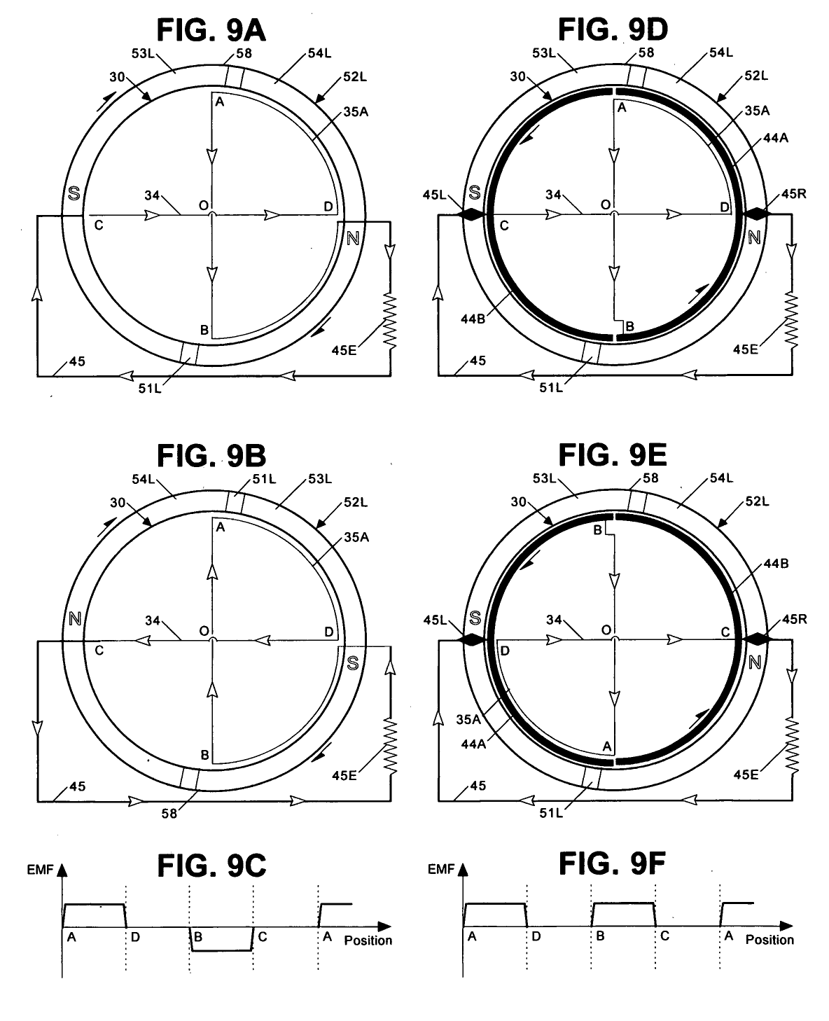

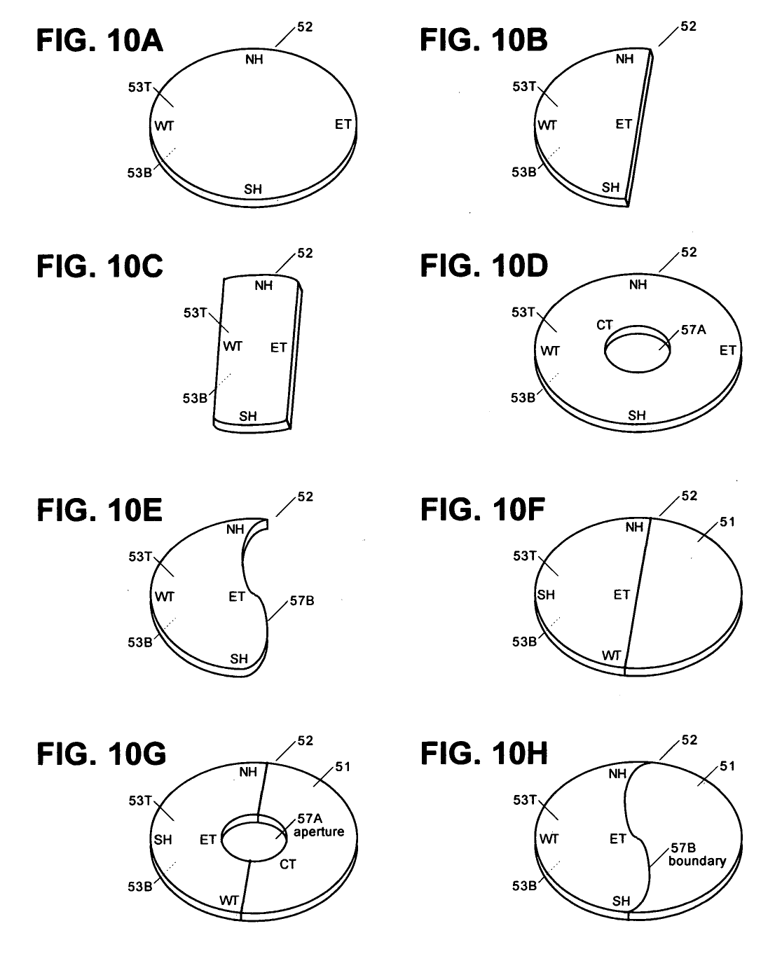

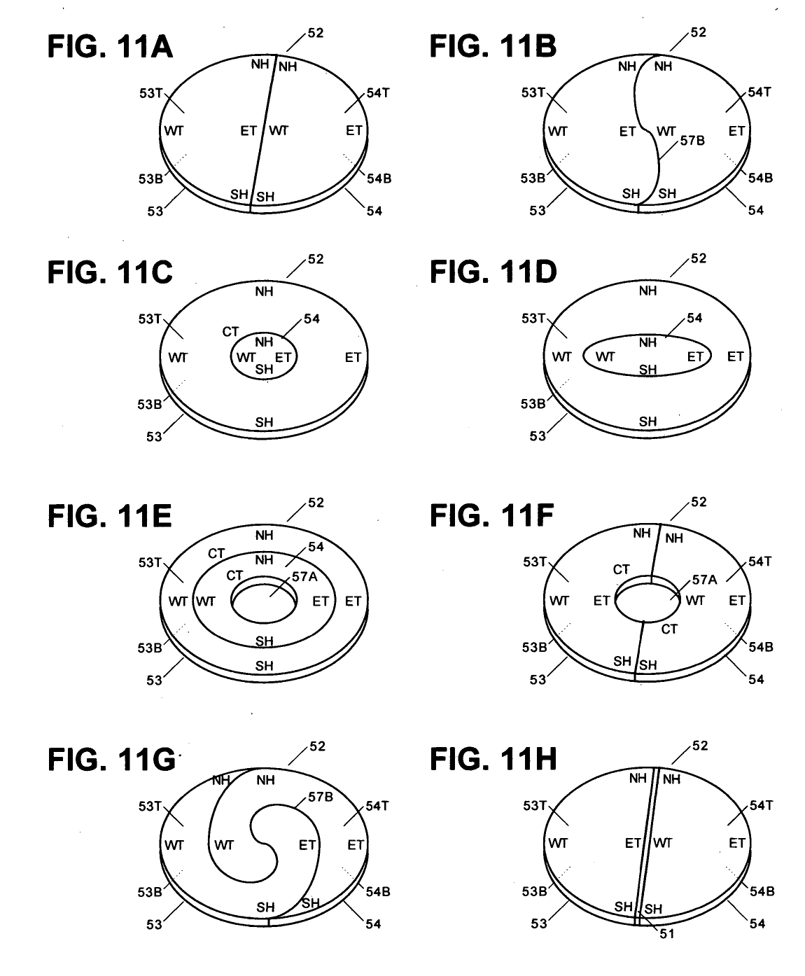

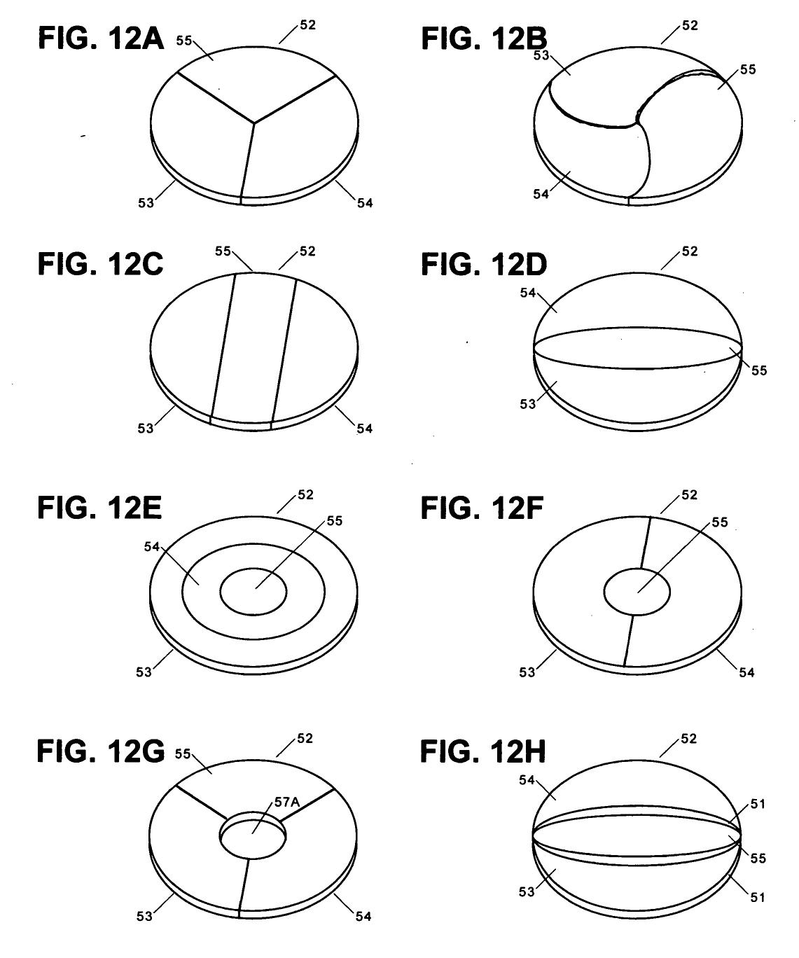

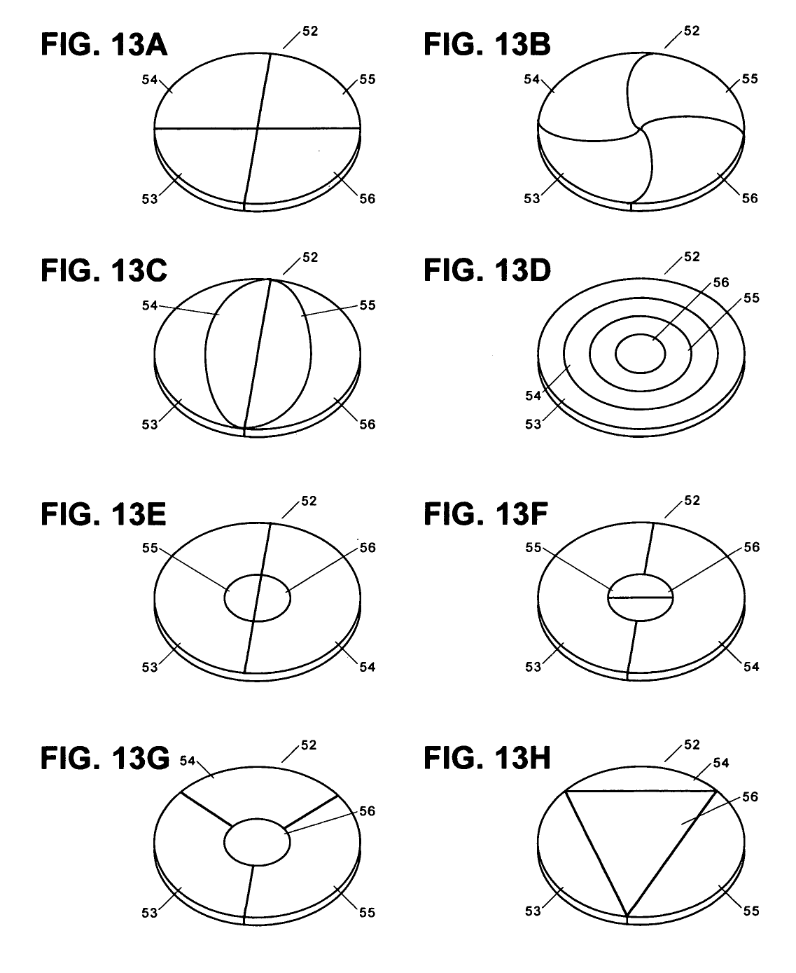

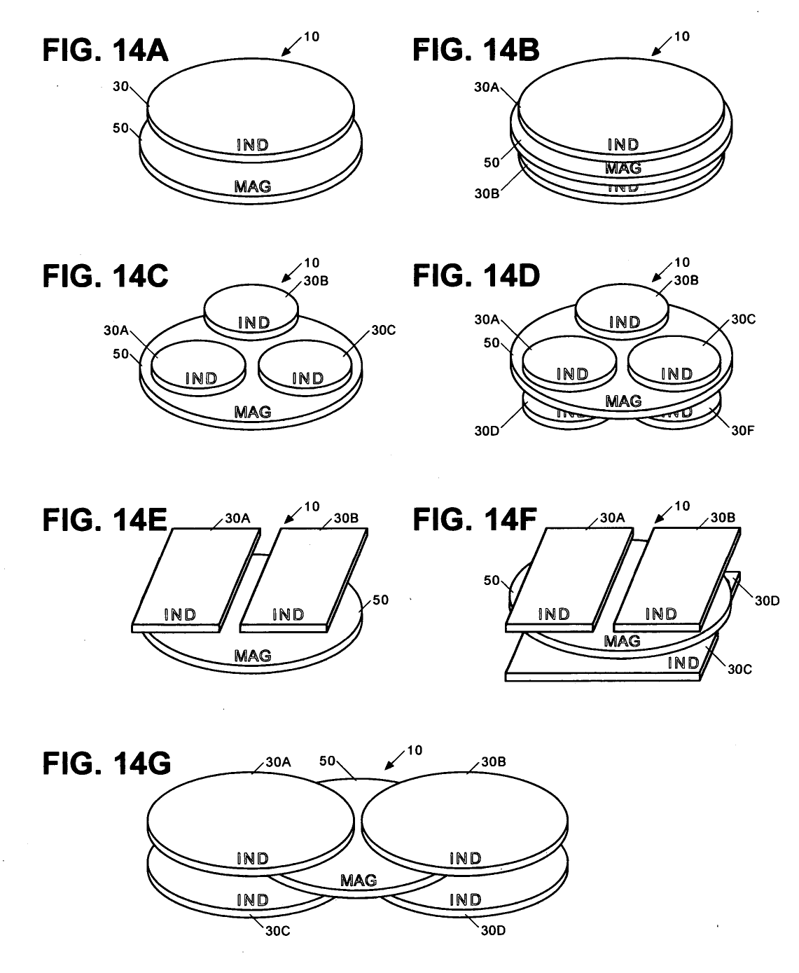

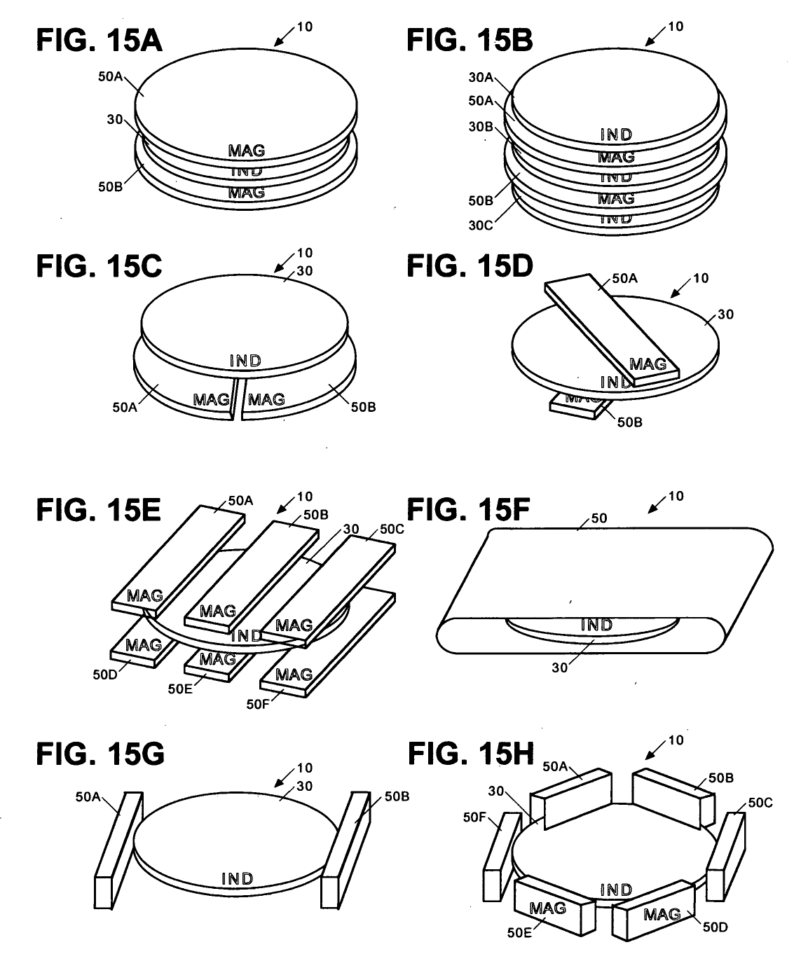

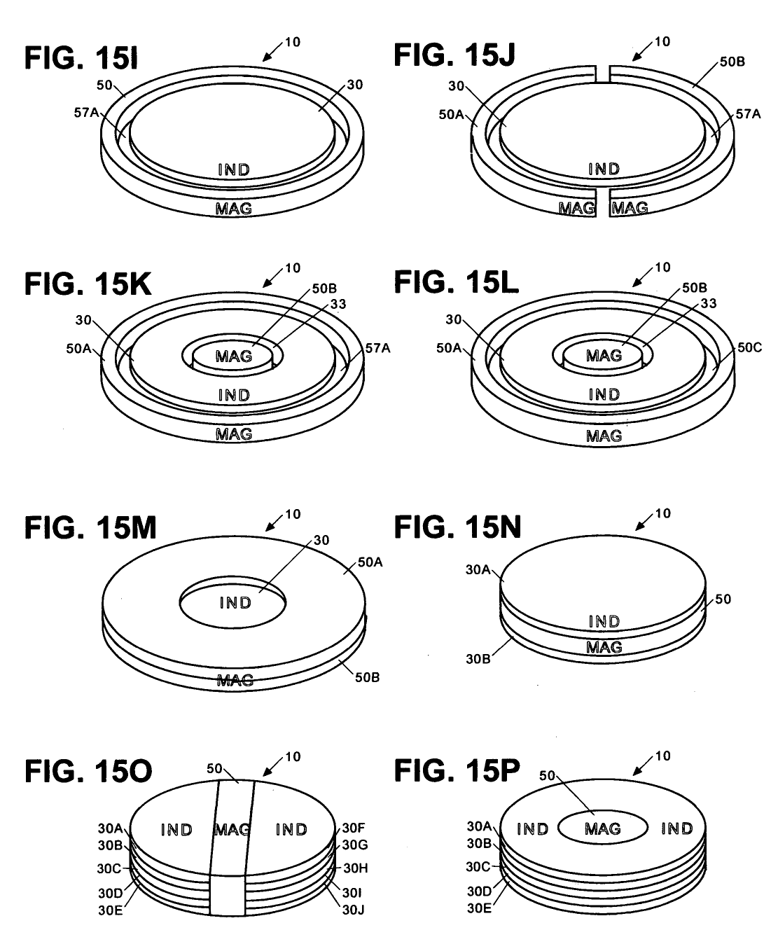

The interlayer connections may further be applied to connect more than two basic conductive elements, more than two conductive paths, and/or more than two basic elements and paths seemingly overlapping each other at a single location of the induction member 30. FIG. 8I represents a top view of exemplary multilayer electrical connections of diagonal conductive lines of the induction member of FIG. 3J according to the present invention, where multiple angular diagonal conductive wires 41D are connected in series by multiple arcuate conductive paths 41Ca through a first set of multiple interlayer connectors 43Ma. Because the angularly arranged diagonal wires 41D overlap but do not electrically contact each other, a second set of multiple interlayer connectors may be required. FIG. 8J is another top view of exemplary multilayer electrical connections of multiple diagonal conductive wires of the induction member of FIG. 3J according to the present invention, where the diagonal conductive wires 41D overlap each other in a center part of the induction member 30 by multiple conductive paths 41Cb through a second set of multiple interlayer connectors 43Mb. Thereby, multiple conductive wires 41D are connected in series to form a series conductive loop starting from the contact A and terminating at another contact P. The diagonal wires 41 D which overlap each other and the inner conductive paths 41Cb in the center part of the induction member 30 and which overlap the peripheral conductive paths 43Ca in a boundary of the induction member 30 may also be arranged in multiple induction layers not to contact to each other. For example, FIG. 8K shows a top view of a top layer of the induction member of FIGS. 8I and 8J, FIG. 8L shows a top view of a median layer of the induction member of FIGS. 81 and 8J, and FIG. 8M is a top view of a bottom layer of the induction member of FIGS. 81 and 8J according to the present invention. A top induction layer 40T includes a diagonal conductive wire 41Da and multiple angularly disposed radial conductive wires 41Db-41Dh, 41Db′-41Dh′, and defines a first contact A on a left end of the diagonal wire 41Da and a second contact P on a low end of a low center wire. The diagonal wire 41Da and each segment of the radial wires 41Db-41Dh, 41Db′-41Dh′ are insulated from the others by a contiguous insulative region 42. To the contrary, a bottom induction layer 40B includes multiple peripheral conductive wires 41Ca and multiple inner conductive wires 41Cb each of which is insulated from the others by a contiguous insulative region 42. A median induction layer 40M includes not only a first set of interlayer connectors 43Ma but also a second set of interlayer connectors 43Mb. Each interlayer connector 43Ma of the first set is positioned under one end of one radial wire 41D and one end of one peripheral wire 41Ca to connect the diagonal and radial wires 41D in series, whereas each interlayer connector 43Mb of the second set is positioned to connect corresponding segments of the radial wires 41D to form a continuous diagonal wire. In such a manner, the diagonal and radial conductive wires 41D of the top induction layer 40T may be connected in series by the arcuate paths 41Ca, 41Cb of the bottom induction layer 40B through multiple interlayer connectors 43Ma, 43Mb of the median induction layer 40M, thereby defining a series conductive loop. Diagonal and radial lines may be connected in series by conductive paths having different configurations. For example, FIG. 8N is another top view of the exemplary multilayer electrical connections of such diagonal conductive lines of the induction member of FIG. 3J according to the present invention, where diagonal conductive lines 41D are connected in a clockwise direction and arcuate conductive wires 41Ca are disposed around one part of the induction member 30. The overlapping conductive lines 41D may also be arranged by interlayer connectors having different arrangements, where such wires 41Ca may overlap each other in the central or other regions of the induction member 30, where the diagonal wires 41D and/or their internal conductive wires 41Cb for bypassing each other may be distributed in other arrangements, and so on. It is noted that, regardless of details thereof, such arrangements also fall within the scope of the present invention, as long as a corresponding pair of the radial conductive wires 41Ca may be connected to each other to form a diagonal wire. It is further noted that any of the diagonal and radial wires 41D and the arcuate conductive wires 41Ca, 41Cb may serve as either the passive elements or the active elements, depending upon the foregoing magnetic and/or configurational characteristics of the magnetic member 50, its orientation, and/or its movement direction.

In view of the foregoing, the figures In this specification including overlapping basic conductive elements may be regarded as embodiments where such basic elements are connected in series or in parallel on a single induction layer through various intralayer conductive paths as exemplified in FIGS. 3D-3G, 31-3L, 30-3U. or in which such elements are connected in series or in parallel through various interlayer connectors and/or conductive paths arranged in multiple induction layers as exemplified in FIGS. 8A through 8N. In this aspect, the figures with overlapping basic conductive elements may be regarded as functional equivalents of those of multilayer arrangements.

The foregoing intraunit and/or interlayer connections may be arranged in various embodiments. For example, intraunit connections between the basic conductive elements or between such elements and conductive paths may be provided in a center region of the induction member, around a periphery thereof, and/or other locations thereof. Alternatively and as exemplified in FIGS. 8F and 8G, intralayer connections may be facilitated by intralayer connectors disposed in another layer. The same applies to interunit connections which may be arranged in a single layer or in multiple layers utilizing interunit connectors disposed in another layer. When feasible, intralayer and/or interlayer connections may be provided along a side of an induction layer and/or induction member by providing, e.g., circumferential, vertical or spiral conductive paths thereon. When it is preferred to provide as many conductive lines as possible on the induction layer and/or member, such conductive lines may be connected in series and/or in parallel using an external circuitry disposed outside of the induction member.

It is appreciated that the foregoing conductive paths and/or various connectors do not have to be disposed preferentially along the periphery and/or in the center region of the induction member. It is also appreciated that disposition of such conductive paths and/or connectors does not compromise construction of such paths on the induction member so that such conductive paths and/or connectors may be arranged to connect the basic conductive elements at any location of such elements. In other words, the basic conductive elements may extend beyond the point of connection with the conductive paths and/or connectors, because the electromagnetic induction of current does not have anything to do with the exact location of such connection. Accordingly, as shown in FIGS. 7A to 7C, 7G, 7H, and 7J, such elements may be defined between the nodes or, alternatively, as shown in FIGS. 7E, 8A, 8E, 8I, 8J, and 8K, such elements may also be defined to extend beyond the nodes. The latter embodiment generally allows to construct the basic conductive elements having greater lengths.

As exemplified in FIG. 6C, multiple layers of basic conductive elements may be deposited one over the other in a single induction layer. In the alternative and as exemplified in FIGS. 8A through 8N, multiple induction layers may be disposed to include therein various basic conductive elements and/or conductive paths. For example, multiple induction layers each of which include at least one of basic conductive elements, conductive paths, and connectors may be directly disposed one over the other. The primary criterion of this embodiment may be that the basic conductive elements, conductive paths, and connectors are meticulously arranged around insulative regions in one or more of such layers to avoid any undesirable electrical contacts. In another alternative, multiple induction layers and multiple insulative layers may be disposed in an alternating mode. This embodiment is generally applicable to induction layers each of which includes therein the basic electric elements and conductive paths and each of which would make undesirable electrical contact with those of the other layer when disposed directly over the other. A combination of the induction layers may be repeatedly deposited to include a desirable number or length of basic conductive elements in the induction member. When desirable, the induction layers may also include different basic conductive elements provided in one or more of such layers in different arrangements. In addition, multiple induction members may be incorporated into the electromagnetic generator as will be described below.

As a special embodiment of the above multilayer induction member, at least one induction layer may be disposed both on top of and below the induction member. In one embodiment, such upper and lower induction layers may include at least substantially similar or identical basic conductive elements and/or units provided in at least substantially similar or identical arrangements such that both induction layers may induce electric currents which are in phase and which have the same polarity. The upper and lower induction layers may then be connected in parallel or in series through additional conductive paths provided through the substrate layer, around the side of the substrate layer or through external wiring. In the alternative, the basic conductive elements and/or units of the upper and lower induction layers may include such similar or identical basic conductive elements and/or units, although those of one induction layer may be a mirror image of, linearly translated from or angularly rotated about those of the other induction layer. In yet another alternative, the upper and lower induction layers may also include different basic conductive elements and/or units which may be connected in series or parallel in the induction member or in the external circuit. When desirable, at least one protective layer may be disposed on such upper and/or lower induction layer, in which such a protective layer may preferably be electrically insulative to prevent formation of undesirable contacts thereby, permeable to magnetic fluxes to facilitate propagation of such fluxes thereacross, and so on. It is appreciated the foregoing embodiments may also apply to multiple induction layers which are disposed on the same side of the induction member.

It is appreciated that the magnetic fluxes may be arranged to intersect the induction member at desirable angles. For example, when the induction member is disposed between two magnets having opposite magnetic characteristics, the magnetic fluxes perpendicularly intersect the induction member. When such magnets may have non-identical and non-opposite magnetic characteristics, the magnetic fluxes may also be arranged to intersect the induction member at any desirable angles. The magnetic fluxes may further be arranged to intersect the induction member at angles which may vary over time and/or position. For example, at least one of the magnets may be arranged to have nonuniform and/or asymmetric distribution of the magnetic elements so that the intensity and/or direction of the magnetic fluxes may be spatially dependent. In the alternative, one of the magnets may be moved with respect to the other so that a given region of the induction member may be subject to magnetic fluxes of which the intensities or directions may vary over time. When both magnets are mobile, one of such magnets may be arranged to move along a different direction and/or at a different speed to vary the intensity or direction of the magnetic fluxes. In contrary, when the induction member is to be disposed between two magnets having identical magnetic characteristics, mutually repelling magnetic fluxes intersect the induction member in parallel or at very small angles. When desirable, the induction layer or induction member may also be disposed at a preset angle with respect to the magnets of the magnetic member. In addition, at least one induction layer or the basic conductive elements thereof may be disposed at a preset angle with respect to other induction layers or the basic conductive elements provided in other induction layers.

Regardless of the number of induction layers included therein, the induction member may also include at least one additional layer which may include magnetic elements, ferromagnetic materials or other materials capable of affecting intensities and/or directions of the magnetic fluxes propagating therethrough. For example, at least one magnetic layer may be implemented inside the substrate layer, between the substrate layer and induction layer, between adjacent induction layers, below the bottom induction layer, over the top induction layer, and the like. The magnetic layer may be arranged to have the magnetic characteristics (e.g., number and/or distribution pattern of the N and S) opposite to those of the magnets of the magnetic member so as to augment the magnetic fluxes propagating through the induction member. Such a magnetic layer may have the magnetic intensity which is higher than, equal to or lower than that of the magnets of the magnetic member. Alternatively, at least one ferromagnetic layer may be implemented inside the substrate layer, between the substrate layer and induction layer, between adjacent induction layers, below the bottom induction layer, over the top induction layer, and the like. Although the ferromagnetic layer may not have any intrinsic magnetic intensity, ferromagnetic molecules of such a layer align when subjected to external magnetic fluxes and augment the magnetic fluxes propagating therethrough.

The foregoing magnetic layer and/or ferromagnetic layer may further be arranged to adjust the angle of intersection between the induction member and magnetic fluxes propagating therethrough. In general, the foregoing magnetic layer with opposite magnetic characteristics augments the magnetic fluxes but does not change the directions thereof. However, by employing the magnetic layer whose magnetic characteristics may differ from those of the magnets disposed thereover or therebelow, the intensities as well as the directions of the magnetic fluxes may be altered. When the magnetic layer is arranged to have the same magnetic characteristics as the magnet disposed thereover or therebelow, such a magnetic layer may not only change the intensities and/or directions of the magnetic fluxes but also alter the directions of the induced currents along the basic conductive elements included therein. Thus, this embodiment may be applied to a magnetic layer inserted between two induction layers such that the current may be induced along one direction of the basic conductive elements of one induction layer but along an opposite direction of such elements provided in another induction layer.

The induction members described heretofore and hereinafter may also include other elements. For example, intralayer dividers may be provided to the induction layer to physically separate different units of the induction layer, while interlayer dividers may be provided to physically separate adjacent induction layers. Such dividers may be electrically insulative and, therefore, used for similar purposes as the foregoing insulation layer and/or insulative regions. Such dividers may also have high magnetic permeability and, therefore, used as magnetic shunts as will be described below. Alternatively, such intralayer and/or interlayer dividers may be used solely to provide mechanical support and/or integrity to the induction layer and/or induction member.

The induction members described heretofore and hereinafter may also include thereon at least one commutator which may be arranged to manipulate electrical connection patterns between various basic conductive elements and/or conductive units provided thereon and to convert AC currents to DC currents or vice versa. Any conventional commutators known in the relevant art may be incorporated into the induction members, magnetic members, and/or external circuit of the electromagnetic induction generator. In the alternative, novel planar commutators of the present invention may also be provided to the induction members and/or magnetic members by various methods similar to those for the above conductive elements. It is appreciated that “planar commutators” as used herein collectively mean any electrical configurations arranged to contact different basic conductive elements or different regions of such elements as the magnetic and/or induction members may rotate or be displaced with respect to the other to manipulate directions of electric current flowing therethrough. The planar commutators may also be incorporated, e.g., into the magnetic member or induction member, into the mobile member or stationary member, into a circuitry which is disposed external to the induction member, into a body of the induction generator, and the like. FIGS. 9A and 9B denote top views of an induction member in operation and disposed between the magnets of the mobile magnetic member of FIG. 1A according to the present invention, where the magnetic member generates magnetic fluxes flowing downwardly and upwardly respectively on a left half and a right half of the induction member (as seen from above) in FIG. 9A and conducting in opposite directions (as seen from above) in FIG. 9B. Such an induction member 30 includes a flipped trapezoidal conductive loop 34 identical to that of FIG. 2A to 2D, except that its second half loop is opened up to connect its terminals to an external circuit 45 which includes an external load 45E. As described in conjunction with FIGS. 2A to 2D, the induction member 30 may generate net electric currents when the leading edge 58 of the lower magnet 52L travels between the points A and D (as in FIG. 9A) and between the points B and C (as in FIG. 9B). Therefore, as shown in FIG. 9C which shows a temporal profile of EMF attainable by the exemplary generator including the induction member of FIGS. 9A and 9B according to the present invention, such an induction member 30 induces an AC pulse train of voltage (or current) which consists of square waves having alternating polarities and separated by idle intervals disposed therebetween. Exemplary planar commutators may be incorporated into the external circuit 45 and FIGS. 9D and 9E show top views of a rotating induction member and a pair of exemplary commutators in operation according to the present invention, in which the stationary upper and lower magnets of the magnetic member emit magnetic fluxes which conduct downwardly and upwardly respectively on the left and right halves of the induction member (as seen from above). The induction member 30 of FIGS. 9D and 9E are at least substantially identical to that of FIGS. 9A and 9B, except that the former induction member 30 has a first semi-annular conductive pad 44A connected to the conductive line AB at the point B as well as a second semi-annular conductive pad 44B connected to the conductive line CD at the point C. The induction member 30 of FIGS. 9D and 9E is also arranged to rotate in a counterclockwise direction around the stationary lower magnet 52L (and upper magnet 52U) of the magnetic member 50. The external circuit 45 of FIGS. 9D and 9E is also at least substantially identical to that of FIGS. 9A and 9B, except that the former circuit 45 includes a right commutator 45R and a left commutator 45L each of which may be fixedly connected to right and left terminals of the external circuit 45, respectively, and which may preferably be disposed above the conductive pads 44A, 44B and each of which may movably contact one of the mobile pads 44A, 44B disposed thereunder. Therefore, as shown in FIG. 9F which is a temporal profile of EMF attainable by the exemplary generator having the induction member and commutators of FIGS. 9D and 9E according to the present invention, the induction member 30 may induce a DC pulse train of voltage (or current) which consists of square waves having the same polarities and separated by idle intervals disposed therebetween.

Various commutators may be incorporated into the electromagnetic induction generator of this invention. First, the conductive pads may have various shapes and/or sizes depending upon various factors such as, e.g., shapes and/or sizes of the induction layers of the induction member, locations of the commutators, movement patterns of the magnetic and/or induction member, and the like. Such conductive pads may be disposed in the induction member, magnetic member, external circuit or body of the generator, although it is preferred that the conductive pads be provided on the mobile member instead of the stationary member. The commutators may similarly be provided in the induction member, magnetic member, external circuit or body of the generator as far as they may be arranged to contact different basic conductive elements or different regions thereof, although it is generally preferred that one end of the commutators be fixedly disposed to the stationary member. In addition, the conductive pads may be provided not on the periphery of the mobile magnetic or induction member but on regions closer to their centers. The commutators of the present invention may also have other configurations as far as they may convert the induced AC (or DC) current (or voltage) into the DC (or AC) current (or voltage) and/or they may facilitate the electrical connection between the mobile magnetic or induction member and the external circuit.

As described above, it is preferred to suppress or to minimize induction of the adverse current along the basic conductive elements or conductive units. In addition, such basic conductive elements may be connected in series or in parallel to augment the intensity of the induced current or to increase the power associated therewith. For this end, the above intraunit connections, interunit connections, intralayer connections, and/or interlayer connections may be applied according to various heuristics described heretofore and hereinafter. For curvilinear polygonal conductive loops, e.g., one or more sides of at least one of such loops may be opened to form multiple terminals which may be connected in series and/or in parallel to minimize the induction of the adverse current, as exemplified in FIGS. 7G and 7H. Such curvilinear polygonal conductive units may also be flipped to construct favorable paths for the current as exemplified in FIGS. 2A through 2D. In addition, each of such polygonal conductive units may be constructed to cover as much an area of the induction member so that the idle cycles of such units may be minimized, as exemplified in FIGS. 4B and 4D. When desirable, directional electric or electronic devices such as conventional diodes may be used to prevent the adverse current from flowing through the conductive units of the induction member or basic conductive elements thereof. In addition, conventional commutators and/or the foregoing planar commutator may also be implemented into the induction member, magnetic member, body of the generator, and the like.

Various magnetic members fall within the scope of this invention to be used in conjunction with the foregoing induction members. In order to efficiently induce electric current (or voltage), however, such magnetic members may preferably be designed in view of configurational characteristics of the induction members and dynamic characteristics of electromagnetic induction generators such as, e.g., selection of the mobile member, movement pattern, more particularly, movement direction of the mobile member, and so on. Accordingly, detailed design parameters of the magnetic members are dependent upon those of the induction members and actuators which will be described below.

The primary design parameter of the magnetic members of the present invention is to generate magnetic fields around the induction members so that magnetic fluxes of the magnetic fields intersect the foregoing basic conductive elements of the induction members. Another design parameter of the magnetic members is construction of compact but efficient magnetic members and/or magnets thereof. The magnetic members of this invention may generally consist of one or more magnets which may be stationary or may move with respect to the induction members. Such magnetic members may include one or more magnets which are disposed apart from each other and include one or more segments of the permanent magnets. Examples of such permanent magnets may include, but not be limited to, rare earth cobalt magnets (e.g., samarium-cobalt, i.e., SmCo), rare earth iron boron magnets (e.g., sintered neodymium-iron-boron, i.e., NdFeB). Such magnetic members, their magnets, and magnetic segments thereof may also include other pseudomagnetic materials examples of which may include, but not be limited to, ferrimagnetic materials, paramagnetic materials, ferromagnetic materials, anti-ferromagnetic materials, diamagnetic materials, and/or any other materials capable of affecting or capable of varying characteristics of the magnetic fields created around such magnetic members, their magnets, and/or their magnetic segments.

Whether the magnetic member of this invention may include a single magnet or an assembly of multiple magnets, each magnet may preferably be disposed adjacent to the basic conductive elements of the induction member and to emit the magnetic fluxes vertically, horizontally, and/or at preselected angles theretoward. Such a magnet may have any shapes and/or sizes as long as it may effectively emit magnetic fluxes to the basic conductive elements of the induction member. However, when such a magnet is a part of the magnetic member which happens to be designated as the mobile member of the induction generator, the magnet and/or the magnetic member with such a magnet may be arranged to have a compact configuration and small dimension to reduce an overall size of the electromagnetic induction generator. Exemplary shapes of such a magnet may include, but not be limited to,an annular, hollow or solid curvilinear bar (or rod), an annular, hollow or solid curvilinear sheet or slab (or plate), and other configurations which may have cross-sectional shapes of curvilinear polygons, circles or ovals with or without any internal apertures. Such a magnet may be constructed to be planar so that a planar surface of such a magnet may face the planar surface of the induction member at very short distances. The magnet or magnetic member may include one or more planar surfaces on one or both sides thereof. In addition, when the magnetic member includes multiple magnets, the magnets may be arranged to have identical or different configurational or magnetic characteristics examples of which may include, but not be limited to, shapes, sizes, elevations, orientations, numbers and/or distribution patterns of the poles, magnetic intensities, and so on. Such magnets may be arranged in a symmetric or asymmetric arrangement and in an even or uneven arrangement. When desirable, multiple magnets may be separated and/or supported by one or more dividers.

Each of the foregoing magnet of the magnetic member of the present invention may consist of one or more magnetic segments. Whether the magnet may consist of a single magnetic segment or an assembly of multiple magnetic segments, each magnetic segment may typically be disposed adjacent to the basic conductive elements of the induction member so as to emit the magnetic fluxes vertically, horizontally, and/or at preselected angles theretoward. The magnetic segment may have any shapes and/or sizes as long as it may effectively emit magnetic fluxes to the basic conductive elements of the induction member. However, when the magnetic segment may be designated as a part of the mobile magnetic member, the magnetic segment may be arranged to have a compact configuration and small dimension to reduce an overall size of the electromagnetic induction generator. Exemplary shapes of the segment may also include, but not be limited to,an annular, hollow or solid curvilinear bar (or rod), an annular, hollow or solid curvilinear sheet or slab (or plate), and other configurations having cross-sectional shapes of curvilinear polygons, circles or ovals with or without any internal apertures. The magnetic segment may be constructed to be planar so that a planar surface of the segment may face the planar surface of the induction member at very short distances. The magnetic segment may form one or more planar surfaces on one or both sides thereof. In addition, when such a magnet consists of multiple magnetic segments, each magnetic segment may be arranged to have identical or different configurational or magnetic characteristics examples of which may include, but not limited to, shapes, sizes, elevations, orientations, numbers and/or distribution patterns of the poles, magnetic intensities, and so on. The magnetic segments may be arranged in a symmetric or asymmetric arrangement and in an even or uneven arrangement and may be separated and/or supported by one or more dividers. Following FIGS. 10A to 10H, 11A to 11H, 12A to 12H, and 13A to 13H denote exemplary embodiments of various magnetic segments and magnets including such segments. It is appreciated in all of these figures that the magnetic member may consist of one of such exemplary magnets or that each of such magnets may be used as a top magnet, a bottom magnet, a median magnet, and/or a peripheral magnet of the magnetic member consisting of multiple magnets.

FIGS. 10A to 10H are perspective views of exemplary magnets consisting of a single magnetic segment according to the present invention. The magnet may have any arbitrary shapes and/or sizes, although one with a circular cross-section may be preferred for a mobile embodiment. For example, an exemplary magnet 52 of FIG. 10A consists of a single magnetic segment shaped as a circular plate or sheet. Such a magnetic segment 52 may be arranged to have its N (or S) pole on its top or bottom surface 53T, 53B or, when preferred, on its north, south, east or west end (respectively abbreviated as “NH,” “SH,” “ET,” and “WT” hereinafter). Alternatively, the magnet may be arranged as a portion of the circular plate as shown in FIGS. 10B and 10C, where exemplary magnets are arranged as a semi-circular plate and a curvilinear bar, respectively and where the N (or S) pole may be disposed on any surface 53T, 53B or on any end NH, SH, ET, WT. The magnet may define at least one aperture therein or therearound. For example, the magnet 52 of FIG. 10D defines an aperture 57A in its center so that the magnet 52 is shaped as a concentric ring. The magnet 52 may also have its N (or S) pole not only on its surfaces and/or ends but also on and/or around its edge formed along the aperture 57A. Thus, the N and S poles may be arranged on a center boundary (abbreviated as “CT” hereinafter) and outer boundary or vice versa. The magnet may have curvilinear boundaries rather than the straight borders as shown in FIGS. 10B and 10C. For example, an exemplary magnet 52 of FIG. 10E forms an arcuate boundary on its left side and a spiral boundary on its right side. In addition, various dividers described hereinabove may also be incorporated into the magnets as in FIGS. 10F to 10H, where the half-circular magnetic segment 52 of FIG. 10B and the curvilinear magnet 52 of FIG. 10E are mechanically coupled to dividers 51 to form circular magnet 50 in FIGS. 10F and 10H, respectively, and where a half-annular magnetic segment 52 of FIG. 10D is coupled to a similarly shaped divider 51 to form a circular magnet 50 in FIG. 10G. The dividers 51 may be used for various purposes, such as e.g., as magnetic shunts, magnetic insulators, mechanical support, mechanical coupler, and/or protector.

Various modifications and/or equivalents of the foregoing magnets and/or magnetic segments may also fall within the scope of the present invention. First, each of such magnets (and/or magnetic segments) may define thereon or therearound two or more magnetic poles. When the magnet (and/or magnetic segment) defines two poles, they are usually disposed on their top and bottom surfaces or on a pair of opposing ends, e.g., on the NH and SH, on the ET and WT, etc. When the magnet (and/or magnetic segment) may define more than two poles, they may be arranged on the NH and SH ends of the top surface and the NH and SH ends of the bottom surface. In addition, such poles may further be defined on any region of their top or bottom surface, on any region around their periphery or side, etc. Second, the foregoing dividers may be disposed in various arrangements as well. For example, such dividers may be disposed inside or around the magnet, and/or thin layers of such dividers may also be provided over the top surface of the magnet and/or below the bottom surface thereof to minimize any mechanical damage in case the mobile magnetic or induction member should collide with the stationary member. Although the magnets of FIGS. 10A to 10H are generally planar, other configurations also fall within the scope of this invention. For example, a concave or convex magnet may be constructed so that it forms a conical or hemispherical article. Such a magnet may be used with a convex or concave induction member in order to effectively induce current through the basic conductive elements thereof. Moreover, the magnet and/or magnetic segment may be arranged to be homogeneous or even so that its configurational and/or magnetic characteristics such as, e.g., its shape, size, elevation, orientation, pole distribution pattern, and/or magnetic intensities may be uniform thereover. When desirable, such a magnet and/or magnetic segment may also be arranged to be heterogeneous or uneven so that the above configurational and/or magnetic characteristics may vary from one region to another thereover. Furthermore, the magnet and/or magnetic segment may be constructed as a combination of any of the above embodiments.

FIGS. 11A to 11H show perspective views of exemplary magnets each including two magnetic segment according to the present invention. The magnets including two magnetic segments may have shapes and/or sizes similar to or different from those shown in FIGS. 10A through 10B. For illustration purposes, however, various embodiments exemplified in FIGS. 11A through 11H are limited to magnets shaped as circular sheets, slabs or plates. The magnet may consist of two magnetic segments which are disposed side by side. For example, each magnet 52 of FIGS. 11A and 11B have two semicircular magnetic segments each of which defines a top surface 53T (or 54T), a bottom surface 53B (or 54B), and four ends NH, SH, ET, WT, where the two segments 53, 54 are bordered by a straight boundary in FIG. 11A and by a curved or spiral boundary in FIG. 11B. Such a magnet may also consist of a pair of magnetic segments concentrically arranged about or off its center. For example, the magnet 52 of FIG. 11C includes an outer annular magnetic segment 53 enclosing therein an inner circular magnetic segment 54, while that 52 of FIG. 11D includes a similar outer segment 53 enclosing therein an inner oval magnetic segment 54. Such a magnet may also define an internal or center aperture 57A around which two magnetic segments are disposed. For example, those 52 of FIGS. 11E and 11F consist of two magnetic segments 53, 54 defining the aperture 57A in their center regions, in which the magnetic segments 53, 54 are disposed concentrically and laterally in FIGS. 11E and 11F, respectively. Such a magnet may include two magnetic segments intertwining each other such that each magnetic segment occupies multiple sections of any straight line passing through the center of the magnet. For example, the magnet 52 of FIG. 11G consists of two spiral magnets 53, 54 intertwining each other by about 180 degrees such that any straight line passing through the center of the magnet 52 are divided into four sections occupied by each magnetic segment 53, 54 in an alternating mode. The above dividers may also be incorporated into any of the foregoing magnets having twin magnetic segments. For example, an exemplary magnet 52 shown in FIG. 11H is similar to that of FIG. 11A, except that two semicircular magnetic segments 53, 54 are bordered by a center divider 51 which may be used as, e.g., magnetic shunts, magnetic insulators, mechanical supports, mechanical couplers, and/or protectors. Similar to those of FIGS. 11A and 11B, the magnetic segments 53, 54 of FIGS. 11C to 11H may also define a top surface, a bottom surface, four ends NH, SH, ET, WT, and a center edge CT when provided with the aperture such that the N or S pole may be arranged in one of such surfaces and ends.

FIGS. 12A to 12H are perspective views of exemplary magnets each including three magnetic segment according to the present invention. The magnets having three magnetic segments may have overall shapes and/or sizes similar to or different from the ones shown in FIGS. 10A to 10H and FIGS. 11A to 11H. For illustration purposes, however, FIGS. 12A to 12H only exemplify exemplary magnets shaped as circular sheets, slabs or plates. Such a magnet may consist of three magnetic segments angularly disposed around a center thereof. For example, those 52 of FIGS. 12A and 12B have three arcuate magnetic segments 53-55 each occupying one third of the magnet 52 and disposed angularly around their centers, where the magnet 52 of FIG. 12A has straight inner borders, while the magnet 52 of FIG. 12B has curved or spiral inner borders. Such a magnet may also consist of three magnetic segments disposed laterally or concentrically with respect to each other. For example, those 52 of FIGS. 12C and 12D have longitudinally extending segments 53-55 disposed side by side, where the magnetic segments 53-55 of FIG. 12C are bordered by straight boundaries, while those 53-55 of FIG. 12D are bordered by curved or spiral boundaries. To the contrary, the magnet 52 of FIG. 12E include concentric magnetic segments 53-55. Such a magnet may further consist of two magnetic segments disposed around or along a periphery of the magnet and a third magnetic segment disposed in or near the center thereof. For example, the magnet of FIG. 12F consist of two semi-annular outer magnetic segments 53, 54 and a circular inner magnetic segment 55. Furthermore, such a magnet may include three magnetic segments disposed around or along its periphery. For example,.the magnet 52 of FIG. 12G includes three curvilinear outer magnetic segments 53-55 disposed side by side around its center while contacting each other and defining a center aperture 57A therein. The above dividers may also be used in any of such magnets with three magnetic segments, and used as, e.g., magnetic shunts, magnetic insulators, mechanical supports, mechanical couplers, and/or protectors. Similar to those of FIGS. 10A to 10H and FIGS. 11A to 11H, each magnetic segment of FIGS.12A to 12G may define a top surface, a bottom surface, four ends NH, SH, ET, WT, and a center edge CT when provided with the aperture such that the N or S pole may be arranged in one of such surfaces and ends.

FIGS. 13A to 13H show perspective views of exemplary magnets each including four magnetic segment according to the present invention, where such magnets may have overall shapes and sizes similar to or different from those shown in FIGS. 10A to 10H, FIGS. 11A to 11H, and FIGS. 12A to 12H. For illustration purposes, however, FIGS. 13A to 13H illustrate exemplary magnets shaped as circular slabs or plates. Such a magnet may consist of four magnetic segments angularly disposed around a center thereof. For example, those 52 of FIGS. 13A and 13B include four arcuate magnetic segments 53-56 each occupying a quadrant of the magnet 52 and disposed angularly about a center thereof, in which the magnet 52 of FIG. 13A has straight inner borders but the magnet 52 of FIG. 13B has curved or spiral inner borders. Such a magnet may also consist of four magnetic segments disposed laterally or concentrically. For example, the magnet 52 of FIG. 13C has longitudinally extending segments 53-56 disposed side by side but the magnet 52 of FIG. 13D includes concentric magnetic segments 53-56. Such a magnet may further consist of two magnetic segments disposed around or along a periphery of the magnet and other two segments disposed in or near the center thereof. For example, those of FIGS. 13E and 13F consist of two semi-annular outer magnetic segments 53, 54 and two semi-circular inner magnetic segments 55, 56, in which the inner segments 55, 56 of FIG. 13E are generally parallel with the outer segments 53, 54, whereas the inner segments 55, 56 of FIG. 13F are perpendicular or normal to the outer segments 53, 54. Moreover, such a magnet may include three magnetic segments disposed about or along a periphery of the magnet and one magnetic segment enclosed thereby. For example,.the magnet 52 shown in FIG. 13G consists of three curvilinear outer magnetic segments 53-55 disposed side by side around a center of the magnet 52 while contacting each other and enclosing a circular inner magnetic segment 56 therein, while the magnet of FIG. 3H includes three arcuate outer magnetic segments 53-55 angularly disposed apart from each other about the center of the magnet 52 and abutting sides of a triangular inner magnetic segment 56. Such a magnet may also include at least one aperture defined in, around or off its center. The dividers may further be employed in any of such magnets with four magnetic segments, and used as magnetic shunts, magnetic insulators, mechanical supports, mechanical couplers, and/or protectors. Similar to those of FIGS. 10A to 10H, FIGS. 11A to 11H, and FIGS. 12A to 12H, each magnetic segment of FIGS. 13A to 13G may define a top surface, a bottom surface, four ends NH, SH, ET, WT, and a center edge CT when provided with the aperture so that the N or S pole may be arranged in one of such surfaces and ends.

Various modifications and/or equivalents of the foregoing magnets and/or magnetic segments of FIGS. 11A to 11H, 12A to 12H, and 13A-13H may also fall within the scope of the present invention.

Such magnets and/or their segments may have almost arbitrary shapes and/or sizes as far as they may effectively emit magnetic fluxes to the foregoing basic conductive elements of the induction layers and/or induction members. Thus, such magnets and/or magnetic segments may be formed as, e.g., slabs or plates having curvilinear polygonal, circular, oval or other curved configurations, bars or other articles which may be considered as portions of the above polygonal or curved configurations, concave and/or convex blocks, cones, hemispheres or other three-dimensional configurations, and so on. Instead of these contiguous articles, the magnets and/or magnetic segments may be comprised of multiple separate articles which may be fixedly disposed by a body of the generator or which may be arranged to be mobile with respect to the induction member while maintaining geometric arrangements therebetween. For example, the magnet may consist of two or more of the above magnetic segments disposed apart from each other to provide a composite magnetic field therearound which consists of the magnetic fluxes emitted by such multiple magnetic segments. Similar to the case of the magnets of FIGS. 10A to 10H, the magnets having multiple magnetic segments as well as such magnetic segments themselves may be constructed homogeneous or even such that the foregoing configurational and/or magnetic characteristics are generally uniform across such magnets and/or their magnetic segments. In the alternative, such magnets and/or their segments may be provided heterogeneous or uneven so that they may emit the magnetic fluxes unevenly, resulting in heterogeneous or uneven magnetic fields created therearound. In terms of their geometrical arrangements, multiple magnetic segments may be arranged symmetrically or asymmetrically with respect to a predetermined line and/or point outside or inside the magnetic member to create symmetric and/or asymmetric magnetic fields therearound. The magnetic segments may further be arranged angularly around a center of the magnetic fields, laterally or side by side with respect to each other.

Similar to the magnet consisting of a single magnetic segment, the magnetic segments of FIGS. 11A to 11H, FIGS. 12A to 12H, and FIGS. 13A to 13H may define a variety of magnetic poles thereover, thereunder, and/or therearound. In the simplest embodiment, each magnetic segment may have one N pole and one S pole, each of which may be defined on one of the foregoing surfaces, ends, edges or any location on or off the magnetic segment. Accordingly, each magnetic segment may emit magnetic fluxes from its top to bottom surface (or vice versa), from its NH to SH (vice versa), from its ET to WT (or vice versa), from its outer to inner periphery, and the like. In another embodiment, such a magnetic segment may be arranged to form a first number of N poles and a second number of S poles, where the first and second numbers may be identical or different and the poles may be defined in the above surfaces, edges, ends, and any location of the magnetic segment. It is appreciated that the magnetic poles disposed in geometrically opposing locations of the magnetic segments and/or magnets may not have to be of opposite polarities. For example, when the magnetic segment 53 of FIG. 1A has the N pole in WT on its top surface 53T, it may have the S pole in one or more geometrically opposite points such as, e.g., the ET on its top surface 53T and the Wr of its bottom surface 53B, or in geometrically non-opposite points such as, e.g., the NH and SH on its top surface, any ends or edges of its bottom surface 53B, any points around its side, and the like. As described above, the magnetic segments do not have to be symmetrically arranged and do not have to have uniform magnetic intensity. Therefore, any magnet consisting of symmetrically arranged magnetic segments may not necessarily generate a symmetric magnetic field, and any magnet consisting of asymmetrically arranged magnetic segments may not necessarily generate an asymmetric magnetic field.

The primary role of the magnetic segments and/or magnets may be to emit the magnetic fluxes to the foregoing basic conductive elements vertically, horizontally or at preset angles. Such magnetic fluxes may vertically intersect the basic conductive elements when the basic elements are disposed between the opposite poles and extend in a direction normal to a line connecting such poles. To the contrary, the magnetic fluxes may conduct in parallel with the basic conductive elements when such elements are disposed between the same poles and extend in the same direction as a line connecting the same poles and/or when the basic conductive elements are disposed between the opposite poles and extend in the same direction as a line connecting the opposite poles. In addition, magnetic fluxes may intersect the basic conductive elements at preset angles when such elements may be disposed in a direction neither normal nor parallel to a line connecting the adjacent poles. This arrangement may be realized by various embodiments such as, e.g., by orienting the magnetic segments and/or magnets at preset angles to the basic elements, by providing non-uniform or uneven intensities to the magnetic segments and/or magnets, by arranging the magnetic segments and/or magnets to have non-uniform or uneven thicknesses or heights, by asymmetrically arranging the magnetic segments, and the like. It is appreciated that, in principle, the magnetic segments and/or magnets may be constructed as long as they may vary intensities and/or directions of magnetic fluxes intersecting the above basic conductive elements, temporal rates of changes of such intensities and/or directions, areas of regions which may be at least partly enclosed by the basic conductive elements, and the like.

The foregoing magnets of FIGS. 11A to 11H, FIGS. 12A to 12H, and FIGS. 13A to 13H may also include various dividers for a variety of reasons. For example, such dividers may be disposed inside or around any magnetic segments or, alternatively, thin layers of such dividers may be provided over the top surface and/or below the bottom surface of the magnetic segments and/or magnets in order to mitigate any mechanical damage in case the mobile magnetic (or induction) member should collide with the stationary induction (or magnetic) member. As described above, such dividers may be comprised of, e.g., materials with high magnetic permeabilities (for magnetic shunts), materials with low magnetic permeabilities (for magnetic insulators), materials having high moduli and/or elasticities (for mechanical supports and/or couplers) regardless of their magnetic permeabilities. The dividers may preferably be made of insulative materials so as to prevent undesirable electric connections of the basic conductive elements therethrough. Where possible short-circuit is not a concern, the dividers may also be made of conductive materials. When applicable, the dividers may be arranged to fine tune and/or modify the magnetic fields created around the magnetic segments and magnets. For example, such dividers may be made of or include pseudomagnetic materials examples of which may include, but not be limited to, ferrimagnetic materials, paramagnetic materials, ferromagnetic materials, anti-ferromagnetic materials, diamagnetic materials, and/or any other materials capable of modifying characteristics of the magnetic fields.

In addition to the above planar magnetic segments and magnets of FIGS. 11A to 11H, FIGS. 12A to 12H, and FIGS. 13A to 13H, other configurations may also fall within the scope of this invention. For example, concave or convex magnetic segments may be constructed to form conical or hemispherical articles. Such magnetic segments may be assembled to form a planar composite magnetic segment or magnet. Alternatively, such conical or hemispherical magnetic segments and/or magnets may be used with matching convex or concave induction members, thereby minimizing distances therebetween and effectively inducing electric current through such elements. Moreover, the magnetic segments and/or magnets may further be arranged to be homogeneous to have uniform configurational and/or magnetic characteristics such as, e.g., shapes, sizes, elevations, orientations, arrangements, symmetry, pole distribution patterns, magnetic intensities, and the like. When desirable, the magnetic segments and/or magnets may also be arranged to be heterogeneous to have non-uniform or uneven configurational or magnetic characteristics thereover. Furthermore, the magnetic segments and/or magnets may also be constructed as a combination of any of the above embodiments.

As described above, the magnetic member of the present invention may include one or multiple magnets each of which may in turn consist of one or more magnetic segments along with the optional dividers. Detailed design criteria for the magnetic members do not generally deviate from those for the magnetic segments and/or magnets, i.e., generating magnetic fields therearound and emitting magnetic fluxes vertically, horizontally or at preset angles to the foregoing basic conductive elements to induce the electric current therethrough. Accordingly, the design criteria for the magnetic members typically depend upon the foregoing configurational characteristics of the induction members and those of the actuators responsible for moving mobile magnetic (or induction) members with respect to stationary induction (or magnetic) members. To this end, the foregoing magnetic segments and magnets may be arranged in various arrangements. For example, the magnetic member may consist of a single magnet which may be disposed over, under, beside or otherwise adjacent to the foregoing induction member and/or between multiple induction members. Alternatively, the magnetic member may include multiple magnets each of which may be disposed over, under, beside or otherwise adjacent to the foregoing induction member or between multiple induction members. The foregoing magnetic segments, magnets or magnetic members may also be disposed inside the induction member for various purposes, e.g., to augment or complement the magnetic fluxes propagating through the induction member, to redirect or modify the magnetic fluxes for magnetic shunting or insulation purposes, to locally or globally reverse the polarity of such magnetic fluxes, and so on. When desirable, the magnetic segments, magnets or magnetic members may be movably or fixedly disposed over, below or beside the induction members.

The electromagnetic induction generators of the present invention include one or more of each of the above magnetic members and induction members deposed according to preset arrangements to induce electric current through various basic conductive units of the induction members. FIGS. 14A to 14G show perspective views of exemplary electromagnetic induction generators including a magnetic member with a single planar magnet and FIGS. 15A to 15P represent perspective views of exemplary electromagnetic induction generators including a magnetic member with multiple or non-planar magnets according to the present invention.

The generator may be comprised of one or multiple induction members disposed over or below the magnetic member consisting of a single magnet. As shown in FIG. 14A, a planar induction member 30 is disposed over another planar magnetic member 50 which is sized to be larger than the induction member 30 so that the magnetic fluxes emanating therefrom may cover an entire area of the induction member 30 and intersect all basic conductive elements provided therein. Alternatively, a top induction member 30A may be disposed over and a bottom induction member 30B may be disposed under such a planar magnetic member 50 as shown in FIG. 14B. An actuator as will be described below may be arranged to move (i.e., rotate, translate, reciprocate, and/or otherwise displace in a horizontal and/or vertical direction) the magnetic and/or induction member to induce current through the basic elements of the induction member. More than one induction member may also be disposed one over the other over and/or below the magnetic member or, alternatively, more than one induction layer may also be provided to one or more of such induction members.

Multiple induction members may be provided side by side over or below the magnetic member as well. As shown in FIG. 14C, planar but smaller induction members 30A-30C may be provided over the magnetic member 50 or, alternatively and as illustrated in FIG. 14D, similar induction members 30A-30F may be disposed on both sides of the magnetic member 50. An actuator may then be arranged to move the magnetic member 50 and/or one or more of the induction members 30A-30F so as to induce the current. These embodiments offer the benefit of providing different basic conductive elements in each of such induction members so that the basic conductive elements in different induction members may induce current during specific portions of the movement of the magnetic member and/or induction member, thereby generating more continuous AC and/or DC currents. The induction members may be arranged to have different shapes and/or sizes, may be arranged to move in different directions or at different speeds, and the like. The induction members disposed below the magnetic member may also be disposed in projected locations of those disposed over the magnetic member or, alternatively, they may be disposed apart from such projected locations. Different number of induction members may be employed over and below the magnetic member.

As described above, the induction members may have shapes other than those of the circular sheets or slabs. As shown in FIG. 14F, e.g., a pair of bar-shaped induction members 30A, 30B may be disposed side by side over the magnetic member 50. In addition and as shown in FIG. 14F, similar induction members 30C, 30D may be disposed under the magnetic member 50 as well. Such induction members 30A-30D may be arranged so that those disposed over and below the magnetic member 50 typically extend in mutually orthogonal directions. Similar to those of FIGS. 14A to 14D, the bar-shaped induction members may be disposed in various arrangements so that different number of the induction members may be disposed on each side of the magnetic member, that such induction member may be arranged symmetrically or asymmetrically, and so on.

Contrary to the above embodiments, induction members may also be disposed to be covered by at most partially by the magnetic member. As shown in FIG. 14G, two induction members 30A, 30B are disposed over, whereas other two induction members 30C, 30D are disposed under the magnetic member 50 disposed between each pair of the induction members 30A-30D, thereby disposing only a fraction of each induction member over or under the magnetic member. An actuator then moves one or more induction members to induce current through the basic conductive elements of the induction member. Such an embodiment may seem inefficient, because non-negligible portions of the induction members are not directly intersected by the magnetic fluxes emanating from the magnetic member. It is appreciated, however, that the intensity of the induced current depends not only upon intensities of the magnetic fluxes but also upon temporal change in such magnetic fluxes. Because each induction member has to move from a region of stronger magnetic fluxes to another region of weaker magnetic fluxes, this embodiment may also prove effective, subject to various configurational characteristics of the basic conductive elements of the induction members and/or arrangement patterns therebetween. As described above, different numbers of induction members may be disposed over and below the magnetic member, and such induction members may be identical or different. In addition, the induction members may be coupled to move in unison or may be arranged to move separately in the different or same directions at different or same speeds.

The generator may also include multiple magnetic members between and/or around which one or more induction members may be disposed according to preset arrangements. More particularly, the magnetic members may be sized to cover entire portions of the induction members. As shown in FIG. 15A, e.g., two magnetic members 50A, 50B are stacked one over the other at a distance and a planar induction member 30 is disposed therebetween. Alternatively and as shown in FIG. 15B, an additional top induction layer 30A and a bottom induction layer 30C may also be disposed over the top magnetic member 50A and below the bottom magnetic member 50B, respectively, along with a median induction layer 50B disposed between the top and bottom magnets 50A, 50B. In such embodiments, the top and bottom magnets 50A, 50B conduct the magnetic fluxes vertically and perpendicularly to various basic conductive elements of the induction members 30, 30A-30C regardless of their shapes and directions of extension. Therefore, an actuator may induce current by moving either or both of the induction and magnetic members 30, 30A-30C, 50 as far as such a movement includes a horizontal component. It is preferred, however, that the basic conductive elements extend radially and that one of such members horizontally rotates or translates such that the directions of the basic conductive elements included in the induction member, magnetic fluxes emitting from the magnetic member, and movement of the mobile member become orthogonal to each other and that the current intensities may also be maximized. The foregoing embodiments may be varied or modified without departing from the scope of this invention. More than one induction layers may be disposed over, below or between the magnets in the stacking arrangement or in the lateral side-by-side arrangement. The distances between each pair of magnetic and induction member may be maintained constant or may be varied.

The generator may include multiple magnetic members each of which may be sized to amount to only a portion of the induction members. An exemplary embodiment of FIG. 15C includes two semi-circular magnetic members 50A, 50B disposed side by side under the bottom surface of the induction member 30, while that of FIG. 15D includes one bar-shaped magnetic member 50A over a top surface of the induction member 30 and another similar magnetic member 50B underneath a bottom surface of the induction member 30. When desirable, one or more of similar magnetic members may be disposed over the induction member as well. By including two separate and independent magnetic members on the same side of the induction member, various composite magnetic fields may be customized around the induction member. Such an embodiment may particularly be beneficial when opposing ends of the magnetic members have the same poles and direct mechanical coupling of such magnetic members is not practical due to repulsive force exerted therebetween. The foregoing embodiments may be varied and/or modified without departing from the scope of this invention. For example, the same or different number of magnetic members may be disposed over and below the induction member. Such magnetic members disposed on one side of the induction member may be provided at different elevations and/or in different orientations. The magnetic members may be mechanically coupled to each other such that they may move in unison. Alternatively, the magnetic members may be separately disposed and move independently in the same or different directions at the same or different speeds.

An exemplary embodiment shown in FIG. 15E is generally similar to the one of FIG. 15D, except that more magnetic members 50A-50E are disposed side by side above and underneath the induction member 30 of FIG. 15E. Such magnetic members 50A-50F may be arranged to move independently or may be coupled to each other to move in unison. More particularly, such magnetic members 50A-50F may be coupled by one or more continuous loops and moved along with the loop. For example, three magnetic members 50A-50C on top of the induction member 30 may be translated from left to right and displaced under the induction member 30 one by one, whereas those 50D-50F may be translated in an opposite direction and displaced over the induction member 30 one after the other. When feasible and as shown in FIG. 15F, a continuous sheet of magnetic material 50 may be constructed as the magnetic member which may then be translated or reciprocated around the induction member 30.

Contrary to the vertically disposed magnetic members of FIGS. 15A to 15F, the generator may include multiple magnetic members which may be laterally disposed on opposing sides of the induction members as well. An exemplary embodiment of FIG. 15G includes two bar-shaped magnetic members disposed on opposing sides of the induction member and emitting horizontal magnetic fluxes from one side to an opposing side of the induction member. FIG. 15H exemplifies another embodiment similar to that of FIG. 15G, except that the generator of FIG. 15H includes six magnetic members 50A-50F which are disposed around the induction member 30 generally at a uniform angular interval. By arranging the polarity of such magnetic members 50A-50F, various composite magnetic fields may be created about the induction member 30, although such fields may generally be characterized by horizontal magnetic fluxes. The foregoing embodiments may also be varied or modified without departing from the scope of the present invention. For example, the circumferential magnets may be arranged have the same or different configurational and/or magnetic characteristics, to be disposed at a uniform angle or different angles around the center of the induction member, to be disposed symmetrically or asymmetrically, to have the same or different orientations and/or elevations, and the like.

The generator may also include at least one concentric magnetic member in a center aperture of which at least a portion of the induction member may be disposed. FIG. 151 illustrates a concentric magnetic member 50 and an induction member 30 disposed in a center aperture 57A of the magnetic member 50 and FIG. 15J exemplifies a similar embodiment except that the induction member 30 of FIG. 15J is encircled by a pair of semi-annular or horseshoe-shaped magnetic members 50A, 50B. To the contrary, FIG. 15K shows another concentric magnetic member 50A and induction member 30 similar to those of FIG. 15I, except that the induction member 30 has a center aperture 33 in which a smaller magnetic member 50B is disposed. Similar to those of FIGS. 15G and 15H, the magnetic members 50, 50A-50B of FIGS. 15I to 15K may generate generally horizontal magnetic fluxes which may conduct either centrifugally or centripetally. It is appreciated, however, that vertical magnetic fluxes may also be attained from these embodiments. For example, when the opposing inner sides of such magnetic members 50, 50A, 50B are arranged to have opposite polarities, the magnetic fluxes may flow from one side to another horizontally in a parallel or concentric fashion. However, when such sides may have the same polarity, the magnetic fluxes may conduct laterally near the periphery of the magnetic members and then substantially vertically near the center thereof. In addition, as is the case with FIG. 15C, the magnetic members 50A, 50B of FIGS. 15J and 15K may have various number of the same or opposite poles in various regions thereof. The foregoing embodiments may also be varied or modified without departing from the scope of this invention. For example, the magnetic and induction members may have the same or different heights (or elevations) such that at least a portion of one member may be disposed beyond or below an edge of the other member. In addition, the induction member may be aligned with the magnetic member or may alternatively be disposed off from the center of the magnetic member so that a gap formed between an inner side of the magnetic member and an outer side of the induction member may vary from position to position. Various numbers of induction members may also be disposed inside the magnetic member, more than two identical or different magnetic members may be arranged around the induction member, multiple Induction members may be stacked and disposed inside the aperture of the magnetic member, and the like.

The generator may also include multiple magnetic members arranged to enclose therein at least substantial portions of the induction members. FIG. 15L shows the induction member 30 and magnetic members 50A, 50B of FIG. 15K, where the center and peripheral magnetic members 50A, 50B may be mechanically and magnetically coupled by a bottom magnetic member 50C. Similarly, FIG. M illustrates the induction member 30 which is sandwiched between the magnetic members 50A, 50B of FIG. 15L defining a center aperture which may be required to rotate the induction member 30. Compared with those 50A-50C of FIGS. 15L, the magnetic members 50A-50B shown in FIG. 15M may enclose the top and bottom of the induction member 30 and, therefore, may emit even stronger magnetic fluxes to the basic conductive elements of the induction member 30.

The magnetic member or magnets thereof may also be incorporated into the induction member. For example, FIG. 15N illustrates a composite inductor consisting of, e.g., a top induction member 30A, a median magnetic member 50, and a bottom induction member 30B, where the magnetic member 50 is stacked between and abutting the top and bottom induction members 30A, 30B. In contrary, FIG. 15D exemplifies another composite inductor, where a median magnetic member 50 diagonally extends from one end to an opposing end of the composite inductor and where multiple induction members 30A-30J are vertically stacked on each side of the magnetic member 50. Furthermore, FIG. 15P shows multiple annular induction members stacked one over the other and a magnetic member 50 is disposed through the center aperture of such induction members 30A-30E. The foregoing composite inductors may also be varied or modified without departing from the scope of the present invention. For example, multiple magnets or magnetic members may be fixedly or movably disposed between, around, or inside such induction members. In addition, the number of poles and/or pole distribution patterns may be varied to generate desirable magnetic fields around the basic conductive elements of the induction members.

Electromagnetic induction generators having other embodiments may also fall within the scope of the present invention. As described above, the magnetic and/or induction members may have any arbitrary shapes and sizes so that they may have the foregoing curvilinear polygonal configurations, each of such members may include at least one aperture in its center or other regions thereof, and the like. In addition, optional magnets and induction layers may also be fixedly or movably disposed inside the induction members and magnetic members, respectively. The induction members may include any number of induction layers in any arrangements as far as suitable interlayer electric connections may be provided. For example, the induction layers may be disposed on the top and/or bottom surface of the substrate layer or the induction layers may be disposed one over another induction layer, magnet, and/or insulation layer. Furthermore, each induction layer may be provided with any number of basic conductive elements each of which may have any shape and/or size and may be connected by any suitable connection patterns. Similarly, the magnetic members may also be comprised of any number of magnets each having any number of magnetic segments therein.

When the electromagnetic induction generator may have multiple induction members, they may have identical, similar, functionally equivalent or different configurations. The induction members may be arranged symmetrically or asymmetrically with respect to one another and may be disposed from the magnetic member at a uniform distance or at different distances. When such a generator includes therein multiple magnetic members, each member may have identical, similar, functionally equivalent or different configurational and magnetic characteristics. The magnetic members may be disposed from the induction members at a uniform distance or at different distances and may be arranged in identical or different orientations. The magnetic members may be arranged symmetrically or asymmetrically as well.

As discussed above, the objective of the electromagnetic induction generator is to move either or both of the magnetic and induction members, thereby arranging the magnetic fluxes to intersect the basic conductive elements provided in the induction member to change the intensity and/or direction of the magnetic fluxes intersecting through a region at least partially surrounded by the basic conductive elements and/or conductive units over time and/or to change an area of a region defined by the basic conductive elements and/or conductive units normally projected onto the magnetic fluxes over time.

In order to embody such, the actuator may be arranged to move the magnetic and/or induction member in various arrangements. First, the actuator may be arranged to rotate one of such members (i.e., the mobile member) relative to the other of the members (i.e., the stationary member). In general, the planar induction member is disposed as close to the planar surface of the magnetic member so as to maximize intensities of the magnetic fluxes which decreases inversely proportional to the distance therebetween. Any of such members may be designated as the stationary member to offer different design benefits. For example, the stationary induction member allows easier electrical connection of the basic conductive elements without necessarily through the above commutators, while the heavier stationary magnetic member allows the user to rotate the induction member with less energy. When desirable, the actuator may move both of the magnetic and induction members. Second, the actuator may be arranged to translate or otherwise move one of such members relative to the other thereof in curvilinear movement paths. In order to achieve such linear translational motions, however, such an actuator may have to reciprocate the mobile member along a reciprocating movement path so that the generator may induce the electric current without idle periods for bringing the mobile member back to its original starting position. Alternatively and as exemplified in FIG. 15F, the mobile member may also be constructed as a conventional caterpillar or otherwise continuous track which constantly encloses at least a portion of the stationary member therein. For example, multiple magnets may be attached to the caterpillar or track or, alternatively, such a caterpillar or track may be made of magnetic materials or may be magnetized. Similarly, multiple planar induction members may be attached to the caterpillar or track as well.

The actuator may further be arranged to rotate or to translate the mobile member in a horizontal direction or in a vertical direction which may be respectively defined to be parallel or perpendicular to a long axis of the generator. It is preferred, however, that the detailed configuration of the operation mechanism of the actuator may not be determined independently. Rather, the operation mechanism of the actuator may preferably be determined in lieu of the configurational characteristics of the induction member(s) and the configurational or magnetic characteristics of the magnetic member. For example, in the generator exemplified in FIG. 15A, the actuator may horizontally rotate the magnetic member of which the magnets generally conduct the magnetic fluxes in the vertical direction. The Fleming's right-hand law dictates that the current should flow either centrifugally or centripetally. Therefore, such an induction member may preferably be designed to include as many radially extending basic conductive elements as possible, while preferentially employing circumferential conductive paths. Similarly, when the actuator may horizontally translate the magnetic member, the induction member may rather include as many linear basic conductive elements which extend in a direction orthogonal to the direction of the translational movement of the magnetic member. In contrary, when such an actuator may be arranged to vertically translate the magnetic member, no current may be induced regardless of the configuration of the basic conductive elements, for the vector product of the external force and the magnetic fluxes of the Fleming's right-hand law require that the movement direction of the mobile member effected by the external force not coincide with the direction of magnetic fluxes. In another embodiment in which the magnets of FIGS. 15A or 15G are arranged to conduct the magnetic fluxes in a horizontal direction, the generator may or may not induce current depending upon, e.g., the configurational characteristics of the induction member, dynamic characteristics of the actuator, and the like. For example, when the actuator horizontally rotates and/or translates the induction member, no current is induced through the basic conductive elements, for all such elements are included in the planar induction member generally extend in the directions of the magnetic member and movement of the induction member. Accordingly, such an induction member may preferably be arranged to have vertically extending basic conductive elements or the actuator may have to vertically translate the magnetic and/or induction member.

As exemplified in these examples, whether or not an electromagnetic induction generator may induce current generally depends upon whether any two of three principal directions coincide or not, i.e., a first direction along which the mobile member rotates or translates, a second direction in which the magnetic fluxes conduct, and a third direction along which the basic conductive elements extend, where two directions are deemed to coincide each other when they are either parallel or anti-parallel. According to the Fleming's right-hand law, no current may be induced through the basic conductive elements when the mobile member moves along the first direction which coincides with the second or third direction, when the magnets of the magnetic member are arranged to emit the magnetic fluxes in the second direction coinciding with the first or third direction or when the basic conductive elements are arranged to extend in the third direction which coincides with the first or second direction. Thus, the most efficient electromagnetic induction generator may be constructed by arranging the magnetic member(s), induction member(s), and actuator in such a way that the above first, second, and third directions are perpendicular to each other. When such directions are not mutually perpendicular but form an acute angle, the generator may still induce the electric current although its efficiency may not reach its maximum value. In addition, when the basic conductive elements are arranged to extend in various directions and/or when the magnetic member includes multiple magnets effecting the magnetic field of which the magnetic fluxes are neither vertical nor horizontal, the induction member may induce current with dynamic characteristics such that intensities and/or directions of such current may vary as a function of the angular and/or axial position of the mobile member with respect to the stationary member. Based upon the foregoing basic design rules, various electromagnetic induction generators may be constructed according to the present invention by selecting appropriate actuators which may operate compatibly with the induction members as well as with the magnetic members. Accordingly, one actuator may have to vertically rotate the mobile member with respect to one stationary member, but may have only to horizontally translate the mobile member relative to a different stationary member. Further details of selecting compatible magnetic members, induction members, and actuators are well known in the field of general physics, more particularly, magnetism.

When the mobile magnetic member may include multiple magnets, they may be coupled to each other to move in unison. Alternatively, the actuator may be arranged to move each magnet and, when desirable, may move one or more magnets in different directions and/or at different speeds. Similarly, when the generator includes multiple mobile induction members, they may be coupled to each other to move in unison or the actuator may move one or more of the induction members in different directions and/or at different speeds. As described above, one or more of such magnets or induction members may be disposed in different elevations and/or orientations. The mobile member may also be arranged to rotate about or off its center or to translate along or off its centerline. As described above, such an embodiment may not be effective because not an entire portion of the stationary member may abut the mobile member. However, this embodiment may provide more drastic changes in the intensities and/or directions of the magnetic fluxes around the basic conductive elements of the induction member, thus increasing an overall induction efficiency of the generator.

It is appreciated that no fixed design rule applies as to which member should be designated as the mobile or stationary member within the scope of this invention. As described above, however, the advantage of employing the stationary induction member lies in easier electrical connection, while that of employing the stationary magnetic member is to move the magnetic member with least mechanical energy. Other factors may also be accounted for in selecting the stationary and mobile members. For example, the member having greater mechanical integrity and stability may be designated as the mobile member over the one with less integrity and stability. Thus, the induction member may be selected as the mobile member when the induction member may be provided as a single contiguous article having multiple induction layers contiguously formed one over the other. When the induction member includes complicated configurations, e.g., having one or more magnets disposed in its center region, using the induction member as the mobile member may not be practical. A total number of magnetic or induction members and an arrangement pattern therebetween may be other factors. Other things being equal, it is generally easier to designate the members with a less number as the mobile members. In particular, when multiple magnetic or induction members are arranged to move separately, it may be best to keep such members as the stationary members, while rotating or translating the other members around the stationary members. Arrangement patterns between the magnetic and induction members may render some of the members more easily manipulatable than others. In such cases, the easily manipulatable members may be designated as the mobile members, while other members obstructed by the mobile members may be selected to be the stationary members. In addition, configurational characteristics of the induction members and/or magnetic characteristics of the magnetic members may determine which member should be designated to be mobile or stationary. It is manifest, e.g.,that the magnetic member of FIG. 15F should be designated as the reciprocating mobile member, whereas the induction member may be stationarily or movably disposed within such a magnetic member. In other less conspicuous cases, however, the Fleming's right-hand law may be able to guide which member should be used as the mobile member or which member should not be selected as the stationary member, which will be described in greater detail below.

Regardless of the detailed configurational characteristics of an assembly of the magnetic and induction members, a top portion as well as a bottom portion of such an assembly may preferably be occupied by the induction members. It is appreciated that the electromagnetic induction generators of the present invention may be used to supply electric energy to various portable electronic or electric equipment. Accordingly, it is imperative to minimize adverse effects from the magnetic fluxes on such equipment by, e.g., providing magnetic shunts around the generators so that the magnetic fluxes may be redirected through the exterior shunts instead of propagating out of the generator and intersecting various electric circuits of the portable equipment. Because of this configuration, the top and bottom induction layers, even though they may not be sandwiched by the magnetic members, may receive an enough amount of magnetic fluxes

Various combinations of above embodiments may be used to provide electromagnetic induction [symbol] generators with various configurations. For example, the magnetic and/or induction member shown in one figure may be implemented to the magnetic and/or induction member of the generators built base [symbol] on the configurations of other figures. In addition, one or more magnets of the magnetic member, one [symbol] or more of multiple magnetic members, and/or one or more magnets disposed between, around, and/ [symbol] inside the induction member may be replaced by the foregoing pseudomagnetic materials, insulators [symbol] materials with high magnetic permeabilities. Furthermore, in any of the foregoing embodiments, any [symbol] the induction members may be replaced by the magnetic members, while the magnetic members may be replaced by the induction members.

As described above, the electromagnetic induction generators of the present invention include actuators which may be arranged to receive mechanical user inputs and to transduce such inputs into a driving force capable of moving the above magnetic and/or induction members at desirable speeds in suitable directions. Such actuators may be comprised of various conventional mechanical couplers examples of which may include, but not be limited to, various gears, pulleys, chains, belts, and other power transmission devices known in the art. In order to transduce such user inputs into the driving force, such actuators may also include conventional springs and/or dash pots. The actuators may be arranged to transduce the user inputs into the driving force real time or, alternatively, to store the user inputs by convention energy storage members and then to transform the energy into the driving force upon receiving the user command. Typical examples of such energy storage members may include, but not be limited to, various coils and springs made of or including materials with high elasticity. Once the user inputs are transduced into the driving force, the actuator may rotate or translate the magnetic and/or induction members in order to induce electric current through the basic conductive elements of the induction member. Such induced current may be delivered directly to portable devices so that the user may operate the devices while applying the inputs to the generator. Alternatively, the generator of the present invention may include capacitors or rechargeable batteries which may be charged by the induced current initially, convert the energy into current thereafter, and then deliver such current to the portable devices.

The foregoing electromagnetic induction generators of the present invention may be provided in various embodiments. First, the generators may be manufactured to have shapes and sizes of the conventional AC/DC adaptors. Such generators may be placed near portable electric devices and the use may supply the induced electric energy to the portable device through a connection cable. In the alternative, such generators may be shaped and sized to be movably coupled to the portable devices. For example, such a generator may include at least one mechanical receiver into which at least a part of the device is inserted and movably retained and/or by which the generator is movably coupled to at least a part of the portable device. The actuator may then be disposed in locations in such a way that the user may apply the mechanical input signal to the generator while operating the portable device in a normal pattern. In yet another alternative, such generators may be shaped and sized as the battery units of the portable devices. Accordingly, when the battery unit of the portable device runs out, the user may replace the discharged battery with the portable generator and operate the portable device while providing the mechanical user input to the generator and supplying the electrical energy to such a portable device.

Although the electromagnetic induction generators of the present invention are constructed as portable generators, such induction generators may be provided as stationary articles and/or may be incorporated into stationary devices as backup generators. The induction generators of the present invention may also be provided in bigger sizes and/or capacities when strong electric voltage and/or current may be preferably needed. Accordingly, the size of such a generator may vary according to the need.

Other technologies may be applied to provide compact electromagnetic induction generators of the present invention. For example, nanotechnology may be employed to provide preset patterns of molecules on top of the substrate layer of the induction member. Such molecules may then be utilized as the basic conductive elements of the induction member. In the alternative, micro-electromechanical systems (MEMS) may be utilized to provide miniature basic conductive elements on the substrate layer of the induction member as well. It is, therefore, appreciated that details of technologies for providing the basic conductive elements in the induction member are not crucial to the scope of this invention as long as such basic conductive elements may induce current in cooperation with the magnetic member and the actuator.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

What is claimed is:

1. An electromagnetic induction generator for generating electric current comprising:
a magnetic member configured to form at least one planar surface and to include at least one magnet emitting magnetic fluxes through said planar surface;
an induction member including a substrate layer and at least one planar induction layer which is disposed over said substrate layer and configured to define therein at least one planar conductive loop which is disposed adjacent to said planar surface of said magnetic member and is configured to receive at least a portion of said magnetic fluxes; and
an actuator configured to receive a user input and to convert said user input into movement of at least one of said magnetic and induction members with respect to the other of said members so as to induce electric current through said conductive loop of said induction member.

2. The induction generator of claim 1, wherein at least a substantial length along said conductive loop is configured to have at least substantially identical electrical conductivity, electron mobility, and hole mobility.

3. The induction generator of claim 1, wherein said induction layer is configured to have a height not exceeding 2 millimeters.

4. The induction generator of claim 1, wherein said induction layer is configured to have a height not exceeding 1 millimeter.

5. The induction generator of claim 1, wherein said induction member is configured to be planar and to have a height not exceeding 5 millimeters.

6. The induction generator of claim 1, wherein said induction member is configured to be planar and to have a height not exceeding 3 millimeters.

7. The induction generator of claim 1, wherein said induction layer includes therein a plurality of said conductive loops and at least one intralayer connector and wherein at least one of said loops is configured to be connected in series to another of said loops through said intralayer connector.

8. The induction generator of claim 1, wherein said induction member includes a plurality of said induction layers and at least one interlayer connector, wherein at least one of said layers is disposed over said substrate layer and at least another of said layers is disposed beneath said substrate layer, and wherein at least one of said loops disposed in said one of said layers is connected in series to at least one of said loops disposed in said another of said layers through said interlayer connector.

9. The induction generator of claim 1, wherein said induction member includes a plurality of said induction layers disposed one over the other on one of a top and bottom of said substrate layer and wherein said induction member further includes at least one interlayer connector which is configured to connect in series at least one of said loops disposed in one of said induction layers to at least one of said loops disposed in another of said layers in series.

10. The induction generator of claim 1, wherein said actuator is configured to maintain a distance from said planar surface of said magnetic member to said induction layer of said induction member within a preset range.

11. The induction generator of claim 10, wherein said range is less than 5 millimeters.

12. The induction generator of claim 10, wherein said movement is at least one of translational and rotational.

13. The induction generator of claim 1, wherein said magnetic member includes a body defining an internal space and wherein at least a portion of said induction member is configured to be disposed in said internal space.

14. The induction generator of claim 1, wherein said magnetic member includes a first magnet and a second magnet and wherein at least a portion of said induction member is configured to be disposed between said first and second magnets.

15. The induction generator of claim 1, wherein said first and second magnets are disposed side by side in order for one edge of said magnets to oppose each other.

16. The induction generator of claim 1, wherein said first and second magnets are disposed one over the other in order for said planar surfaces of said magnets to oppose each other.

17. The induction generator of claim 1 further comprising at least one magnetic shunt having high magnetic permeabilities and enclosing at least one surface of said magnetic member.

18. An electromagnetic induction generator for generating electric current through electromagnetic induction made by a process comprising the steps of:
providing at least one magnetic member including at least one magnet configured to define at least one planar surface and to emit magnetic fluxes through said planar surface;
arranging at least one induction member including at least one conductive loop therein;
disposing said magnetic and induction members adjacent to each other; and
moving at least one of said magnetic and induction members with respect to the other, thereby inducing current through said conductive loop of said induction member.

19. The induction generator of claim 18, said arranging step including the steps of:
disposing a substrate layer in a chamber; and
depositing conductive materials on said substrate layer according to a preset pattern to define said conductive loop thereon.

20. An inductor for an electromagnetic induction generator having at least one magnetic assembly configured to emit magnetic fluxes, said inductor comprising:
a substrate layer; and
at least one planar induction layer disposed over said substrate layer and configured to define therein at least one planar conductive loop which is disposed adjacent to said magnetic assembly and configured to receive at least a portion of said magnetic fluxes,
